(19) United States
(12) Patent Application Publication
(10) Pub. No.: US 2025/0254683 A1
(43) Pub. Date: Aug. 7, 2025

(54) MANAGING SMALL DATA TRANSMISSION WITH A RADIO ACCESS NETWORK

(71) Applicant: GOOGLE LLC, Mountain View, CA (US)

(72) Inventor: Chih-Hsiang Wu, Taoyuan City (TW)

(21) Appl. No.: 18/857,548

(22) PCT Filed: Apr. 24, 2023
(86) PCT No.: PCT/US2023/019675

§ 371 Date: Oct. 17, 2024

Related U.S. Application Data
(60) Provisional application No. 63/334,074, filed on Apr. 22, 2022.
(60) Provisional application No. 63/334,081, filed on Apr. 22, 2022.

(51) Int. Cl. H04W 72/1268; H04W 72/20

(52) U.S. Cl. CPC H04W 72/1268; H04W 72/20

(57) ABSTRACT

A user equipment (UE) receiving, from a radio access network (RAN), a configuration for skipping an uplink transmission. The UE obtains an uplink (UL) grant. When operating with an inactive radio connection between the UE and the RAN, the UE skips the uplink transmission corresponding the UL grant in accordance with the received configuration.

### CROSS-REFERENCE TO RELATED APPLICATIONS

This application claims priority to and the benefit of the filing date of provisional U.S. Patent Application No. 63/334,074, titled “Managing Small Data Transmission with a User Equipment,” filed on Apr. 22, 2022 and provisional U.S. Patent Application No. 63/334,081, titled “Managing Small Data Transmission with a Radio Access Network,” filed on Apr. 22, 2022. The entire contents of the provisional applications are hereby expressly incorporated herein by reference.

### FIELD OF THE DISCLOSURE

This disclosure relates generally to wireless communications and, more particularly, to managing configurations of small data communication of uplink and/or downlink data at a user equipment (UE) and a radio access network (RAN) when the UE operates in an inactive or idle state associated with a protocol for controlling radio resources.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station; the RRC_CONNECTED state, in which the UE has an active radio connection with the base station; and the RRC_INACTIVE to allow a UE to more quickly transition back to the RRC_CONNECTED state due to Radio Access Network (RAN)-level base station coordination and RAN-paging procedures. In some cases, the UE in the RRC_INACTIVE state has only one, relatively small packet to transmit. In some such cases, a Small Data Transmission (SDT) procedure would support data transmission for the UE operating the RRC_INACTIVE (i.e., without transitioning to RRC_CONNECTED state).

SDT is enabled on a radio bearer basis and is initiated by the UE only if less than a configured amount of uplink data awaits transmission across all radio bearers for which SDT is enabled, the downlink RSRP is above a configured threshold, and a valid SDT resource is available. SDT procedure can be initiated by the UE with either a transmission over a random access channel (RACH) (i.e., called random access SDT (RA-SDT)) or over Type 1 configured grant (CG) resources (i.e., called CG-SDT). For RA-SDT, the network configures 2-step and/or 4-step random access resources for SDT. In RA-SDT, the UE transmits an initial transmission including data in a message 3 (Msg3) of a 4-step random access procedure or in a payload of a message A (MsgA) of a 2-step random access procedure. The network can then schedule subsequent uplink and/or downlink transmissions using dynamic uplink grants and downlink assignments, respectively, after the completion of the random access procedure.

During an SDT session with a base station (e.g., gNB), the UE obtains an uplink grant (e.g., a dynamic grant or a configured grant) for data transmission. In such cases, the UE may not have data available for transmission with the uplink grant. It is not clear whether the UE skips an uplink transmission configured by the uplink grant. It is also unknown how the base station manages small data communication for the UE.

### SUMMARY

An example embodiment of the techniques of this disclosure is a method for wireless communication. The method is implemented in a UE and comprises receiving, from a RAN, a configuration for skipping an uplink transmission; obtaining a UL grant; and when operating with an inactive radio connection between the UE and the RAN, skipping the uplink transmission corresponding the UL grant in accordance with the received configuration.

Another example embodiment of the techniques of this disclosure is a UE comprising a transceiver and a processing hardware configured to implement the method above.

Yet another example embodiment of these techniques is a method for wireless communication implemented in a node of a RAN and comprising: transmitting, to the UE, a configuration for skipping an uplink transmission according to a UL grant when the UE operates with an inactive radio connection between the UE and the RAN; and communicating with the UE in accordance with the configuration when the UE operates with the inactive radio connection.

Still another example embodiment of the techniques of this disclosure is a node of RAN comprising a transceiver and a processing hardware configured to implement the method above.

### BRIEF DESCRIPTION OF THE DRAWINGS

FIG. 1A is a block diagram of an example wireless communication system in which a user device and a base station of this disclosure can implement the techniques of this disclosure for reducing latency in data communication;

FIG. 1B is a block diagram of an example base station in which a centralized unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIG. 3 illustrates an example scenario in which a RAN node configures a UE for SDT, and the UE enters an inactive state;

FIG. 4 illustrates an example scenario similar to FIG. 3, but in which the UE is already in an inactive state while being configured for SDT;

FIG. 5A illustrates an example scenario in which a RAN node determines to resume a connection with a UE to transmit data before configuring the UE for SDT;

FIG. 5B illustrates an example scenario similar to FIG. 5A, but in which the UE initiates the procedure to resume the connection with the RAN;

FIG. 6A illustrates an example scenario in which a UE requests to connect to a RAN node, and in which the RAN node communicates with a previously connected base station to retrieve UE context information;

FIG. 6B illustrates an example scenario similar to FIG. 6A, but in which the UE communicates UL and/or DL data with a CU of a RAN node via a DU before completing SDT;

FIG. 6C illustrates an example scenario similar to FIG. 6A, but in which the UE enters a connected state and receives configuration information before returning to an inactive state and communicating via SDT;

FIG. 7A illustrates an example scenario in which an RRC layer of a UE initiates SDT, during which the upper layers of the UE communicate UL and/or DL data directly with the PDCP layer;

FIG. 7B illustrates an example scenario similar to FIG. 7A, but in which the upper layers communicate UL and/or DL data with the PDCP layer via the RRC layer;

FIG. 7C illustrates an example scenario similar to FIG. 7A, but in which the RRC layer communicates with the upper layers of the UE via the PDCP layer prior to performing the SDT procedure;

FIG. 8A is a flow diagram of an example method implemented in a UE for determining whether to transmit SDT data to a RAN using a UL grant based on whether the UE has UL data to transmit;

FIG. 8B is a flow diagram of an example method similar to FIG. 8A, but in which the UE determines whether to transmit a data packet when the UE does not have UL data to transmit based on whether the first SDT configuration configures UL transmission skipping;

FIG. 8C is a flow diagram of an example method similar to FIG. 8B, but in which the UE determines whether to transmit the data packet based on whether the SIB configures and/or the UE supports UL transmission skipping;

FIG. 8D is a flow diagram of an example method similar to FIG. 8B, but in which the UE determines whether to transmit the data packet based on whether the non-SDT configuration configures UL transmission skipping;

FIG. 9A is a flow diagram of an example method implemented in a UE for determining whether to enable UL transmission skipping based on whether an SDT configuration configures such before determining whether to transmit SDT data or a data packet;

FIG. 9B is a flow diagram of an example method similar to FIG. 9A, but in which the UE determines whether to enable UL transmission skipping based on whether an SIB configures UL transmission skipping and/or the UE supports UL transmission skipping;

FIG. 9C is a flow diagram of an example method similar to FIG. 9A, but in which the UE determines whether to enable UL transmission skipping based on whether a non-SDT configuration configures UL transmission skipping;

FIG. 10A is a flow diagram of an example method implemented in a UE for generating a UE capability IE including non-SDT, SDT, and UL transmission skipping capabilities;

FIG. 10B is a flow diagram of an example method similar to FIG. 10A, but in which the UE transmits a UE capability identifier to a base station identifying a stored UE capability for non-SDT, SDT, and UL transmission skipping capabilities;

FIG. 11A is a flow diagram of an example method implemented in a UE for determining whether to transmit SDT data using a UL grant after generating and transmitting UE capability information to a RAN node;

FIG. 11B is a flow diagram of an example method similar to FIG. 11A, but in which the UE transmits a UE capability identifier to a base station identifying a stored UE capability;

FIG. 12 is a flow diagram of an example method implemented in a UE for determining whether to indicate to a RAN node that a UE supports transmission skipping;

FIG. 13A is a flow diagram of an example method implemented in a UE for communicating with a RAN node via SDT configurations and refrains from communicating via non-SDT configurations while in an inactive state;

FIG. 13B is a flow diagram of an example method similar to FIG. 13A, but in which the UE communicates with the RAN node via the SDT configurations and a portion of the non-SDT configurations while in the inactive state.

FIG. 14A is a flow diagram of an example method implemented in a DU of a RAN node for including a transmission skipping configuration in an SDT configuration to configure a UE;

FIG. 14B is a flow diagram of an example method similar to FIG. 14A, but in which the DU refrains from including the transmission skipping configuration in the SDT configuration;

FIG. 14C is a flow diagram of an example method similar to FIG. 14A, but in which the DU determines whether to include the transmission skipping configuration in the SDT configuration based on whether the UE and/or the DU supports UL transmission skipping;

FIG. 15 is a flow diagram of an example method implemented in a RAN node for determining whether to include a transmission skipping configuration based on whether the UE and/or RAN node supports UL transmission skipping;

FIG. 16A is a flow diagram of an example method implemented in a RAN node for including a transmission skipping configuration in an SDT configuration and broadcasting the SDT configuration on a cell;

FIG. 16B is a flow diagram of an example method similar to FIG. 16A, but in which the RAN node refrains from including the transmission skipping configuration in the SDT configuration;

FIG. 16C is a flow diagram of an example method similar to FIG. 16A, but in which the RAN node determines whether to include the transmission skipping configuration based on whether the RAN node supports UL transmission skipping;

FIG. 17A is a flow diagram of an example method implemented in a DU for including a transmission skipping configuration in a non-SDT configuration, transmitting the non-SDT configuration to the UE, and enabling a transmission skipping detection function for the UE;

FIG. 17B is a flow diagram of an example method similar to FIG. 17A, but in which the DU refrains from including the transmission skipping configuration in the non-SDT configuration;

FIG. 17C is a flow diagram of an example method similar to FIG. 17A, but in which the DU determines whether to include the transmission skipping configuration in the non-SDT configuration based on whether the UE and/or DU supports UL transmission skipping;

FIG. 18 is a flow diagram of an example method implemented in a RAN node for determining whether to include a transmission skipping configuration in a non-SDT configuration based on whether the UE and/or RAN node supports UL transmission skipping;

FIG. 19A is a flow diagram of an example method implemented in a RAN node for communicating with a UE in an inactive state by using an SDT configuration and refraining from using a non-SDT configuration; and

FIG. 19B is a flow diagram of an example method similar to FIG. 19A, but in which the RAN node communicates with the UE in the inactive state by using the SDT configuration and a portion of the non-SDT configuration.

### DETAILED DESCRIPTION OF THE DRAWINGS

As discussed in more detail below, a user equipment (UE) and/or a network node of a radio access network (RAN) can use the techniques of this disclosure for managing early data communication and transitioning a UE between states of a protocol for controlling radio resources between the UE and the RAN. As used in this disclosure, early data communication can refer to early data transmission (EDT) from the perspective of the network (i.e., EDT in the downlink direction), or EDT from the perspective of the UE (i.e., EDT in the uplink direction).

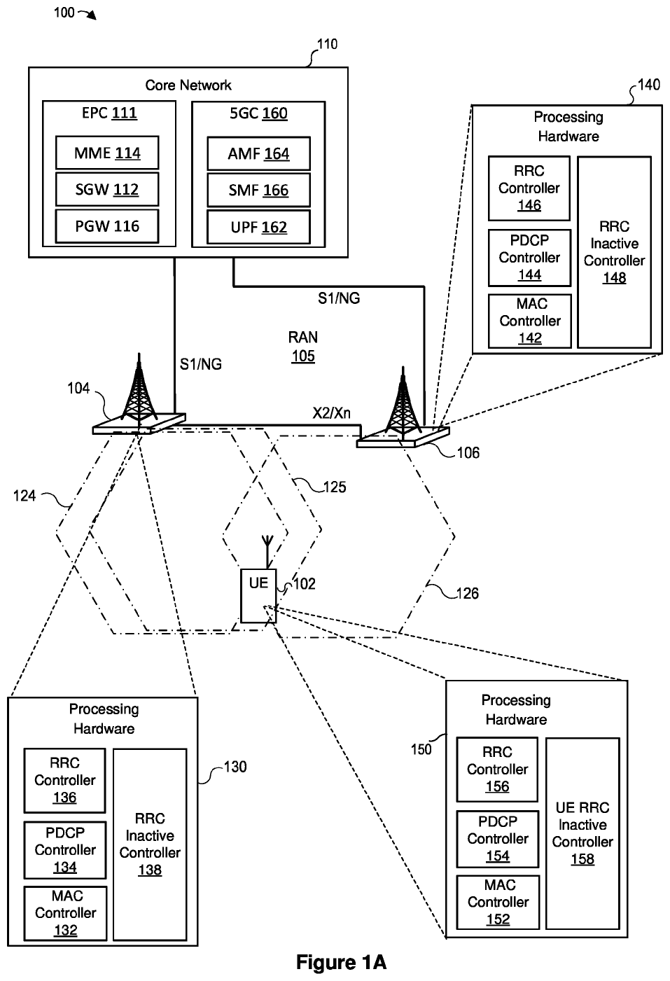

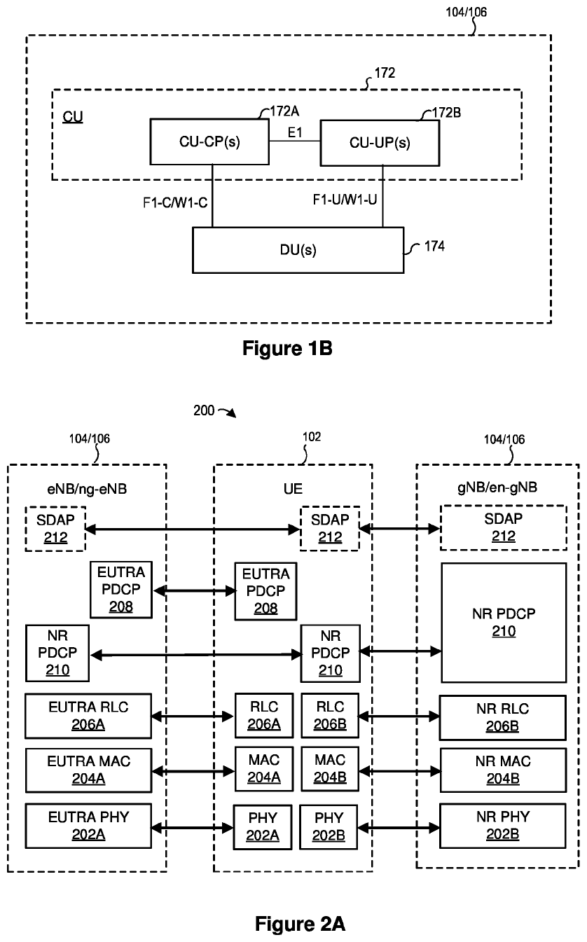

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 covers a cell 124, and the base station 106 covers a cell 126. If the base station 104 is a gNB, the cell 124 is an NR cell. If the base station 104 is an ng-eNB, the cell 124 is an evolved universal terrestrial radio access (E-UTRA) cell. Similarly, if the base station 106 is a gNB, the cell 126 is an NR cell, and if the base station 106 is an ng-eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

As discussed in detail below, the UE 102 and/or the RAN 105 may utilize the techniques of this disclosure when the radio connection between the UE 102 and the RAN 105 is suspended, e.g., when the UE 102 operates in an inactive or idle state of the protocol for controlling radio resources between the UE 102 and the RAN 105. For clarity, the examples below refer to the RRC_INACTIVE or RRC_IDLE state of the RRC protocol.

As used in this disclosure, the term “data” or “data packet” refers to signaling, control-plane information at a protocol layer of controlling radio resources (e.g., RRC); controlling mobility management (MM); controlling session management (SM); or non-signaling, non-control-plane information at protocol layers above the layer of the protocol for controlling radio resources (e.g., RRC), above the layer of the protocol for controlling mobility management (MM), above the layer of the protocol for controlling session management (SM), or above the layer of the protocol for controlling quality of service (QOS) flows (e.g., service data adaptation protocol (SDAP)). The data to which the UE and/or the RAN applies the techniques of this disclosure can include, for example, Internet of Things (IoT) data, ethernet traffic data, internet traffic data, or a short message service (SMS) message. Further, as discussed below, the UE 102 in some implementations applies these techniques only if the size of the data is below a certain threshold value.

In the example scenarios discussed below, the UE 102 transitions to the RRC_INACTIVE or RRC_IDLE state, selects a cell of the base station 104, and exchanges data with the base station 104, either via the base station 106 or with the base station 104 directly, without transitioning to RRC_CONNECTED state. As a more specific example, after the UE 102 determines that data is available for uplink transmission in the RRC_INACTIVE or RRC_IDLE state, the UE 102 can apply one or more security functions to an uplink (UL) data packet, generate a first uplink (UL) protocol data unit (PDU) including the security-protected packet, include a UL RRC message along with the first UL PDU in a second UL PDU, and transmit the second UL PDU to the RAN 105. The UE 102 includes a UE identity/identifier (ID) for the UE 102 in the UL RRC message. The RAN 105 can identify the UE 102 based on the UE ID. In some implementations, the UE ID can be an inactive Radio Network Temporary Identifier (I-RNTI), a resume ID, or a non-access stratum (NAS) ID. The NAS ID can be an S-Temporary Mobile Subscriber Identity (S-TMSI) or a Global Unique Temporary Identifier (GUTI).

The security function can include an integrity protection and/or encryption function. When integrity protection is enabled, the UE 102 can generate a message authentication code for integrity (MAC-I) to protect integrity of the data. Thus, the UE 102 in this case generates a security-protected packet including the data and the MAC-I. When encryption is enabled, the UE 102 can encrypt the data to obtain an encrypted packet, so that the security-protected packet includes encrypted data. When both integrity protection and encryption are enabled, the UE 102 can generate a MAC-I for protecting integrity of the data and encrypt the data along with the MAC-I to generate an encrypted packet and an encrypted MAC-I. The UE 102 then can transmit the security-protected packet to the RAN 105 while in the RRC_INACTIVE or RRC_IDLE state.

In some implementations, the data is an uplink (UL) service data unit (SDU) of the packet data convergence protocol (PDCP) or SDAP. The UE 102 applies the security function to the SDU and includes the secured SDU in a first UL PDU (e.g., a UL PDCP PDU). The UE 102 then includes the UL PDCP PDU in a second UL PDU such as a UL MAC PDU, which can be associated with the medium access control (MAC) layer. Thus, the UE 102 in these cases transmits the secured UL PDCP PDU in the UL MAC PDU. In some implementations, the UE 102 can include, in the UL MAC PDU, a UL RRC message. In further implementations, the UE 102 may not include a UL RRC message in the UL MAC PDU. In this case, the UE 102 may not include a UE ID of the UE 102 in the UL MAC PDU not including a UL RRC message. In yet further implementations, the UE 102 can include the UL PDCP PDU in a UL radio link control (RLC) PDU and then include the UL RLC PDU in the UL MAC PDU. In the case of including the UL RRC message in the UL MAC PDU, the UE 102 in some implementations generates an RRC MAC-I and includes the RRC MAC-I in the UL RRC message. For example, the RRC MAC-I is a resumeMAC-I field (e.g., as specified in 3GPP specification 38.331). In further implementations, the UE can obtain the RRC MAC-I from the UL RRC message with an integrity key (e.g., K_{RRCint} key), an integrity protection algorithm, and other parameters COUNT (e.g., 32-bit, 64-bit or 128-bit value), BEARER (e.g., 5-bit value) and DIRECTION (e.g., 1-bit value).

In further implementations, the data is a UL service data unit (SDU) of the NAS. The UE 102 applies the security function to the SDU and includes the secured SDU in a first UL PDU such as a NAS PDU, which can be associated with the NAS layer. For example, the NAS layer can be an MM sublayer or SM sublayer of 5G, Evolved Packet System (EPS), or 6G. Then the UE 102 can include the UL NAS PDU in a second UL PDU such as a UL RRC message. Thus, the UE 102 in these cases transmits the (first) secured UL NAS PDU in the UL RRC message. In some implementations, the UE 102 can include the UL RRC message in a UL MAC PDU and transmits the UL MAC PDU to a base station (e.g., base station 104 or 106) via a cell (e.g., cell 124 or 126). In this case, the UE 102 may not include an RRC MAC-I in the UL RRC message. Alternatively, the UE 102 may include an RRC MAC-I as described above.

In some implementations, the UL RRC message described above can be a common control channel (CCCH) message, an RRC resume request message, or an RRC early data request message. The UL RRC message can include a UE ID of the UE 102 as described above.

More generally, the UE 102 can secure the data using at least one of encryption and integrity protection, include the secured data as a security-protected packet in the first UL PDU, and transmit the first UL PDU to the RAN 105 in the second UL PDU.

In some scenarios and implementations, the base station 106 can retrieve the UE ID of the UE 102 from the UL RRC message and identify the base station 104 as the destination of the data in the first UL PDU, based on the determined UE ID. In one example implementation, the base station 106 retrieves the first UL PDU from the second UL PDU and transmits the first UL PDU to the base station 104. The base station 104 then retrieves the security-protected packet from the first UL PDU, applies one or two security functions to decrypt the data and/or check the integrity protection, and transmits the data to the CN 110 (e.g., SGW 112, UPF 162, MME 114 or AMF 164) or an edge server. In some implementations, the edge server can operate within the RAN 105. More specifically, the base station 104 derives at least one security key from UE context information of the UE 102. Then the base station 104 retrieves the data from the security-protected packet by using the at least one security key and transmits the data to the CN 110 or edge server. When the security-protected packet is an encrypted packet, the base station 104 decrypts the encrypted packet to obtain the data by using the at least one security key (e.g., an encryption and/or decryption key). If the security-protected packet is an integrity-protected packet, the integrity-protected packet may include the data and the MAC-I. The base station 104 can verify whether the MAC-I is valid for the security-protected packet by using the at least one security key (e.g., an integrity key). When the base station 104 confirms that the MAC-I is valid, the base station 104 sends the data to the CN 110 or edge server. However, when the base station 104 determines that the MAC-I is invalid, the base station 104 discards the security-protected packet. Further, if the security-protected packet is both encrypted and integrity-protected, the encrypted and integrity-protected packet may include the encrypted packet along with the encrypted MAC-I. The base station 104 in this case decrypts the encrypted packet and the encrypted MAC-I to obtain the data and the MAC-I. The base station 104 then determines whether the MAC-I is valid for the data. If the base station 104 determines that the MAC-I is valid, the base station 104 retrieves the data and forwards the data to the CN 110 or edge server. However, if the base station 104 determines that the MAC-I is invalid, the base station 104 discards the packet.

In another implementation, the base station 106 retrieves the security-protected packet from the first UL PDU. The base station 106 performs a retrieve UE context procedure with the base station 104 to obtain UE context information of the UE 102 from the base station 104. The base station 106 derives at least one security key from the UE context information. Then the base station 106 retrieves the data from the security-protected packet by using the at least one security key and transmits the data to the CN 110 (e.g., UPF 162) or an edge server. When the security-protected packet is an encrypted packet, the base station 106 decrypts the encrypted packet to obtain the data by using the at least one security key (e.g., an encryption and/or decryption key). If the security-protected packet is an integrity-protected packet, the integrity protected packet may include the data and the MAC-I. The base station 106 can verify whether the MAC-I is valid for the security-protected packet by using the at least one security key (e.g., an integrity key). When the base station 106 confirms that the MAC-I is valid, the base station 106 sends the data to the CN 110. On the other hand, when the base station 106 determines that the MAC-I is invalid, the base station 106 discards the security-protected packet. Further, if the security-protected packet is both encrypted and integrity-protected, the encrypted and integrity-protected packet may include the encrypted packet along with the encrypted MAC-I. The base station 106 in this case decrypts the encrypted packet and the encrypted MAC-I to obtain the data and the MAC-I. The base station 106 then determines whether the MAC-I is valid for the data. If the base station 106 determines that the MAC-I is valid, the base station 106 retrieves the data and forwards the data to the CN 110. However, if the base station 106 determines that the MAC-I is invalid, the base station 106 discards the packet.

In other scenarios and implementations, the base station 104 can retrieve the UE ID of the UE 102 from the UL RRC message and identify that the base station 104 stores UE context information of the UE 102. Thus, the base station 104 retrieves the security-protected packet from the first UL PDU, retrieves the data from the security-protected packet, and sends the data to the CN 110 or edge server as described above.

Further, the RAN 105 in some cases transmits data in the downlink (DL) direction to the UE 102 operating in the RRC_INACTIVE or RRC_IDLE state.

For example, when the base station 104 determines that data is available for downlink transmission to the UE 102 currently operating in the RRC_INACTIVE or RRC_IDLE state, the base station 104 can apply at least one security function to the data to generate a security-protected packet, generate a first DL PDU including the security-protected packet, and the first DL PDU in a second DL PDU. To secure the data, the base station 104 can apply the security function (e.g., integrity protection and/or encryption) to the data. More particularly, when integrity protection is enabled, the base station 104 generates a MAC-I for protecting integrity of the data, so that the security-protected packet includes the data and the MAC-I. When encryption is enabled, the base station 104 encrypts the data to generate an encrypted packet, so that the security-protected packet is an encrypted packet. Further, when both integrity protection and encryption are enabled, the base station 104 can generate a MAC-I for protecting the integrity of the data and encrypt the data along with the MAC-I to generate an encrypted packet and an encrypted MAC-I. The base station 104 in some implementations generates a first DL PDU, such as a DL PDCP PDU, using the security-protected packet, includes the first DL PDU in a second DL PDU associated with the MAC layer for example (e.g., a DL MAC PDU), and transmits the second DL PDU to the UE 102 without first causing the UE 102 to transition from the RRC_INACTIVE or RRC_IDLE state to the RRC_CONNECTED state. In some implementations, the base station 104 includes the DL PDCP PDU in a DL RLC PDU, includes the DL RLC PDU in the DL MAC PDU and transmits the DL MAC PDU to the UE 102 without first causing the UE 102 to transition from the RRC_INACTIVE or RRC_IDLE state to the RRC_CONNECTED state.

In another implementation, the base station 104 transmits the first DL PDU to the base station 106, which then generates a second PDU (e.g., a DL MAC PDU) including the first DL PDU and transmits the second DL PDU to the UE 102 without first causing the UE 102 to transition from the RRC_INACTIVE or RRC_IDLE state to the RRC_CONNECTED state. In some implementations, the base station 106 generates a DL RLC PDU including the first DL PDU and includes the DL RLC PDU in the second DL PDU. In yet another implementation, the base station 104 includes the first DL PDU in a DL RLC PDU and transmits the DL RLC PDU to the base station 106, which then generates a second DL PDU (e.g., a DL MAC PDU), including the DL RLC PDU, and transmits the second DL PDU to the UE 102.

In some implementations, the base station (i.e., the base station 104 or 106) generates a downlink control information (DCI) and a cyclic redundancy check (CRC) scrambled with an ID of the UE 102 to transmit the second DL PDU generated by the base station. In some implementations, the ID of the UE 102 can be a Radio Network Temporary Identifier (RNTI). For example, the RNTI can be a cell RNTI (C-RNTI), a temporary C-RNTI or an inactive C-RNTI. The base station transmits the DCI and scrambled CRC on a physical downlink control channel (PDCCH) to the UE 102 operating in the RRC_INACTIVE or RRC_IDLE state. The base station scrambles the CRC with the ID of the UE 102. In some implementations, the base station may assign the ID of the UE 102 to the UE 102 in a random access response or a message B (MsgB) that the base station transmits in a random access procedure with the UE 102 before transmitting the DCI and scrambled CRC. In further implementations, the base station may assign the ID of the UE 102 to the UE 102 in an RRC message (e.g., RRC release message or an RRC reconfiguration message) that the base station transmits to the UE 102 before transmitting the DCI and scrambled CRC, e.g., while the UE 102 was in the RRC_CONNECTED state.

The UE 102 operating in the RRC_INACTIVE or RRC_IDLE state can receive the DCI and scrambled CRC on the PDCCH. Then the UE 102 confirms that a physical downlink shared channel (PDSCH), including the second DL PDU, is addressed to the UE 102 according to the ID of the UE 102, DCI, and scrambled CRC. The UE 102 then can retrieve the data from the security-protected packet. If the security-protected packet is an encrypted packet, the UE 102 can decrypt the encrypted packet using the appropriate decryption function and the security key to obtain the data. If the security-protected packet is the integrity-protected packet including the data and the MAC-I, the UE 102 can determine whether the MAC-I is valid. If the UE 102 confirms that the MAC-I is valid, the UE 102 retrieves the data. If, however, the UE 102 determines that the MAC-I is invalid, the UE 102 discards the packet. Finally, when the security-protected packet is both encrypted and integrity-protected, with encrypted data and an encrypted MAC-I, the UE 102 can decrypt the encrypted packet and encrypted MAC-I to obtain the data and the MAC-I. The UE 102 can then verify that the MAC-I is valid for the data. If the UE 102 confirms that the MAC-I is valid, the UE 102 retrieves and processes the data. Otherwise, when the UE 102 determines that the MAC-I is invalid, the UE 102 discards the data.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a Medium Access Control (MAC) controller 132 configured to perform a random access procedure with one or more user devices, receive uplink MAC protocol data units (PDUs) to one or more user devices, and transmit downlink MAC PDUs to one or more user devices. The processing hardware 130 can also include a Packet Data Convergence Protocol (PDCP) controller 134 configured to transmit DL PDCP PDUs in accordance with which the base station 104 can transmit data in the downlink direction, in some scenarios, and receive UL PDCP PDUs in accordance with which the base station 104 can receive data in the uplink direction, in other scenarios. The processing hardware further can include an RRC controller 136 to implement procedures and messaging at the RRC sublayer of the protocol communication stack. The processing hardware 130 in an example implementation includes an RRC inactive controller 138 configured to manage uplink and/or downlink communications with one or more UEs operating in the RRC_INACTIVE or RRC_IDLE state. The base station 106 can include generally similar components. In particular, components 140, 142, 144, 146, and 148 of the base station 106 can be similar to the components 130, 132, 134, 136, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC inactive controller 158 configured to manage uplink and/or downlink communications when the UE 102 operates in the RRC_INACTIVE state. The processing hardware 150 in an example implementation includes a Medium Access Control (MAC) controller 152 configured to perform a random access procedure with a base station, transmit uplink MAC protocol data units (PDUs) to the base station, and receive downlink MAC PDUs from the base station. The processing hardware 150 can also include a PDCP controller 154 configured to, in some scenarios, transmit DL PDCP PDUs in accordance with which the base station 106 can transmit data in the downlink direction, and, in further scenarios, receive UL PDCP PDUs in accordance with which the base station 106 can receive data in the uplink direction. The processing hardware further can include an RRC controller 156 to implement procedures and messaging at the RRC sublayer of the protocol communication stack.

FIG. 1B depicts an example distributed or disaggregated implementation of any one or more of the base stations 104, 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller such as PDCP controller 134, 144, RRC controller 136, 146 and/or RRC inactive controller 138, 148. In some implementations, the CU 172 can include a radio link control (RLC) controller configured to manage or control one or more RLC operations or procedures. In further implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or an RLC controller configured to manage or control one or more RLC operations or procedures. The process hardware can also include a physical layer controller configured to manage or control one or more physical layer operations or procedures.

In some embodiments, the RAN 105 supports Integrated Access and Backhaul (IAB) functionality. In some implementations, the DU 174 operates as an (IAB)-node, and the CU 172 operates as an IAB-donor.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can connect to multiple CU-CP 172A through the E1 interface. The CU-CP 172A can connect to one or more DU 174s through an F1-C interface. The CU-UP 172B can connect to one or more DU 174 through the F1-U interface under the control of the same CU-CP 172A. In some implementations, one DU 174 can connect to multiple CU-UP 172B under the control of the same CU-CP 172A. In such implementations, the connectivity between a CU-UP 172B and a DU 174 is established by the CU-CP 172A using Bearer Context Management functions.

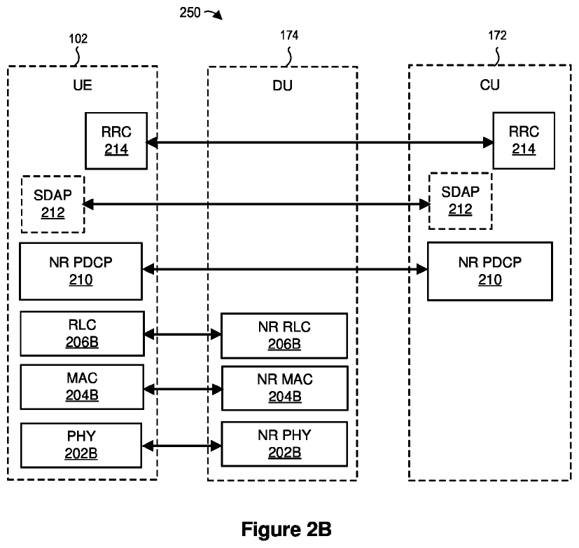

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide Data Radio Bearers (DRBs) to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250, which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

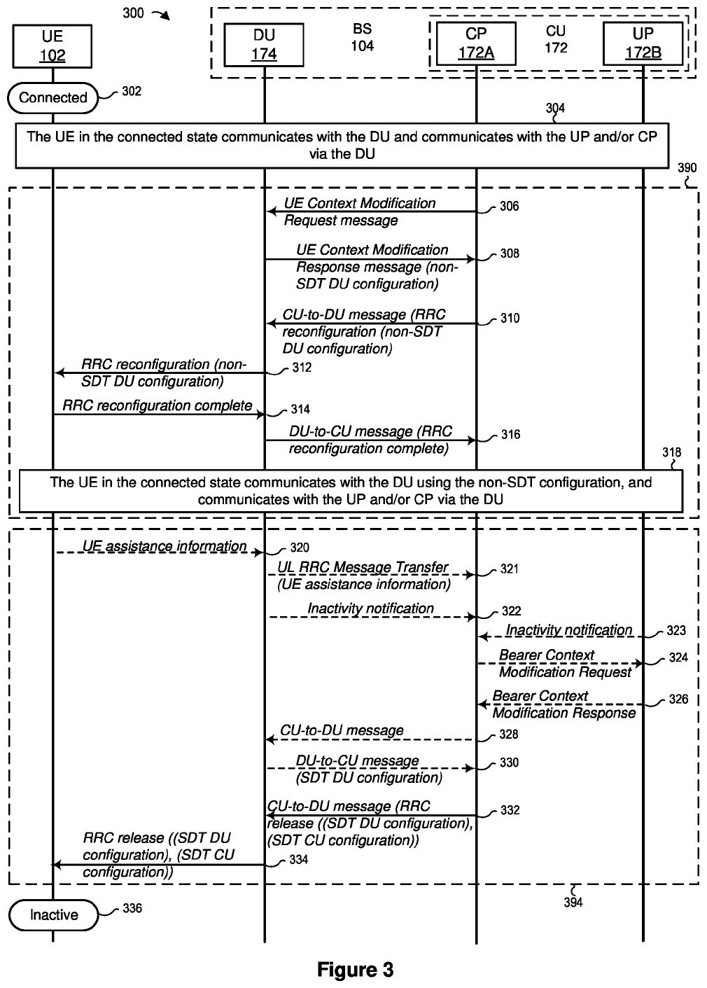

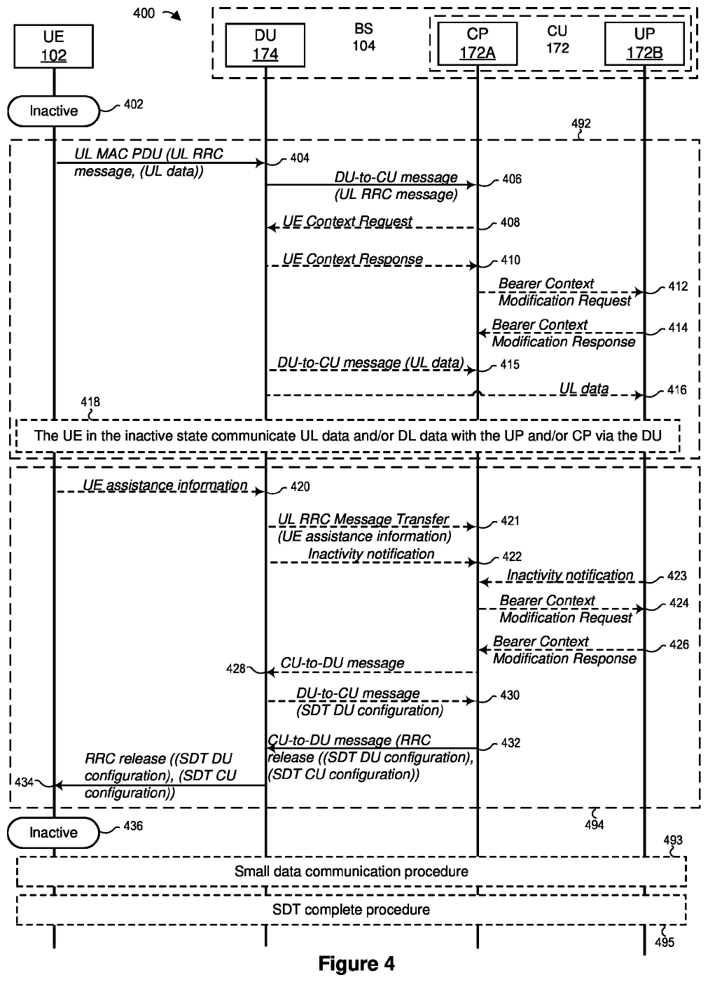

Next, several example scenarios that involve several components of FIG. 1A and relate to transmitting data in an inactive or idle state are discussed next with reference to FIGS. 3 and 4. To simplify the following description, the “inactive state” is used and can represent the RRC_INACTIVE or RRC_IDLE state, and the “connected state” is used and can represent the RRC_CONNECTED state.

Referring first to FIG. 3, which illustrates a scenario 300, in which the base station 104 includes a central unit (CU) 172 and a distributed unit (DU) 174, and the CU 172 includes a CU-CP 172A and a CU-UP 172B. In the scenario 300, the UE 102 initially operates in a connected state 302 and communicates 304 with the DU 174 by using a DU configuration (i.e., a first non-SDT configuration), and further communicates 304 with the CU-CP 172A and/or CU-UP 172B via the DU 174 by using a CU configuration (i.e., a first non-SDT CU configuration). While the UE communicates 304 with the base station 104, the CU-CP 172A sends 306 a UE Context Modification Request message. In response, the DU 174 sends 308 a UE Context Modification Response message to including a non-SDT configuration (i.e., a second non-SDT configuration) for the UE 102 to the CU-CP 172A. The CU-CP 172A generates an RRC reconfiguration message including the non-SDT DU configuration and transmits 310 a first CU-to-DU message (e.g., DL RRC Message Transfer message), including the RRC reconfiguration message, to the DU 174. In turn, the DU 174 transmits 312 the RRC reconfiguration message to the UE 102. In response, the UE 102 transmits 314 an RRC reconfiguration complete message to the DU 174, which in turn transmits 316 a first DU-to-CU message (e.g., UL RRC Message Transfer message), including the RRC reconfiguration complete message, to the CU-CP 172A.

After receiving 312 the RRC reconfiguration message, the UE 102 in the connected state communicates 318 with the DU 174 using the second non-SDT DU configuration. The UE 102 further communicates with the CU-CP 172A and/or CU-UP 172B via the DU 174. In cases where the RRC reconfiguration message does not include a CU configuration, the UE 102 communicates 318 with the CU-CP 172A and/or CU-UP 172B via the DU 174 using the first non-SDT CU configuration. In cases where the RRC reconfiguration message includes a non-SDT CU configuration (i.e., a second non-SDT CU configuration), the UE 102 communicates 318 with the CU-CP 172A and/or CU-UP 172B via the DU 174, using the second non-SDT CU configuration.

In some implementations, the second non-SDT CU configuration augments the first non-SDT CU configuration and/or includes at least one new configuration parameter not included in the first non-SDT CU configuration. In some such cases, the UE 102 and at least one of the CU-CP 172A and/or the CU-UP 172B communicate 318 with one another using the second non-SDU CU configuration as well as configuration parameters in the first non-SDT CU configuration that the second non-SDU CU configuration does not augment. In some implementations, the first non-SDT CU configuration includes configuration parameters related to operations of RRC and/or PDCP protocol layers (e.g., RRC 214 and/or NR PDCP 210), that the UE 102 and CU 172 use to communicate with one another while the UE 102 operates in the connected state. Similarly, in further implementations, the second non-SDT CU configuration includes configuration parameters related to operations for the RRC and/or PDCP protocol layers, that the UE 102 and CU 172 use to communicate with one another while the UE 102 operates in the connected state.

In some implementations, the first non-SDT CU configuration includes configuration parameters in a RadioBearerConfig information element (IE) and/or MeasConfig IE (e.g., as defined in 3GPP specification 38.331 v16.7.0 or later). Similarly, the second non-SDT CU configuration includes configuration parameters in the RadioBearerConfig IE and/or MeasConfig IE (e.g., as defined in 3GPP specification 38.331 v16.7.0 or later). In some implementations, the first non-SDT CU configuration is or includes a RadioBearerConfig IE and/or a MeasConfig IE, and the second non-SDT CU configuration is or includes a RadioBearerConfig IE and/or MeasConfig IE.

In some implementations, the first non-SDT DU configuration includes configuration parameters related to operations of RRC, RLC, MAC, and/or PHY protocol layers (e.g., RLC 206B, MAC 204B and/or PHY 202B) that the UE 102 and DU 174 use to communicate with one another while the UE 102 operates in the connected state. Similarly, in further implementations, the second non-SDT DU configuration includes configuration parameters related to operations of the RRC, RLC, MAC, and/or PHY protocol layers that the UE 102 and DU 174 use to communicate with one another while the UE 102 operates in the connected state.

In some implementations, the first non-SDT DU configuration includes configuration parameters in a CellGroupConfig IE (e.g., as defined in 3GPP specification 38.331 v16.7.0). Similarly, the second non-SDT DU configuration includes configuration parameters in the CellGroupConfig IE (e.g., defined in 3GPP specification 38.331 v16.7.0). In some implementations, the first non-SDT DU configuration and the second non-SDT DU configuration are CellGroupConfig IEs.

The events 306, 308, 310, 312, 314, 316 and 318 are collectively referred to in FIG. 3 as a non-SDT resource configuration/reconfiguration procedure 390.

Depending on the implementation, while the UE 102 communicates with the base station 104 or after the non-SDT resource configuration/reconfiguration procedure 390, the CU-CP 172A determines to cause the UE 102 to transition to an inactive state from the connected state, based on data inactivity of the UE 102 (i.e., the UE 102 in the connected state has no data activity with the base station 104). In some implementations, either while the UE 102 communicates with the base station 104 or after the non-SDT resource configuration/reconfiguration procedure 390, the UE 102 determines or detects data inactivity and transmits 320, to the DU 174, UE assistance information (e.g., a UEAssistanceInformation message) indicating that the UE 102 prefers or requests to transition to the inactive state or leave the connected state. In some implementations, the UE 102 indicates, in the UE assistance information, that the UE 102 prefers or requests to transition to the inactive state with SDT configured. In turn, the DU 174 transmits 321 a UL RRC Message Transfer message including the UE assistance information to the CU-CP 172A. Thus, the CU-CP 172A can determine that the UE 102 has data inactivity based on the UE assistance information.

In other implementations, the DU 174 performs data inactivity monitoring for the UE 102. Depending on the implementation, the CU-CP 172A transmits a CU-to-DU message (e.g., a UE Context Setup Request message or a UE Context Modification Request message) to the DU 174 to request or command the DU 174 to perform the data inactivity monitoring. In some cases where the DU 174 detects or determines that the UE 102 has data inactivity during the monitoring, the DU 174 transmits 322 an inactivity notification (e.g., UE Inactivity Notification message) to the CU-CP 172A. Thus, the CU-CP 172A can determine that the UE 102 has data inactivity based on the inactivity notification received from the DU 174.

In yet other implementations, the CU-UP 172B performs data inactivity monitoring for the UE 102. In some such implementations, the CU-CP 172A transmits a CP-to-UP message (e.g., a Bearer Context Setup Request message or a Bearer Context Modification Request message) to the CU-UP 172B to request or command the CU-UP 172B to perform the data inactivity monitoring. In some cases where the CU-UP 172B detects or determines that the UE 102 has data inactivity during the monitoring, the CU-UP 172B transmits 323 an inactivity notification (e.g., Bearer Context Inactivity Notification message) to the CU-CP 172A. Thus, the CU-CP 172A can determine that the UE 102 has data inactivity based on the inactivity notification received from the CU-UP 172B. In some implementations, the CU-CP 172A determines that the UE 102 has data inactivity based on the UE assistance information, inactivity notification of the event 322, and/or inactivity notification of the event 323.

In some implementations, after a certain period of data inactivity, the CU-CP 172A determines that neither the CU 172 (i.e., the CU-CP 172A and/or the CU-UP 172B) nor the UE 102 has transmitted any data in the downlink direction or the uplink direction, respectively, during the period. In some implementations, in response to the determination, the CU-CP 172A determines to cause the UE 102 to transition to the inactive state with SDT configured. Alternatively, the CU-CP 172A determines to cause the UE 102 to transition to the inactive state without SDT configured in response to determining that the UE 102 has data inactivity.

In response to or after determining that the UE 102 has data inactivity (e.g., for a certain period) or determining to cause the UE 102 to transition to the inactive state with SDT configured, the CU-CP 172A sends 324, to the CU-UP 172B, a Bearer Context Modification Request message to suspend data transmission for the UE 102. In response, the CU-UP 172B suspends data transmission for the UE 102 and sends 326 a Bearer Context Modification Response message to the CU-CP 172A. In some implementations, in response to or after determining that the UE 102 has data inactivity (e.g., for the certain period) or determining to cause the UE 102 to transition to the inactive state with SDT configured, the CU-CP 172A sends 328 a second CU-to-DU message (e.g., a UE Context Modification Request message) to instruct the DU 174 to provide an SDT DU configuration for the UE 102. In some implementations, the CU-CP 172A includes an SDT request indication (e.g., an IE such as a CG-SDT Query Indication IE or SDT Query Indication IE) to request an SDT DU configuration in the second CU-to-DU message.

In further implementations, in response to the SDT request indication or the second CU-to-DU message, the DU 174 transmits 330 a second DU-to-CU message (e.g., UE Context Modification Response message) to the CU-CP 172A. Alternatively, the DU 174 does not include the SDT DU configuration in the second DU-to-CU message. Instead, the DU 174 sends, to the CU-CP 172A, an additional DU-to-CU message (e.g., UE Context Modification Required message), including the SDT DU configuration, after receiving the second CU-to-DU message or transmitting the second DU-to-CU message. In some implementations, the CU-CP 172A transmits an additional CU-to-DU message (e.g., UE Context Modification Confirm message) to the DU 174 in response to the additional CU-to-DU message.

In other implementations, the CU-CP 172A transmits the second CU-to-DU message and receives the second DU-to-CU message or the additional DU-to-CU message, before determining that the UE 102 has data inactivity. In yet other implementations, the CU-CP 172A includes the SDT request indication in the first CU-to-DU message of the event 308 and the DU 174 includes the SDT DU configuration in the first DU-to-CU message of the event 310 in response to the SDT request indication.

Depending on the implementation, in response to determining to cause the UE 102 to transition to the inactive state with SDT configured, the CU-CP 172A generates an RRC release message (e.g., RRCRelease message or RRCConnectionRelease message) to cause the UE 102 to transition to the inactive state. In some implementations, the CU-CP 172A includes the SDT DU configuration (e.g., if obtained from the DU 174) and/or an SDT CU configuration in the RRC release message. The CU-CP 172A then sends 332 to the DU 174 a third CU-to-DU message (e.g., a UE Context Release Command message, a UE Context Modification Request message, or a DL RRC Message Transfer message) which includes the RRC release message. In turn, the DU 174 transmits 334 the RRC release message to the UE 102. In some implementations, the DU 174 generates a MAC PDU including the RRC release message and transmits 334 the MAC PDU to the UE 102. The RRC release message instructs the UE 102 to transition to the inactive state. The UE 102 transitions 336 to the inactive state from the connected state upon receiving the RRC release message. Depending on the implementation, in response to the third CU-to-DU message, the DU 174 retains the SDT DU configuration (e.g., if generated by the DU 174 during the procedure 328, 330) and releases or retains at least a portion of the first non-SDT DU configuration and/or at least a portion of the second non-SDT DU configuration. The DU 174 can send a third DU-to-CU message (e.g., a UE Context Release Complete message or a UE Context Modification Response message) to the CU-CP 172A in response to the third CU-to-DU message.

In some implementations, the UE 102 monitors a PDCCH using a C-RNTI to receive a DCI while operating 302 in the connected state. In response to or after receiving 334 the RRC release message, the UE 102 stops using the C-RNTI to monitor a PDCCH. In some implementations, the UE 102 retains the C-RNTI in response to or after receiving 334 the RRC release message or transitioning 336 to the inactive state from the connected state. In further implementations, the UE 102 performs a two-step or a four-step random access procedure with the base station 104 (e.g., the CU-CP 172A and/or DU 174) and receives, from the DU 174, a random access response message, including the C-RNTI, in the random access procedure. In other implementations, the UE 102 receives an RRC message (e.g., RRC reconfiguration message), including the C-RNTI from the CU-CP 172A via the DU 174 or another base station (e.g., base station 106) not shown in FIG. 3.

The events 320, 321, 322, 323, 324, 326, 328, 330, 332, and 334 are collectively referred to in FIG. 3 as an SDT configuration procedure 394.

In some implementations, the UE 102 releases the first non-SDT DU configuration and/or second non-SDT DU configuration in response to the RRC release message. In further implementations, the UE 102 releases at least a portion of the first non-SDT DU configuration and at least a portion of the second non-SDT DU configuration in response to the RRC release message. In other implementations, if the RRC release message instructs the UE 102 to transition to the inactive state (i.e., RRC_IDLE), the UE 102 releases the first non-SDT DU configuration and/or second non-SDT configuration. In yet other implementations, if the RRC release message instructs the UE 102 to transition to the inactive state (i.e., RRC_INACTIVE), the UE 102 releases a first portion of the first and/or second non-SDT DU configurations and retains a second portion of the first and/or second non-SDT DU configurations. In yet other implementations, if the RRC release message instructs the UE 102 to transition to the inactive state (i.e., RRC_INACTIVE), the UE 102 retains the first non-SDT DU configuration (not augmented by the second non-SDT DU configuration if received) and/or second non-SDT DU configuration.

In some implementations, the CU-CP 172A does not include an indication in the third CU-to-DU message to instruct the DU 174 to retain the SDT DU configuration. The DU 174 retains the SDT DU configuration as described above. In other implementations, the CU-CP 172A includes an indication in the third CU-to-DU message (e.g., a UE Context Release Command message) to instruct the DU 174 to retain the SDT DU configuration, and the DU 174 retains the SDT DU configuration in response to the indication. If the UE Context Release Command message excludes the indication, the DU 174 releases the SDT DU configuration. In yet other implementations, the CU-CP 172A does not include an indication in the third CU-to-DU message (e.g., a UE Context Modification Request message or a DL RRC Message Transfer message) for the UE 102 to instruct the DU 174 to release the SDT DU configuration. Thus, the DU 174 retains the SDT DU configuration in response to the third CU-to-DU message excluding the indication. If the third CU-to-DU message includes the indication, the DU 174 releases the SDT DU configuration.

In some implementations, the SDT CU configuration (e.g., SDT-Config IE) includes a DRB list (e.g., a std-DRB-List) including a list of DRB ID(s) that indicate ID(s) of DRB(s) configured for SDT. In some implementations, the SDT CU configuration includes an SRB2 indication (e.g., sdt-SRB2-Indication) that indicates an SRB2 configured for SDT. In some implementations, the SDT CU configuration includes a compression protocol continuation indication (e.g., sdt-DRB-ContinueROHC) that indicates whether a PDCP entity for the DRB(s) configured for SDT, during SDT operation (i.e., initial and/or subsequent SDT described for FIG. 4), continues. For example, the compression protocol can be a Robust Header Compression (ROHC). In some implementations, the SDT CU configuration includes a data volume threshold (e.g., sdt-DataVolumeThreshold) for the UE 102 to determine whether the UE 102 can initiate SDT. In some implementations, the CU-CP 172A includes the SDT DU configuration in the SDT CU configuration. In some implementations, “SDT CU configuration” is simplified to “SDT configuration”.

In some implementations, the SDT DU configuration includes at least one of a buffer status reporting (BSR) configuration, a power headroom reporting (PHR) configuration, configured grant (CG) configuration(s) for CG-SDT, a UL bandwidth part (BWP) configuration, a DL BWP configuration for CG-SDT, a time alignment timer value for CG-SDT (e.g., CG-SDT time alignment timer (CG-SDT-TAT) value), and/or a timing advance validity threshold for CG-SDT. In some implementations, the UL BWP configuration configures a dedicated UL BWP for the UE 102 to perform CG-SDT. Depending on the implementation, the UL BWP configuration includes the CG configuration(s), a PUCCH configuration, a PUSCH configuration, and/or a sounding reference signal (SRS) configuration. In some implementations, the DL BWP configuration configures a dedicated DL BWP for the UE 102 during CG-SDT. In some implementations, the DL BWP configuration includes a PDCCH configuration and/or a PDSCH configuration for the UE to receive DL control signals on PDCCH(s) and data on PDSCH(s) from the DU 174 while the UE 102 performs CG-SDT with the DU 174. In some implementations, each of the CG configuration(s) configures periodic radio resources (i.e., CG resources) that the UE 102 uses to transmit data without receiving a dynamic grant for data transmission. Each of the CG configuration(s) configures or includes a periodicity indicating that CG resources periodically occur. In some implementations, the periodicity is a fixed number of symbols, slots, or subframes. Depending on the implementation, some or all of the CG configuration(s) have the same periodicity or different periodicities.

In some implementations, each of the CG configuration(s) configures or includes an offset indicating a time domain offset (e.g., timeDomainOffset), related to a reference time (e.g., system frame number (SFN)), for the CG resources. In some implementations, the CG configuration configures or includes the reference time (e.g., timeReferenceSFN). In some implementations, the CG configuration is or is similar to a ConfiguredGrantConfig IE (e.g., as specified in 3GPP specification 38.331). The DU 174 configures the timing advance validity threshold (e.g., including an RSRP range) for the UE 102 to determine whether the UE 102 can initiate SDT using the configured grant configuration for CG-SDT as described for FIG. 4. In accordance with the timing advance validity threshold, the UE 102 evaluates whether a stored timing advance value is still valid. In implementations where the UE 102 determines that the stored timing advanced value is invalid, the UE 102 initiates an RA-SDT with the CU 172 via the DU 174 as described for FIG. 4. In some implementations, the SDT DU configuration is an SDT-MAC-PHY-CG-Config IE or SDT-MAC-PHY-Config IE.

In some implementations, the “SDT DU configuration” is replaced by “CG-SDT configuration(s)”. In such implementations, the configurations in the SDT DU configuration are specific for CG-SDT. In other implementations, some of the configuration(s) in the SDT DU configuration described above are part of the CG-SDT configuration(s) and the other configuration(s) (e.g., the BSR configuration and/or PHR configuration) in the SDT DU configuration are not part of the CG-SDT configuration(s). The SDT DU configuration includes the CG-SDT configuration(s). In such cases, the UE 102 configures the other configuration(s) for CG-SDT or RA-SDT. In other implementations, the “SDT DU configuration” is simplified to “SDT configuration”.

In some implementations, the DU 174 starts or restarts a DU CG-SDT timer in response to or after: receiving the SDT request indication, generating the CG-SDT configuration(s), receiving 328 the second CU-to-DU message, transmitting 330 the CG-SDT configuration(s) to the CU 172, receiving 332 the third CU-to-DU message, or transmitting 334 the CG-SDT configuration(s) to the UE 102. In further implementations, the DU 174 starts or restarts the DU CG-SDT timer with a timer value to manage the CG-SDT configuration(s).

In some implementations, the timer value is the same as the CG-SDT time alignment timer value. In other implementations, the timer value is close to the CG-SDT time alignment timer value. In one example, the timer value is larger than and close to the CG-SDT time alignment timer value. In another example, the timer value is smaller than and close to the CG-SDT time alignment timer value. In cases where the DU CG-SDT timer expires, the DU 174 releases the CG-SDT configuration(s) or the CG resources configured in the CG-SDT configuration(s). When or after releasing the CG-SDT configuration(s), the DU 174 refrains from receiving PUSCH transmissions from the UE 102 on the radio resources that the RAN 105 reserved or configured for the CG-SDT configuration(s). In some implementations, when or after releasing the CG-SDT configuration(s), the DU 174 schedules transmissions for other UE(s) on the radio resources that were reserved or configured for the CG-SDT configuration(s).

As described above, the RRC release message 334, in some implementations, includes the CG-SDT configuration(s). The UE 102 starts or restarts a UE CG-SDT timer (e.g., CG-SDT-TAT) in response to or after receiving the CG-SDT configuration(s). In some implementations, the UE 102 starts or restarts the UE CG-SDT timer (i.e., a first UE CG-SDT timer) with the CG-SDT time alignment timer value, in response to or after receiving the CG-SDT configuration(s). In some cases where the UE CG-SDT timer expires, the UE 102 releases the CG-SDT configuration(s). In other cases where the UE CG-SDT timer expires, the UE 102 retains the CG-SDT configuration(s) and refrains from transmitting UL transmissions (e.g., MAC PDUs) on the CG resources. In some such instances, the UE 102 releases the CG resources or determines that the CG resources are not valid. Depending on the implementation, when the UE CG-SDT timer expires, the UE 102 releases the SRS configuration or SRS resources configured in the SRS configuration. Alternatively, when the UE CG-SDT timer expires, the UE 102 retains the SRS configuration and refrains from transmitting one or more SRSs to the DU 174 on the SRS resources.

While the UE CG-SDT timer is running, the UE 102 in the inactive state communicates (e.g., performs CG-SDT, transmits SRS(s), and/or receives DL control signals (e.g., DCI) and/or data) with the DU 174 via the dedicated DL BWP and dedicated UL BWP. In some implementations, when the UE CG-SDT timer expires, the UE 102 in the inactive state switches to an initial DL BWP and an initial UL BWP from the dedicated DL BWP and dedicated UL BWP, respectively. In some such cases, the UE 102 retunes transceivers of the UE 102 to switch to the initial DL BWP and initial UL BWP. In some implementations, the UE 102 in the inactive state switches to the initial DL BWP and initial UL BWP to perform a random access procedure, while the RAN 105 configures the UE 102 with the CG-SDT configuration. Depending on the implementation, the UE 102 performs the random access procedure for different cases as described below. In some implementations, the UE 102 in the inactive state switches to the initial DL BWP and initial UL BWP to perform measurements on SSBs that the DU 174 transmits on the initial DL BWP.

In some implementations, the DU 174 or CU-CP 172A configures the dedicated DL BWP and dedicated UL BWP to be the same as or to include the initial DL BWP and initial UL BWP, respectively. In some such implementations, when the UE CG-SDT timer expires, the UE 102 does not switch to the initial DL BWP and initial UL BWP from the dedicated DL BWP and dedicated UL BWP, respectively. In further such cases, the UE 102 does not retune transceivers of the UE 102 due to switching BWPs. In yet further such cases, when the UE 102 in the inactive state performs a random access procedure with the DU 174, the UE 102 performs the random access procedure without switching to the initial DL BWP and initial UL BWP. In such cases, the UE 102 performs measurements on SSBs that the DU 174 transmits within the initial DL BWP, while performing CG-SDT with the DU 174.

In some implementations, in response to or after the UE CG-SDT timer expires, the UE 102 performs RA-SDT with the CU 172 via the DU 174 on the initial UL BWP and initial DL BWP, as described for FIG. 4. That is, the UE 102 determines that RA-SDT is valid in response to or after the UE CG-SDT timer expires.

In some implementations, the DU 174 reserves CG resources configured according to the CG configuration(s). In further implementations, the DU 174 releases the CG resources when releasing either the SDT DU configuration or the CG-SDT configuration(s), or when the DU CG-SDT timer expires. In some implementations, the DU 174 releases the SRS resources configured in the SRS configuration when releasing either the SDT DU configuration or the CG-SDT configuration(s), or when the DU CG-SDT timer expires.

In cases where the DU 174 does not provide the CG-SDT configuration(s) or the SDT DU configuration to the CU-CP 172A, the DU 174 releases all signaling and user data transport resources for the UE 102 in response to the third CU-to-DU message. In cases where the DU 174 provides the SDT DU configuration or the CG-SDT configuration(s) to the CU-CP 172A, the DU 174 retains signaling and user data transport resources for the UE 102 in response to or after receiving the third CU-to-DU message.

In some cases where the SDT DU configuration does not include a configuration for CG-SDT, the CU-CP 172A and/or the DU 174 configures RA-SDT for the UE 102. In some such cases, the UE 102 performs RA-SDT with the CU 172 via the DU 174 as described for FIG. 4.

In some implementations, the CU-CP 172A does not request the DU 174 to provide an SDT DU configuration when determining to cause the UE 102 to transition to the inactive state with SDT configured. In some such cases, the events 328 and 330 are omitted, and the CU-CP 172A does not include the SDT DU configuration in the RRC release message. Alternatively, the CU-CP 172A generates the SDT DU configuration by itself, without requesting the DU 174 to provide an SDT DU configuration, and includes the SDT DU configuration in the RRC release message.

In some implementations, the DU 174 does not include an SDT DU configuration in the second DU-to-CU message. In some such implementations, the DU 174 does not include the SDT DU configuration in the second DU-to-CU message because the UE 102 does not support CG-SDT, and the DU 174 therefore does not support CG-SDT. In other implementations, the DU 174 does not include the SDT DU configuration in the second DU-to-CU message because the DU 174 does not have available radio resources for CG-SDT. In such cases, the RRC release message does not include an SDT DU configuration. Otherwise, the DU 174 transmits an SDT DU configuration to the CU-CP 172A as described above. In some implementations, the DU 174 does not include a configuration for CG-SDT in the SDT DU configuration in the second DU-to-CU message, similar to the SDT DU configuration above.

In some implementations, the CU-CP 172A requests the DU 174 to provide an SDT DU configuration as described above, such as in cases where the UE 102 supports CG-SDT and/or the DU 174 supports CG-SDT. In cases where the UE 102 does not support CG-SDT or the DU 174 does not support CG-SDT, the CU-CP 172A does not request the DU 174 to provide an SDT DU configuration. Depending on the implementation, the CU-CP 172A receives a UE capability (e.g., UE-ETURA-Capability IE, UE-NR-Capability IE, UE-6G-Capability IE) for the UE 102 from the UE 102, the CN 110 (e.g., MME 114 or AMF 164), or the base station 106 while the UE 102 operates 302 in the connected state. The UE capability indicates whether the UE 102 supports CG-SDT. Thus, the CU-CP 172A can determine whether the UE 102 supports CG-SDT in accordance with the UE capability. In some implementations, the CU-CP 172A receives, from the DU 174, a DU-to-CU message indicating whether the DU 174 supports CG-SDT. Depending on the implementation, the DU-to-CU message is the second DU-to-CU message, the message of the event 308 or 316, or a non-UE associated message (e.g., a non-UE associated F1AP message defined in 3GPP specification 38.473).

In some implementations, the DU 174 determines whether to provide an SDT DU configuration for the UE 102 to the CU-CP 172A, depending on whether the UE 102 supports CG-SDT or not. In further implementations, the DU 174 additionally determines whether to provide an SDT DU configuration for the UE 102 to the CU-CP 172A, depending on whether the DU 174 supports CG-SDT or not. In cases where the UE 102 supports CG-SDT and/or the DU 174 supports CG-SDT, the DU 174 provides an SDT DU configuration for the UE 102 to the CU-CP 172A as described above. In cases where the UE 102 does not support CG-SDT or the DU 174 does not support CG-SDT, the DU 174 does not provide an SDT DU configuration for the UE 102 (e.g., the DU 174 does not include the SDT DU configuration in the second DU-to-CU message). In some implementations, the DU 174 receives the UE capability from the CU-CP 172A while the UE 102 operates 302 in the connected state or in the inactive state before the event 302. Thus, the DU 174 can determine whether the UE supports CG-SDT in accordance with the UE capability. In some implementations, the DU 174 sends a DU-to-CU message to the CU-CP 172A to indicate whether the DU 174 does support CG-SDT or not, as described above.

Referring now to FIG. 4, a scenario 400 depicts small data transmission similar to the scenario 300, but in which the UE 102 is in an inactive state. In the scenario 400, the base station 104 includes a CU 172 and a DU 174. The CU 172 includes a CU-CP 172A and a CU-UP 172B. In the scenario 400, the UE 102 initially operates 402 in an inactive state with SDT configured. In some implementations or scenarios, the UE 102 transitions to the inactive state with SDT configured from the connected state as described for FIG. 3. In some such implementations, the UE receives from the CU-CP 172A an RRC release message including a first SDT CU configuration and/or a first SDT DU configuration (e.g., events 332, 334).

In other implementations or scenarios, the UE 102 transitions to the inactive state with SDT configured from the inactive state without SDT configured. For example, the UE 102 receives, from a base station (e.g., the base station 104 or base station 106), an RRC release message causing the UE 102 to transition to the inactive state and not configuring SDT (e.g., indicating releasing SDT or not including an SDT configuration in the RRC release message). In such a case, the UE 102 transitions to the inactive state without SDT configured in response to the RRC release message. In some implementations, the UE 102 in the inactive state with or without SDT configured performs a RAN notification area (RNA) update with the base station without state transitions. During the RNA update, the UE 102 receives another RRC release message including a first SDT CU configuration and/or a first SDT DU configuration from the base station, similar to the RRC release message of the events 332, 334. The components (e.g., UE 102, CU 172, DU 174, etc.) in FIG. 4 can be the same as or different from the equivalently numbered components in FIG. 3.

Later in time, the UE 102 operating in the inactive state with SDT configured initiates SDT. In response to or after initiating SDT, the UE 102 generates an initial UL MAC PDU, which includes a UL RRC message and transmits 404 the initial UL MAC PDU to the DU 174 on a cell (e.g., the cell 124 or another cell of the base station 104 not shown in FIG. 1A). The following events between the UE 102 and the DU 174 occur on the cell. In some implementations, the UE 102 starts an SDT session timer in response to initiating the SDT. In some implementations, the SDT session timer is a new timer (e.g., as defined in an RRC specification (e.g., v17.0.0)). The DU 174 retrieves the UL RRC message from the initial UL MAC PDU, generates a first DU-to-CU message including the UL RRC message, and sends 406 the first DU-to-CU message to the CU-CP 172A. In some implementations, the first DU-to-CU message is an Initial UL RRC Message Transfer message. In other implementations, the first DU-to-CU message is a UL RRC Message Transfer message.

In scenarios in which the UE 102 initiates SDT to transmit UL data qualifying for SDT, the UE 102 includes the UL data in the initial UL MAC PDU that the UE 102 transmits 404. In some implementations, the UL data includes a PDU (e.g., PDCP PDU) or a data packet (e.g., IP packet or Ethernet packet). In scenarios in which the UE 102 initiates SDT to receive DL data, the UE 102 does not include a UL data packet in the initial UL MAC PDU that the UE 102 transmits 404. In some implementations, the UE 102 initiates SDT to receive DL data in response to receiving a paging from the DU 174. In some such scenarios, the UE 102 includes an SDT indication in the initial UL MAC PDU or the UL RRC message to indicate, to the base station 104, that the UE 102 is initiating SDT to receive DL data. In some implementations, the DL data includes a PDU (e.g., PDCP PDU) or a data packet (e.g., IP packet or Ethernet packet).

In some implementations, the UE 102 in the inactive state performs a random access procedure with the DU 174 to transmit 404 the UL MAC PDU. In some such cases, the SDT is an RA-SDT. For example, the random access procedure can be a four-step random access procedure or a two-step random access procedure. In the case of the four-step random access procedure, the UE 102 transmits a random access preamble to the DU 174 and, in response, the DU 174 transmits to the UE 102 a random access response (RAR) including an uplink grant, a temporary C-RNTI, and a timing advance command, and the UE 102 transmits 404 the UL MAC PDU to the DU 174 in accordance with the uplink grant. The DU 174 receives 404 the UL MAC PDU in accordance with the uplink grant in the RAR and transmits a DL MAC PDU including a contention resolution MAC control element to the UE 102 in response. In the case of the two-step random access procedure, the UE 102 transmits 404, to the DU 174, a message A (MsgA) including a random access preamble and the UL MAC PDU in accordance with two-step random access configuration parameters. In some implementations, the UE 102 receives a message B (MsgB) including a temporary C-RNTI and a timing advance command from the DU 174 in response to the MsgA. In further implementations, the DU 174 includes a contention resolution MAC control element in the MsgB. The UE 102 receives the two-step random access configuration parameters in a system information broadcast by the DU 174 on the cell 124 before transmitting 404 the UL MAC PDU. The DU 174 receives 404 the UL MAC PDU in accordance with the two-step random access configuration parameters.

When the UE 102 succeeds in a contention resolution in the random access procedure (i.e., receives the contention resolution MAC control element), the UE 102 discards a previously retained C-RNTI (e.g., described for FIG. 3) and determines the temporary C-RNTI to be a new C-RNTI. The UE 102 monitors a PDCCH from the DU 174 using the C-RNTI to communicate 418 data (e.g., UL data and/or DL data) with the base station 104. In details, the UE 102 receives a DCI and a cyclic redundancy check (CRC) of the DCI on a PDCCH from the DU 174 and verifies the CRC using the C-RNTI. Depending on the implementation, the DCI includes an uplink grant or a downlink assignment. If the UE 102 verifies the CRC is correct and the DCI includes an uplink grant, the UE 102 uses the uplink grant to transmit 418 UL data to the DU 174. If the UE 102 verifies the CRC is correct and the DCI includes a downlink assignment, the UE 102 uses the downlink assignment to receive 418 DL data from the DU 174.

In other implementations, the UE 102 transmits 404 the UL MAC PDU on CG resources, such as in cases where the UE 102 receives or is configured with CG configuration(s) (e.g., as described for FIG. 3). In such cases, the UE 102 performs CG-SDT. The UE 102 does not perform a random access procedure for transmitting 404 the UL MAC PDU. Thus, the DU 174 receives 404 the UL MAC PDU on the CG resources. In some such implementations, in response to or after generating or transmitting 404 the UL MAC PDU, the UE 102 starts a UE timer (e.g., a second UE CG-SDT timer) if the CU-CP 172A or the DU 174 configures the UE 102 to apply the UE timer during SDT. In some implementations, the UE 102 starts the UE timer with a UE timer value (e.g., cg-SDT-RetransmissionTimer value). In some implementations, the UE 102 receives an RRC release message including the UE timer value from the base station 104, similar to the events 332, 334, 432, and 434. In some implementations, the CP-CP 172A includes the UE timer value in a CG-SDT configuration and transmits the RRC release message including the CG-SDT configuration to the UE 102 via the DU 174. In other implementations, the UE 102 receives the UE timer value in a system information block broadcast by the DU 174 via the cell 124. While the UE timer is running, the UE 102 in the inactive state or SDT session refrains from retransmitting the UL MAC PDU on the CG resources. In some implementations, in response to or after receiving 404 the UL MAC PDU on the CG resources, the DU 174 starts a DU timer (e.g., a second DU CG-SDT timer) with a DU timer value. In some implementations, the DU timer value is the same as or larger than the UE timer value. While the DU timer is running, the DU 174 processes UL transmissions received from the UE 102 on the CG resources as new transmissions.

In some implementations, the UE 102 transmits 418 subsequent UL MAC PDU(s), including one or more UL data packets, on the CG radio resources. In some implementations, the UE 102 transmits 418 the subsequent UL MAC PDU(s) on radio resources configured in uplink grant(s) received on PDCCH(s) from the DU 174. In some implementations, the UE 102 transmits 418 some of the subsequent UL MAC PDU(s) on radio resources configured in the CG configuration and transmits 418 the other of the subsequent UL MAC PDU(s) on radio resources configured in the uplink grant(s).

In some cases where the UE 102 transmits 418 subsequent UL MAC PDU(s) on the CG resources, the UE 102 starts or restarts the timer (e.g., the second UE CG-SDT timer) in response to or after generating or transmitting 418 each of the subsequent UL MAC PDU(s). The UE 102 can start or restart the timer with the timer value as described above. While the UE timer is running, the UE 102 in the inactive state or SDT session refrains from retransmitting the UL MAC PDU. In some implementations, in response to or after receiving 418 each of subsequent UL MAC PDU(s) on the CG resources, the DU 174 starts or restarts the DU timer (e.g., the second DU CG-SDT timer) with the DU timer value. While the DU timer is running, the DU 174 processes UL transmissions received from the UE 102 on the CG resources as new transmissions.

If the UE 102 includes UL data in the initial UL MAC PDU 404, the DU 174 retrieves the UL data from the initial UL MAC PDU. In some such cases, the DU 174 includes the UL data in the DU-to-CU message of the event 406. Alternatively, the DU 174 sends 415 a DU-to-CU message including the UL data to the CU-CP 172A. In some such alternatives, the UL data includes or is a PDCP PDU, an RRC PDU, NAS PDU, or an LTE positioning protocol (LPP) PDU. The PDCP PDU can include an RRC PDU. The UL data can be associated with an SRB (e.g., SRB1 or SRB2). In some implementations, the UE 102 applies one or more security functions (e.g., encryption and/or integrity protection) to the UL data as described above. The CU-CP 172A applies one or more security functions (e.g., decryption and/or integrity protection check) to the UL data as described above. Alternatively, the DU 174 sends 416 the UL data to the CU-UP 172B separately via a user-plane (UP) connection (e.g., a GTP tunnel) as described below. In some such alternatives, the UL data includes or is a PDCP PDU, a SDAP PDU, an IP packet, or an Ethernet packet. In some implementations, the UL data is associated with an SDT DRB. In some implementations, the UE 102 applies one or more security functions (e.g., encryption and/or integrity protection) to the UL data as described above. The CU-UP 172B applies one or more security functions (e.g., decryption and/or integrity protection check) to the UL data as described above.

After receiving 406 the first DU-to-CU message, the CU-CP 172A in some implementations sends 408 a UE Context Request message to the DU 174 to request the DU 174 to establish a UE context for the UE 102. In some implementations, in the UE Context Request message, the CU-CP 172A includes transport layer information for one or more GTP-U tunnels between the CU-UP 172B and DU 174 so that the DU 174 can transmit the UL data and/or subsequent UL data (e.g., in small data communication 418) via the one or more GTP-U tunnels to the CU-UP 172B. In response, depending on the implementation, the DU 174 sends 410 a UE Context Response message to the CU-CP 172A.

In some implementations, the UE Context Request message and UE Context Response message are a UE Context Setup Request message and a UE Context Setup Response message, respectively. In some such implementations, the events 408 and 410 are grouped as a UE Context Setup procedure. In other implementations, the UE Context Request message and UE Context Response message are a UE Context Modification Request message and a UE Context Modification Response message, respectively. In some implementations, the CU-CP 172A does not transmit a UE Context Request message to the DU 174, such as in cases where the DU 174 already has a UE context of the UE 102. In some such implementations, the events 408 and 410 can be omitted or skipped.

After receiving 406 the first DU-to-CU message, transmitting 408 the UE Context Request message, or receiving 410 the UE Context Response message, the CU-CP 172A transmits 412, to the CU-UP 172B, a Bearer Context Modification Request message to resume SDT DRB(s) of the UE 102. In response, the CU-UP 172B resumes the SDT DRB(s) and transmits 414 a Bearer Context Modification Response message to the CU-CP 172A. The events 412 and 414 can be grouped as a Bearer Context Modification procedure. In some implementations, the CU-CP 172A includes a resume indication (e.g., Bearer Context Status Change IE with a “ResumeforSDT” value) in the Bearer Context Modification Request message 424 to indicate the CU-UP 172B resume the SDT DRB(s). In response to the resume indication, the CU-UP 172B resumes the SDT DRB(s) and maintains the non-SDT DRB(s) as suspended or suspends the non-SDT DRB(s).

In some implementations, after receiving 406 the UL RRC message, receiving 408 the UE Context Request message, or transmitting 410 the UE Context Response message, the DU 174 transmits 415 the DU-to-CU message, including the UL data, to the CU-CP 172A, such as in cases where the UL data of the event 404 includes an RRC message or is associated with an SRB (e.g., SRB1 or SRB2). In some cases where the UL data is associated with a DRB, the DU 174 transmits 416 the UL data to the CU-UP 172B, after receiving 406 the UL RRC message, receiving 408 the UE Context Request message or transmitting 410 the UE Context Response message.

In some implementations, the CU-CP 172A includes transport layer information of the CU-UP 172B in the UE Context Request message. The transport layer information of the CU-UP 172B can include an IP address and/or an uplink tunnel endpoint ID (e.g., TEID). In some implementations, the DU 174 transmits 416 the UL data to the CU-UP 172B using the transport layer information of the CU-UP 172B. In some cases where the UE 102 has subsequent UL data (e.g., one or more UL data packets) to transmit, the UE 102 transmits 418 one or more subsequent UL MAC PDUs, including the subsequent UL data, to the DU 174. In turn, the DU 174 retrieves the subsequent UL data from the subsequent UL MAC PDU(s). In cases where the subsequent UL data is associated with one or more SRB (e.g., SRB1 and/or SRB2), the DU 174 transmits 418 the one or more DU-to-CU messages (e.g., UL RRC Message Transfer message(s)) including the subsequent UL data to the CU-CP 172A. Each DU-to-CU message can include a particular UL data packet of the subsequent UL data. In some cases where the CU-CP 172A receives DL data from the CN 110 or edge server, the CU-CP 172A transmits 418 one or more CU-to-DU messages (e.g., DL RRC Message Transfer message(s)) including the DL data (e.g., one or more DL data packets) to the DU 174. In turn, the DU 174 transmits 418 one or more DL MAC PDUs including the DL data to the UE 102 operating in the inactive state. In some implementations, the DL data include or are NAS PDU(s) and/or LPP PDU(s).

In cases where the subsequent UL data is associated with one or more DRBs, the DU 174 transmits 418 the subsequent UL data to the CU-UP 172B, similar to the event 416. In some implementations, the DU 174 includes DU transport layer information of the DU 174 in the UE Context Setup Response message. In turn, the CU-CP 172A includes the transport layer information of the DU 174 in the Bearer Context Modification Request message. In some implementations, the transport layer information of the DU 174 includes an IP address and/or a downlink TEID. In some cases where the CU-UP 172B receives DL data from the CN 110 or edge server, the CU-UP 172B transmits 418 the DL data (e.g., one or more DL data packets) to the DU 174 using the transport layer information of the DU 174. In turn, the DU 174 transmits 418 one or more DL MAC PDUs including the DL data to the UE 102 operating in the inactive state.

In some implementations, the UE 102 includes a buffer status report or a power headroom report in the initial and/or subsequent UL MAC PDU(s) (e.g., in accordance with the BSR configuration and/or PHR configuration, respectively). In the buffer status report, the UE 102 can include or indicate its buffer status for one or more logical channels or logical channel groups. In the power headroom report, the UE 102 can include or indicate power headroom status or value.

In some example scenarios, the subsequent UL data and/or DL data described above include Internet Protocol (IP) packet(s), an Ethernet packet(s), or an application packet(s). In other scenarios, the UL data include or are PDU(s) (e.g., RRC PDU(s), PDCP PDU(s) or RLC PDU(s)) that includes RRC message(s), NAS message(s), IP packet(s), Ethernet packet(s), or application packet(s).

The events 404, 406, 408, 410, 412, 414, 415, 416, and 418 are collectively referred to in FIG. 4 as a small data communication procedure 492. The events 404, 406, 408, 410, 412, 414, 415 and 416 are collectively referred to in FIG. 4 as an initial small data transmission (SDT) procedure 480.

In some implementations, the UL RRC message is an existing RRC resume request message (e.g., an RRCResumeRequest message, an RRCResumeRequest1 message, an RRCConnectionResumeRequest message, or an RRCConnectionResumeRequest1 message). In other implementations, the UL RRC message is a new RRC resume request message, similar to the existing RRC resume request message. For example, the new RRC resume request message may be defined in future 3GPP standards documentation. The new RRC resume request message may be a format of an existing RRC resume request message. In some implementations, for downlink SDT, the UL RRC message includes an SDT indication, which can be a field or information element (IE) (e.g., resumeCause or ResumeCause). In some implementations, the UL RRC message is a common control channel (CCCH) message.

After the UE 102 transmits 404 the UL MAC PDU or communicates 418 the subsequent UL data and/or DL data with the DU 174, the CU-CP 172A, CU-UP 172B, or DU 174 can determine that the UE 102 is in data inactivity based on the UE assistance information, inactivity notification of the event 422 and/or inactivity notification of the event 423, as described above with regard to FIG. 3.

In some implementations, after a certain period of data inactivity, the CU-CP 172A determines that neither the CU 172 nor the UE 102 has transmitted any data in the downlink direction or the uplink direction, respectively, during the period. In response to the determination, the CU-CP 172A can determine to stop the SDT. Alternatively, the CU-CP 172A determines to immediately stop the SDT for the UE 102 in response to determining that the UE 102 is in data inactivity.

In response to or after determining that the UE 102 is in data inactivity (for the certain period) or determining to cause the UE 102 to transition to the inactive state with SDT configured, the CU-CP 172A configures an SDT DU configuration by performing events 424, 426, and/or 428 similar to events 324, 326, and/or 328, respectively.

Similarly, in response to an SDT request indication or a second CU-to-DU message, the DU 174 transmits 430 a second DU-to-CU message (e.g., UE Context Modification Response message) to the CU-CP 172A. In some implementations, the DU 174 includes a second SDT DU configuration in the second DU-to-CU message. In some cases where the DU 174 obtained the first SDT DU configuration, the DU 174 generates the second SDT DU configuration to augment (e.g., replace or update) the first SDT DU configuration. In some implementations, the DU 174 generates the second SDT DU configuration as a complete and self-contained configuration (i.e., a full configuration) (e.g., because the DU 174 does not support delta configuration or none of configuration parameters in the first SDT DU configuration are valid). In some such implementations, the DU 174 includes, in the second DU-to-CU message, a first indication indicating that the second SDT DU configuration is a complete and self-contained configuration (i.e., a full configuration). For example, the first indication can be a setup indication or a full configuration indication.

In other implementations, the DU 174 generates the second SDT DU configuration to update a portion of the first SDT DU configuration (e.g., because the DU 174 supports delta configuration). In some scenarios or implementations, the DU 174 receives the first SDT DU configuration from the CU-CP 172A (e.g., in the second CU-to-DU message). In other scenarios or implementations, the second CU-to-DU message does not include the first SDT DU configuration. In some such cases, the DU 174 still generates the second SDT DU configuration to augment the first SDT DU configuration because the DU 174 generated and retained the first SDT DU configuration. In such implementations, the DU 174 refrains from including the first indication in the second DU-to-CU message in order to indicate that the second SDT DU configuration is a delta configuration (i.e., the second SDT DU configuration includes configuration parameter(s) augmenting the first SDT DU configuration). In some implementations, the DU 174 includes, in the second DU-to-CU message, a second indication indicating that the second SDT DU configuration is a delta configuration. Alternatively, the DU 174 neither includes the second indication nor the first indication in order to indicate that the second SDT DU configuration is a delta configuration.

Alternatively, the DU 174 does not include the second SDT DU configuration in the second DU-to-CU message. Instead, the DU 174 sends, to the CU-CP 172A, another DU-to-CU message (e.g., UE Context Modification Required message) including the second SDT DU configuration (e.g., after receiving the second CU-to-DU message or transmitting the second DU-to-CU message). In some alternative implementations, the CU-CP 172A transmits the second CU-to-DU message and receives the second DU-to-CU message or another DU-to-CU message before or after determining that the UE 102 is in data inactivity.

In yet other implementations, the DU 174 determines to continue to configure the first SDT DU configuration for the UE 102. In some such cases, the DU 174 does not include the first SDT DU configuration in the second DU-to-CU message. After the CU-CP 172A receives the second DU-to-CU message not including an SDT DU configuration, the CU-CP 172A determines that the DU 174 continues to reuse the first SDT DU configuration for the UE 102. In some implementations, the DU 174 includes, in the second DU-to-CU message an indication indicating that the first SDT DU configuration continues to be used for the UE 102. In other implementations, in the second DU-to-CU message, the DU 174 indicates that the first SDT DU configuration reused for the UE 102 by not including an SDT DU configuration in the second DU-to-CU message.

In yet other implementations, the CU-CP 172A refrains from transmitting the first SDT DU configuration to the DU 174. For example, the CU-CP 172A refrains from including the first SDT DU configuration in the second CU-to-DU message. In some cases where the DU 174 does not have the first SDT DU configuration, the DU 174 generates the second SDT DU configuration as a complete and self-contained configuration (e.g., a full SDT DU configuration).

In yet other implementations, the CU-CP 172A includes, in the second CU-to-DU message, an indication to the DU 174 to generate an SDT DU configuration as a complete and self-contained configuration (e.g., a full SDT DU configuration). In response to the indication, the DU 174 generates the second SDT DU configuration as a complete and self-contained configuration (e.g., a full SDT DU configuration).

In yet other implementations, the DU 174 determines to release the first SDT DU configuration and does not configure an SDT DU configuration for the UE 102. In some such cases, the DU 174 includes, in the second DU-to-CU message, an indication indicating that no SDT DU configuration is configured for the UE 102. For example, the indication can be a cause indicating a reason why the DU 174 is unable to configure an SDT DU configuration for the UE 102.

In some implementations, in response to determining to cause the UE 102 to transition to the inactive state with SDT configured, the CU-CP 172A generates an RRC release message (e.g., RRCRelease message RRCConnectionRelease message) to cause the UE 102 to transition to the inactive state. In some implementations, the CU-CP 172A includes the second SDT DU configuration (if obtained from the DU 174) and a second SDT CU configuration in the RRC release message. Alternatively, the CU-CP 172A does not include an SDT configuration in the RRC release message. In some such alternatives, the CU-CP 172A indicates to the UE to release or retain the first SDT CU configuration and/or the first SDT DU configuration in the RRC release message. For example, the CU-CP 172A can include a release indication indicating releasing the first SDT CU configuration or the first SDT DU configuration in the RRC release message. If the CU-CP 172A or the DU 174 determines to reuse the first SDT DU configuration, the RRC release message does not include the release indication and the UE retains the first SDT CU configuration and/or the first SDT DU configuration. In some implementations, the CU-CP 172A includes or does not include the first SDT DU configuration in the RRC release message.

The CU-CP 172A then sends 432 to the DU 174 a third CU-to-DU message including the RRC release message. In turn, the DU 174 transmits 434 the RRC release message to the UE 102. In some implementations, the DU 174 generates a MAC PDU including the RRC release message and transmits 434 the MAC PDU to the UE 102. The RRC release message instructs the UE 102 to transition to the inactive state. The UE 102 stops the SDT and remains 436 in the inactive state upon receiving 434 the RRC release message.

The events 420, 421, 422, 423, 424, 426, 428, 430, 432, and 434 are collectively referred to in FIG. 4 as an SDT complete procedure 494.

During an SDT session (i.e., events 492 and 494), the UE 102 monitors a PDCCH using a C-RNTI to receive a DCI. In some implementations, the UE 102 receives the C-RNTI in the random access procedure described for the event 404. In other implementations, the UE 102 receives and retains the C-RNTI as described for FIG. 3. In response to or after receiving 434 the RRC release message, the UE 102 ends the SDT session and stops using the C-RNTI to monitor a PDCCH. In some implementations, the UE 102 retains the C-RNTI in response to or after receiving 434 the RRC release message or transitioning 436 to the inactive state from the connected state. In cases where the RRC release message 434 configures CG-SDT, the UE 102 in some implementations retains the C-RNTI. In some cases where the RRC release message 434 does not configure or releases CG-SDT, the UE 102 releases the C-RNTI.

After the UE 102 ends the SDT session, the UE 102 in the inactive state monitors a PDCCH using a paging RNTI (P-RNTI). In some scenarios or implementations, the CU-CP 172A determines to page the UE 102 to receive a mobile-terminated call or data. In some implementations, in response to the determination, the CU-CP 172A sends a CU-to-DU message (e.g., Paging message) to the DU 174 to request the DU 174 to page the UE 102. In response to the CU-to-DU message, the DU 174 generates a paging message, a DCI to schedule a PDSCH transmission including the paging message, a CRC of the DCI, scrambles the CRC with the P-RNTI to obtain a scrambled C-RNTI, and transmits the DCI and scrambled CRC on a PDCCH that the UE 102 monitors. The UE 102 receives the DCI and the scrambled CRC on the PDCCH and verifies the scrambled CRC with the P-RNTI. In cases where the UE 102 verifies that the scrambled CRC is valid, the UE 102 receives and decodes the PDSCH transmission in accordance with the DCI and retrieves the paging message from the PDSCH transmission.

In some implementations, the second SDT CU configuration is the same as the first SDT CU configuration. In other implementations, the second SDT CU configuration is different from the first SDT CU configuration. Depending on the implementation, the UE 102 updates (e.g., replaces or modifies) the first SDT CU configuration with the second SDT CU configuration. In some implementations, the CU-CP 172A includes an indication in the RRC release message to indicate to the UE 102 to update the first SDT CU configuration with the second SDT CU configuration. In some such implementations, the UE 102 updates the first SDT CU configuration with the second SDT CU configuration in response to the indication. In other implementations, the CU-CP 172A includes a modification indication in the RRC release message to indicate to the UE 102 to modify the first SDT CU configuration with the second SDT CU configuration. In some such implementations, the UE 102 modifies the first SDT CU configuration with the second SDT CU configuration in response to the modification indication. In yet other implementations, the CU-CP 172A includes a setup indication in the RRC release message to indicate the UE 102 to replace the first SDT CU configuration with the second SDT CU configuration. In some such implementations, the UE 102 replaces the first SDT CU configuration with the second SDT CU configuration in response to the setup indication.

In some implementations, the CU-CP 172A does not include an SDT CU configuration for the UE 102 in the RRC release message 432, 434, in order to configure the UE 102 to retain the first SDT CU configuration and keep using the first SDT CU configuration. When the UE 102 receives 434 the RRC release message, the UE 102 retains the first SDT CU configuration.

In some implementations, the second SDT DU configuration is the same as the first SDT DU configuration. In other implementations, the second SDT DU configuration is different from the first SDT DU configuration. Depending on the implementation, the UE 102 updates (e.g., replaces or modifies) the first SDT DU configuration with the second SDT DU configuration similar to the SDT CU configurations as described above.

In some implementations, the CU-CP 172A does not include an SDT DU configuration for the UE 102 in the RRC release message, in order to configure the UE 102 to retain the first SDT DU configuration and keep using the first SDT DU configuration.

In some cases where the CU-CP 172A and/or the DU 174 support delta configuration, the CU-CP 172A does not send 428 the CU-to-DU message to obtain the second SDT DU configuration from the DU 174. Unless a condition for releasing the first SDT configuration is satisfied, the DU 174 retains the first SDT DU configuration. Alternatively, the CU-CP 172A includes the first SDT DU configuration in the second CU-to-DU message to cause the DU 174 to retain the first SDT DU configuration. In some such cases, the CU-CP 172A does not include an SDT DU configuration and/or an SDT CU configuration in the RRC release message to cause the UE 102 to continue using the first SDT CU configuration and/or the first SDU DU configuration. In some implementations, the CU-CP 172A does not include a release indication in the RRC release message in order to configure the UE to continue using the first SDT DU configuration and/or the first SDT CU configuration. The release indication indicates releasing the previously received SDT DU configuration and/or the SDT CU configuration. In some cases where the CU-CP 172A includes the release indication in the RRC release message, the UE 102 releases the first SDT CU configuration and/or the first SDT DU configuration in response to the release indication.

In some cases where the CU-CP 172A and/or DU 174 do not support delta configuration, the CU-CP 172A does include the SDT DU configuration and/or the SDT CU configuration in the RRC release message as described above.

In some implementations, in response to the third CU-to-DU message, the DU 174 retains the second SDT DU configuration and releases or does not release the first non-SDT DU configuration and/or second non-SDT DU configuration. In further implementations, the DU 174 sends a third DU-to-CU message (e.g., a UE Context Release Complete message or a UE Context Modification Response message) to the CU-CP 172A in response to the third CU-to-DU message. In some implementations, if the RRC release message instructs the UE 102 to transition to the inactive state (i.e., RRC_IDLE), the UE 102 releases a non-SDT configuration (e.g., the first non-SDT DU configuration, first non-SDT CU configuration, second non-SDT DU configuration and/or second non-SDT CU configuration described for FIG. 3) and at least one SDT configuration (e.g., the SDT DU configuration and SDT CU configuration described for FIG. 3).

Examples and implementations for events 320, 321, 322, 323, 324, 326, 328, 330, 332, and 334 can apply to events 420, 421, 422, 423, 424, 426, 428, 430, 432, and 434, respectively. After stopping the SDT, the UE 102 can perform 493 another small data communication procedure with the base station 104, similar to the procedure 492. After completing the procedure 493, the base station 104 can perform 495 an SDT complete procedure with the UE 102, similar to the procedure 494.

In some implementations, the CU-CP 172A does not request the DU 174 to provide an SDT DU configuration for causing the UE 102 to transition the inactive state with SDT configured. In some such cases, the events 428 and 430 are omitted. In such cases, the CU-CP 172A does not include an SDT DU configuration in the RRC release message. Alternatively, the CU-CP 172A generates the SDT DU configuration by itself and includes the SDT DU configuration in the RRC release message.

In some implementations, the DU 174 does not include an SDT DU configuration in the second DU-to-CU message (e.g., if or because the UE 102 does not support CG-SDT, the DU 174 does not support CG-SDT, or the DU 174 does not have available radio resources for CG-SDT). In such cases, the RRC release message does not include an SDT DU configuration. Otherwise, depending on the implementation, the DU 174 includes an SDT DU configuration as described above. In some implementations, the DU 174 does not include a CG-SDT configuration in the SDT DU configuration in the second DU-to-CU message (e.g., if or because the UE 102 does not support CG-SDT, the DU 174 does not support CG-SDT, or the DU 174 does not have available radio resources for CG-SDT). In such cases, the SDT DU configuration does not include a CG-SDT configuration. Otherwise, depending on the implementation, the DU 174 includes the CG-SDT configuration in the SDT DU configuration as described above.

In some implementations, the CU-CP 172A requests the DU 174 to provide an SDT DU configuration as described above, such as in cases where the UE 102 supports CG-SDT and/or the DU 174 supports CG-SDT. In cases where the UE 102 does not support CG-SDT or the DU 174 does not support CG-SDT, the CU-CP 172A does not request the DU 174 to provide an SDT DU configuration. In some implementations, the CU-CP 172A receives a UE capability (e.g., UE-NR-Capability IE) of the UE 102 from the UE 102, the CN 110 (e.g., MME 114 or AMF 164) or the base station 106, before the UE 102 initiates the SDT, while the UE operates 402 in the inactive state, while the UE performs the SDT (e.g., in the UE Context Setup Request message of the event 408 or the CU-to-DU message of the event 428), or while the UE operates in the connected state as described for FIG. 3. The UE capability indicates whether the UE 102 supports CG-SDT. Thus, the CU-CP 172A can determine whether the UE supports CG-SDT in accordance with the UE capability. In some implementations, the CU-CP 172A receives from the DU 174 a DU-to-CU message indicating whether the DU 174 supports CG-SDT. The DU-to-CU message can be the second DU-to-CU message, the message of the event 308 or 316, or a non-UE associated message (e.g., a non-UE associated F1AP message defined in 3GPP specification 38.473).

In some implementations, the DU 174 determines whether to provide an SDT DU configuration for the UE 102 to the CU-CP 172A, depending on whether the UE 102 supports CG-SDT or not. In addition to whether the UE 102 supports CG-SDT or not, the DU 174 may additionally determine whether to provide an SDT DU configuration for the UE 102 to the CU-CP 172A, depending on whether the DU 174 supports CG-SDT or not. In cases where the UE 102 supports CG-SDT and/or the DU 174 supports or enables CG-SDT, the DU 174 provides an SDT DU configuration for the UE 102 to the CU-CP 172A as described above. In cases where the UE 102 does not support CG-SDT or the DU 174 does not support CG-SDT, the DU 174 does not provide an SDT DU configuration for the UE 102 (e.g., the DU 174 does not include the SDT DU configuration in the second DU-to-CU message). In some implementations, the DU 174 receives the UE capability from the CU-CP 172A (e.g., while the UE 102 operates in the connected state or in the inactive state). Thus, the DU 174 can determine whether the UE supports CG-SDT in accordance with the UE capability. In some implementations, the DU 174 sends a DU-to-CU message to the CU-CP 172A to indicate whether the DU 174 does support CG-SDT or not, as described above.

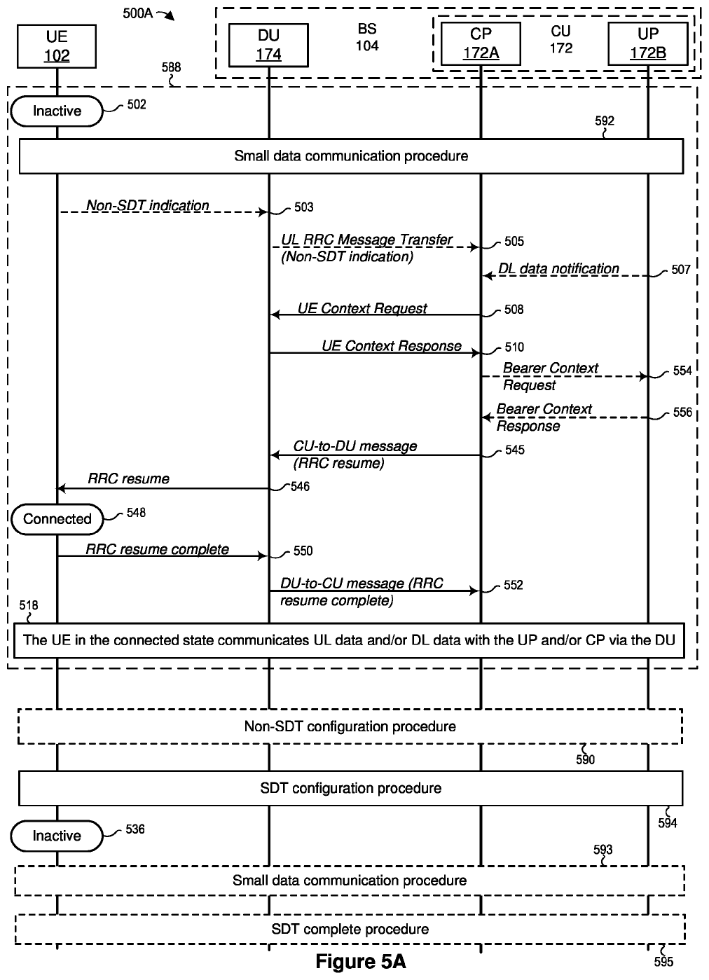

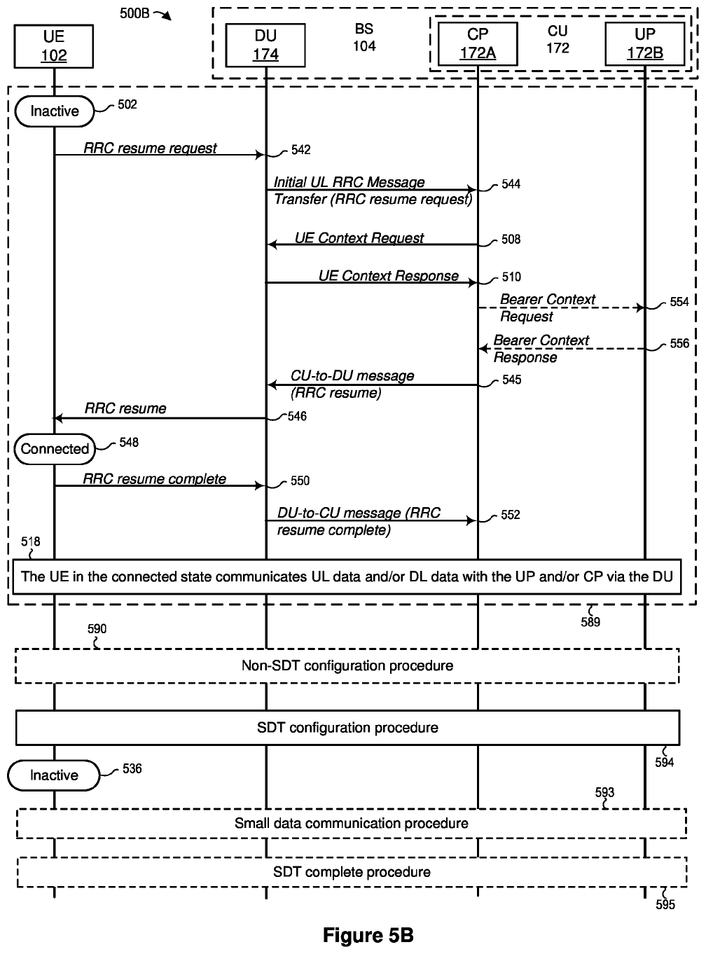

Referring now to FIG. 5A, a scenario 500A depicts small data transmission and transitioning from the inactive state with SDT to the connected state with non-SDT. In the scenario 500A, the base station 104 includes a CU 172 and a DU 174. The CU 172 includes a CU-CP 172A and a CU-UP 172B. In the scenario 500A, the UE 102 initially operates 502 in an inactive state with SDT configured, similar to the event 402. The UE 102 then performs 592 a small data communication procedure with the base station 104, similar to the event 492.

In some implementations, during the small data communication procedure 592, the CU-CP 172A determines whether to cause the UE 102 to transition to a connected state (e.g., based on UL or DL data activity of the UE 102). In some implementations, the UE 102 transmits 503 to the DU 174 a non-SDT indication message to indicate that UL data is available or request to transition to the connected state. In some implementations, the UE 102 transmits 503 to the DU 174 the non-SDT indication message on radio resources configured in a CG configuration for SDT (or CG-SDT configuration). In other implementations, the UE 102 receives an uplink grant on a PDCCH from the DU 174 using a C-RNTI and transmit 503 to the DU 174 the non-SDT indication message on radio resources configured in the uplink grant. In turn, the DU 174 transmits 505 a UL RRC Message Transfer message including the non-SDT indication message to the CU-CP 172A. The CU-CP 172A determines to cause the UE 102 to transition the connected state in response to or based on the non-SDT indication message. In other implementations, the CU-UP 172B receives DL data from the CN 110 and transmits 507 a DL data notification (e.g., DL Data Notification message) to the CU-CP 172A to indicate that DL data is available for transmission in response to receiving the DL data. In some implementations, the CU-CP 172A determines to cause the UE 102 to transition to the connected state in response to or based on the DL data notification. In other implementations, the CU-CP 172A determines to cause the UE 102 to transition to the connected state based on measurement results received from the UE 102. In yet other implementations, the CU-CP 172A receives DL data (e.g., NAS message(s)) from the CN 110 and determines to cause the UE 102 to transition to the connected state in response to receiving the DL data.

In some implementations, the UL data and DL data are associated with radio bearer(s) (e.g., SRB(s) and/or DRB(s)) of the UE 102. For example, the UL data includes RRC message(s) or NAS message(s) associated with SRB(s) of the UE 102. In another example, the UL data includes IP packet(s) associated with DRB(s) of the UE 102. In some implementations, the DRB(s) are SDT DRB(s). In other implementations, the DRB(s) are non-SDT DRB(s). In some implementations, the UE 102 includes ID(s) of the radio bearer(s) in the non-SDT indication message. Thus, the CU-CP 172A determines whether to cause the UE 102 to transition to the connected state based on the ID(s). For example, if the radio bearer(s) identified by the ID(s) do not qualify for SDT, the CU-CP 172A can determine to cause the UE 102 to transition to the connected state. Otherwise, the CU-CP 172A can determine not to cause the UE 102 to transition to the connected state. In some implementations, the UE 102 includes data volume information of the UL data in the non-SDT indication message. Thus, the CU-CP 172A determines whether to cause the UE 102 to transition to the connected state based on the data volume information. In some implementations, the data volume information includes a total data volume of the UL data, which can be quantized or rounded to a value that can be indicated in the data volume information. In further implementations, the data volume information includes a data volume for each of the radio bearer(s), which can be quantized or rounded to a value that can be indicated in the data volume information. For example, if the total data volume is above a predetermined threshold, the CU-CP 172A can determine to cause the UE 102 to transition to the connected state. Otherwise, the CU-CP 172A can determine not to cause the UE 102 to transition to the connected state. In another example, if the data volume for a particular radio bearer is above a predetermined threshold, the CU-CP 172A determines to cause the UE 102 to transition to the connected state. Otherwise, the CU-CP 172A determines not to cause the UE 102 to transition to the connected state. In yet another example, if the total data volume is above a predetermined threshold and the data volume for a particular radio bearer is above another predetermined threshold, the CU-CP 172A determines to cause the UE 102 to transition to the connected state. Otherwise, the CU-CP 172A determines not to cause the UE 102 to transition to the connected state.

In response to or after determining to cause the UE 102 to transition to the connected state, the CU-CP 172A transmits 508 a UE Context Request message (e.g., a UE Context Setup Request message or a UE Context Modification Request message) to the DU 174. In response, the DU 174 transmits 510 a UE Context Response message (e.g., a UE Context Setup Response message or a UE Context Modification Response message) to the CU-CP 172A. In some implementations, the DU 174 includes a non-SDT DU configuration (i.e., a first non-SDT DU configuration) in the UE Context Response message. After receiving 510 the UE Context Response message, the CU-CP 172A transmits 545 a CU-to-DU message including an RRC resume message (e.g., an RRCResume message or an RRCConnectionResume message) to the DU 174. In turn, the DU 174 transmits 546 the RRC resume message to the UE 102. In some implementations, the DU 174 transmits 546 one or more PDUs including the RRC resume message to the UE 102. Depending on the implementation, the PDU(s) are MAC PDU(s) or RLC PDU(s). In some implementations, the CU-to-DU message is a DL RRC Message Transfer message or a UE Context Modification Request message. In some cases regarding the UE Context Modification Request message, the DU 174 transmits a UE Context Modification Response message to the CU-CP 172A in response. In response to the RRC resume message, the UE 102 transitions 548 to the connected state and transmits 550 an RRC resume complete message (e.g., an RRCResumeComplete message or an RRCConnectionResumeComplete message) to the DU 174. In cases where the UE Context Response message includes the non-SDT DU configuration, the CU-CP 172A includes the non-SDT DU configuration in the RRC resume message. The DU 174 transmits 552 a DU-to-CU message including the RRC resume complete message to the CU-CP 172A. In some implementations, the DU-to-CU message is a UL RRC Message Transfer message, a UE Context Modification Required message, or a UE Context Modification Response message.

In some implementations, after determining to cause the UE 102 to transition to the connected state, the CU-CP 172A transmits a 554 Bearer Context Request message (e.g., a Bearer Context Setup Request message or a Bearer Context Modification Request message) to the CU-UP 172B to indicate the CU-UP 172B to resume radio bearer(s) (e.g., SDT DRB(s) and/or non-SDT DRB(s)) of the UE 102, if suspended. In response, the CU-UP 172B resumes the radio bearer(s) for the UE 102 and transmits 556 a Bearer Context Response message (e.g., a Bearer Context Setup Response message or a Bearer Context Modification Response message) to the CU CP-172A. The events 554 and 556 can be grouped as a Bearer Context procedure (e.g., a Bearer Context Setup procedure or a Bearer Context Modification procedure).

In some implementations, the CU-CP 172A transmits 554 the Bearer Context Request message after transmitting 508 the UE Context Request message, receiving 510 the UE Context Response message, transmitting 545 the CU-to-DU message, or receiving 552 the DU-to-CU message. In cases where the CU-CP 172A determines no radio bearer(s) of the UE 102 are suspended when determining to cause the UE 102 to transition to the connected state, the CU-CP 172A does not transmit the Bearer Context Request message 554 to the CU-UP 172B. In some implementations, the CU-CP 172A transmits 545 the CU-to-DU message before or after transmitting 554 the Bearer Context Request message or receiving 556 the Bearer Context Response message.

In some implementations, the CU-CP 172A includes an indication indicating the DU 174 to generate a non-SDT configuration in the UE Context Request message, and the DU 174 includes the first non-SDT DU configuration in the UE Context Response message in response to the indication. In yet other implementations, the CU-CP 172A stores a non-SDT DU configuration (i.e., a second non-SDT DU configuration) that a DU (e.g., the DU 174 or another DU or base station) used to communicate with the UE 102. Depending on the implementation, the UE 102 also stores the second non-SDT DU configuration. In some such cases, the CU-CP 172A includes the second non-SDT DU configuration in the UE Context Request message, and the DU 174 includes the first non-SDT DU configuration in the UE Context Response message in response to receiving the second non-SDT DU configuration. In some implementations, the first non-SDT DU configuration augments or replaces the second non-SDT DU configuration. Examples and implementations for the first and second non-SDT DU configurations are as the non-SDT DU configurations described above. In some implementations, the DU 174 transmits an additional DU-to-CU message (e.g., a UE Context Modification Required message) including the first non-SDT DU configuration to the CU-CP 172A instead of including the first non-SDT DU configuration in the UE Context Response message.

After transitioning to the connected state, the UE 102 communicates 518 UL data and/or DL data with the CU-CP 172A and/or CU-UP 172B via the DU 174. In some implementations, the UL data includes the UL data triggering the UE to transmit the non-SDT indication message. In further implementations, the UL data also includes new UL data available for transmission. In some implementations, the UL data includes PDCP PDU(s), RRC PDU(s), NAS PDU(s), or an LTE positioning protocol (LPP) PDU(s). Depending on the implementation, the UL data is associated with an SRB (e.g., SRB1 or SRB2). In some implementations, the UE 102 applies one or more security functions (e.g., encryption and/or integrity protection) to the UL data as described above. The CU-CP 172A applies one or more security functions (e.g., decryption and/or integrity protection check) to the UL data as described above. Depending on the implementation, the UL data includes PDCP PDU(s), SDAP PDU(s), IP packet(s), or Ethernet packet(s). In some implementations, the UL data is associated with DRB(s) (e.g., SDT DRB(s) and/or non-SDT DRB(s)). In some implementations, the UE 102 applies one or more security functions (e.g., encryption and/or integrity protection) to the UL data as described above. The CU-UP 172B applies one or more security functions (e.g., decryption and/or integrity protection check) to the UL data as described above.

In some implementations, the DL data includes the DL data received from the CN 110 as described above. In further implementations, the DL data includes new DL data that the CU-CP 172A and/or CU-UP 172B receive from the CN 110. Depending on the implementation, the DL data includes DL data packet(s) such as NAS PDU(s), IP packet(s), or Ethernet packet(s). In the case of the NAS PDU(s), the CU-CP 172A receives the NAS PDU(s) from the CN 110 (e.g., AMF 164) and generates RRC PDU(s) each including a particular NAS PDU of the NAS PDU(s). In some implementations, the CU-CP 172A applies one or more security functions (e.g., encryption and/or integrity protection) to the RRC PDU(s) as described above. The UE 102 applies one or more security functions (e.g., decryption and/or integrity protection check) to the RRC PDU(s) as described above. In the case of the NAS PDU(s), the CU-CP 172A receives the NAS PDU(s) from the CN 110 (e.g., AMF 164) and generates RRC PDU(s) each including a particular NAS PDU of the NAS PDU(s). In some implementations, the CU-CP 172A applies one or more security functions (e.g., encryption and/or integrity protection) to the RRC PDU(s) as described above. The UE 102 applies one or more security functions (e.g., decryption and/or integrity protection check) to the RRC PDU(s) as described above. In the case of the IP packet(s) or Ethernet packet(s), the CU-UP 172B receives the DL data packet(s) from the CN 110 (e.g., UPF 162) or an edge server and generates PDCP PDU(s) each including a particular DL data packet of the DL data packet(s). In some implementations, the CU-UP 172B applies one or more security functions (e.g., encryption and/or integrity protection) to the DL data packet(s) as described above. The UE 102 applies one or more security functions (e.g., decryption and/or integrity protection check) to the DL data packet(s) as described above.

In cases where the RRC resume message includes the first non-SDT DU configuration, the UE 102 communicates 518 with the DU 174 using the first non-SDT DU configuration. In some cases where the second non-SDT DU configuration is not completely replaced by the first non-SDT DU configuration (i.e., the UE 102 does not release the second non-SDT DU configuration in response to the RRC resume message), the UE 102 communicates 518 with the DU 174 using the configuration parameters in the second non-SDT DU configuration, which are not augmented by the first non-SDT DU configuration.

In some implementations, the DU 174 does not provide the first non-SDT DU configuration to the CU-CP 172A in the UE Context Response message and the additional DU-to-CU message. In such cases, the RRC resume message does not include the first non-SDT configuration, and the UE 102 and the DU 174 communicate 518 with one another using the second non-SDT DU configuration.

In some implementations, the UE 102 releases the SDT configuration(s) (e.g., the SDT CU configuration, the SDT DU configuration and/or the CG-SDT configuration(s) in response to the RRC resume message or transitioning to the connected state. In some implementations, the base station 104 (e.g., the CU-CP 172A and/or DU 174) releases the SDT configuration(s) in response to or after causing the UE 102 to transition to the connected state, receiving 510 the CU-to-DU message, or transmitting 545, 546 the RRC resume message. In other implementations, the base station 104 releases the SDT configuration(s) in response to or after receiving an acknowledgement (e.g., a RLC acknowledgement or a HARQ acknowledgement) for the PDU(s) including the RRC resume message. In yet other implementations, the base station 104 (e.g., the CU-CP 172A and/or DU 174) releases the SDT configuration(s) in response to or after communicating 508 the UE Context Request message or 510 the UE Context Response message.

In other implementations, the UE 102 retains the SDT configuration(s) (e.g., the SDT CU configuration, the SDT DU configuration and/or the CG-SDT configuration(s)) in response to or after receiving the RRC resume message or transitioning to the connected state. In some implementations, the UE 102 refrains from using the SDT configuration(s) to communicate (e.g., 550 the RRC resume complete message and/or 518 data) with the base station 104, while operating in the connected state. In other implementations, the UE 102 uses the SDT configuration(s) to communicate (e.g., 550 the RRC resume complete message and/or 518 data) with the base station 104, while operating in the connected state. In some implementations, the base station 104 retains the SDT configuration(s) in response to or after causing the UE 102 to transition to the connected state or transmitting the RRC resume message. In some implementations, the base station 104 refrains from using the SDT configuration(s) to communicate (e.g., 550 the RRC resume complete message and/or 518 data) with the UE 102 operating in the connected state. In other implementations, the base station 104 uses the SDT configuration(s) to communicate (e.g., 550 the RRC resume complete message and/or 518 data) with the UE 102 operating in the connected state.

In some implementations, the UE 102 discards a UE Inactive AS Context in response to or after causing the UE 102 to transition to the connected state or transmitting the RRC resume message. In some implementations, the UE 102 releases one or more configuration parameters in a suspend configuration (e.g., suspendConfig) except RAN notification area information (e.g., ran-NotificationAreaInfo). Depending on the implementation, the UE 102 receives the suspend configuration in an RRC release message from the base station 104, similar to event 334 or 434, before performing 592 the procedure.

In some implementations, the non-SDT indication message is or includes an RRC message (e.g., a UEAssistanceInformation message or a new RRC message). In some such implementations, the UE 102 continues to perform small data communication with the base station 104 after transmitting the non-SDT indication message. In some implementations, the UE 102 transmits a UL MAC PDU including the non-SDT indication message to the CU-CP 172A via the DU 174. In some implementations, the UE 102 includes data in the UL MAC PDU in addition to the non-SDT indication message. In other implementations, the UE refrains from including data in the UL MAC PDU. In some implementations, the UE 102 transmits the non-SDT indication message to the CU-CP 172A via the DU 174 and SRB1. In such implementations, the UE 102 refrains from re-establishing a UE PDCP entity for the SRB1 in response to determining to transmit the non-SDT indication message. The UE 102 generates a UL PDCP PDU including the non-SDT indication message using the UE PDCP entity and transmits 503, 505 the UL PDCP PDU to the CU-CP 172A via the DU 174. Then, the UE 102 uses the UE PDCP entity to receive 546 a DL PDCP PDU including the RRC resume message without re-establishing the UE PDCP entity. The CU-CP 172A uses a CU-CP PDCP entity to receive the 505 the UL PDCP PDU. The CU-CP 172A refrains from re-establishing the CU-CP PDCP entity for the SRB1 in response to the receiving the non-SDT indication message. The CU-CP 172A generates the DL PDCP PDU using the CU-CP PDCP entity and transmits 545, 546 the DL PDCP PDU to the UE 102 via the DU 174 and SRB1. The UE 102 generates a UL PDCP PDU including the RRC resume complete message using the UE PDCP entity and transmits 550, 552 the UL PDCP PDU to the CU-CP 172A via the DU 174 and SRB1. The CU-CP 172A receives 550, 552 the UL PDCP PDU from the UE 102 via the DU 174, using the CU-CP PDCP entity. In these implementations, the UE 102 and the CU-CP 172A communicates the PDCP PDUs via the SRB1 without re-establishing the UE PDCP entity and CU-CP PDCP entity.

In other implementations, the non-SDT indication message is an RRC resume request message (e.g., RRCResumeRequest message or RRCResumeConnectionRequest message). In some such implementations, the UE 102 stops 592 small data communication with the base station 104 to transmit the non-SDT indication message. In some implementations, the UE 102 transmits the non-SDT indication message to the CU-CP 172A via the DU 174 and SRB0. In some implementations, the UE 102 re-establishes the UE PDCP entity in response to determining to transmit the non-SDT indication. After re-establishing the UE PDCP entity, the UE 102 receives 546 the DL PDCP PDU using the UE PDCP entity from the DU 174. Similarly, the CU-CP 172A re-establishes the CU-CP PDCP entity upon receiving the non-SDT indication message. After re-establishing the CU-CP PDCP entity, the CU-CP 172A generates the DL PDCP PDU using the CU-CP PDCP entity and transmits 545, 546 the DL PDCP PDU to the UE 102 via the DU 174 and SRB1. After re-establishing the UE PDCP entity, the UE 102 generates a UL PDCP PDU including the RRC resume complete message using the UE PDCP entity and transmits 550, 552 the UL PDCP PDU to the CU-CP 172A via the DU 174 and SRB1. After re-establishing the CU-CP PDCP entity, the CU-CP 172A receives 550, 552 the UL PDCP PDU from the UE 102 via the DU 174, using the CU-CP PDCP entity.

Before performing 592 the small data communication procedure, the UE 102 operating 502 in the inactive state starts or restarts a first UE CG-SDT timer (e.g., CG-SDT-TAT), as described for FIGS. 3 and 4. In some implementations, the UE 102 starts or restarts the first UE CG-SDT timer in response to receiving a timing advance command from the DU 174 during 592 the small data communication procedure. In some implementations, the UE 102 maintains (e.g., keeps or does not stop, start or restart) the first UE CG-SDT timer (e.g., CG-SDT-TAT) running in response to or after receiving the RRC resume message. In other implementations, the UE 102 stops the first UE CG-SDT timer in response to or after receiving the RRC resume message.

Similarly, depending on the implementation, the DU 174 runs a first DU CG-SDT timer for the UE 102 operating 502 in the inactive state, as described for FIGS. 3 and 4. In some implementations, the DU 174 starts or restarts the first DU CG-SDT timer in response to transmitting a timing advance command to the UE 102. In some implementations, the DU 174 maintains (e.g., keeps or does not stop, start or restart) the first DU CG-SDT timer running in response to or after receiving 508 the UE Context Request message, transmitting 510 the UE Context Response message, or transmitting 512 the resume message. In other implementations, the DU 174 stops the first DU CG-SDT timer in response to or after receiving 508 the UE Context Request message, transmitting 510 the UE Context Response message or transmitting 545 the RRC resume message. In some cases where the first DU CG-SDT timer expires, the DU 174 releases the CG-SDT configuration(s). In some cases where the first DU CG-SDT timer expires, the DU 174 alternatively retains the CG-SDT configuration(s) and refrains from receiving or attempting to receive UL transmissions (e.g., MAC PDUs) on the CG resources. In some such cases, the DU 174 releases the CG resources or determines the CG resources not valid.

In some implementations, the UE 102 in the inactive state runs a second UE CG-SDT timer during 592 the small data communication procedure, as described for the procedure 492. In cases where the second UE CG-SDT timer is running, the UE 102 stops the second UE CG-SDT timer in response to or after receiving 546 the RRC resume message or transitioning 548 to the connected state, in some implementations. Alternatively, the UE 102 maintains the second UE CG-SDT timer running in response to or after receiving 546 the RRC resume message or transitioning 548 to the connected state. In some implementations, the UE 102 receives an RRC setup message (e.g., RRCSetup message) instead of the RRC resume message. In response to or after receiving the RRC setup message, the UE 102 stops the second UE CG-SDT timer and transmits an RRC setup complete message to the CU-CP 172A via the DU 174.

Similarly, in some implementations, the DU 174 runs a second DU CG-SDT timer during 592 the small data communication procedure. In some implementations, the DU 174 starts or restarts the second DU CG-SDT timer when or after receiving from the UE 102 a PUSCH transmission on radio resources configured in the CG-SDT configuration. While the second DU CG-SDT timer is running, the DU 174 transmits a PDCCH using the C-RNTI. In cases where the second DU CG-SDT timer is running, the DU 174 stops the second DU CG-SDT timer in response to or after receiving 508 the UE Context Request message, transmitting 510 the UE Context Response message, or transmitting 546 the RRC resume message, in some implementations. In other implementations, the DU 174 maintains the second DU CG-SDT timer in response to or after receiving 508 the UE Context Request message, transmitting 510 the UE Context Response message or transmitting 546 the RRC resume message. The DU 174 transmits, to the UE 102 operating in the connected state, a DCI on a PDCCH using the C-RNTI irrespective of the second DU CG-SDT timer (e.g., running, expiring or stopping).

The events 502, 592, 503, 505, 507, 508, 510, 545, 546, 548, 550, 552, 554, 556 and 518 are collectively referred to in FIG. 5A as a state transition procedure 588.

Later in time, the base station 104 performs 590 a non-SDT configuration procedure and 594 an SDT configuration procedure with the UE 102, similar to the procedure 390 and the procedure 394, respectively. The UE 102 transitions 536 to the inactive state in response to receiving an RRC release message in the procedure 594. In some implementations, after transitioning to the inactive state, the UE 102 in the inactive state performs 593 a small data communication procedure and 595 an SDT complete procedure with the base station 104, similar to the procedure 492 and 494, respectively.

Referring next to FIG. 5B, a scenario 500B is generally similar to the scenario 500A, except that the UE 102 initiates an RRC resume procedure instead of 592 the small data communication procedure. The differences between the scenarios 500B and 500A are discussed below.

In response to initiating the RRC resume procedure, the UE 102 in the inactive state transmits 542 an RRC resume request message to the DU 174, which in turn transmits 544 an Initial UL RRC Message Transfer message including the RRC resume request message (e.g., an RRCResumeRequest message or an RRCConnectionResumeRequest message) to the CU-CP 172A. In response to receiving the RRC resume request message, the CU-CP 172A determines to cause the UE 102 to transition to the connected state. In response to or after determining to cause the UE 102 to transition to the connected state, the CU-CP 172A transitions the UE to the connected state as described for the scenario 500A.

In some implementations, the UE 102 generates a UL MAC PDU including the RRC resume request message and transmits 542 UL MAC PDU to the DU 174. In some implementations, the UE 102 transmits 542 to the DU 174 the UL MAC PDU on radio resources configured in a CG configuration for SDT. In other implementations, the UE 102 performs a random access procedure to transmit the UL MAC PDU, similar to the event 404.

In some implementations, the UE 102 initiates the RRC resume procedure to transmit non-SDT data (i.e., data not qualifying for SDT). More specifically, an upper protocol layer (e.g., NAS layer) of the UE 102 requests an RRC layer (e.g., RRC 214) of the UE 102 to initiate the RRC resume procedure. In other implementations, the UE 102 receives a paging message from the DU 174 and initiates the RRC resume procedure to respond the paging message. In some implementations, the RRC layer (e.g., RRC 214) initiates the RRC resume procedure in response to the paging message. In yet other implementations, the UE 102 detects a periodic RAN notification area update (RNAU) timer expires and initiates the RRC resume procedure in response to the periodic RNAU timer expiring. In some implementations, the RRC layer (e.g., RRC 214) starts or restarts the RNAU timer, maintains the RNAU timer running, and initiates the RRC resume procedure in response to the RNAU timer expiring.

The events 502, 508, 510, 518, 542, 544, 545, 546, 548, 550, 552, 554, and 556 are collectively referred to in FIG. 5B as a state transition procedure 589.

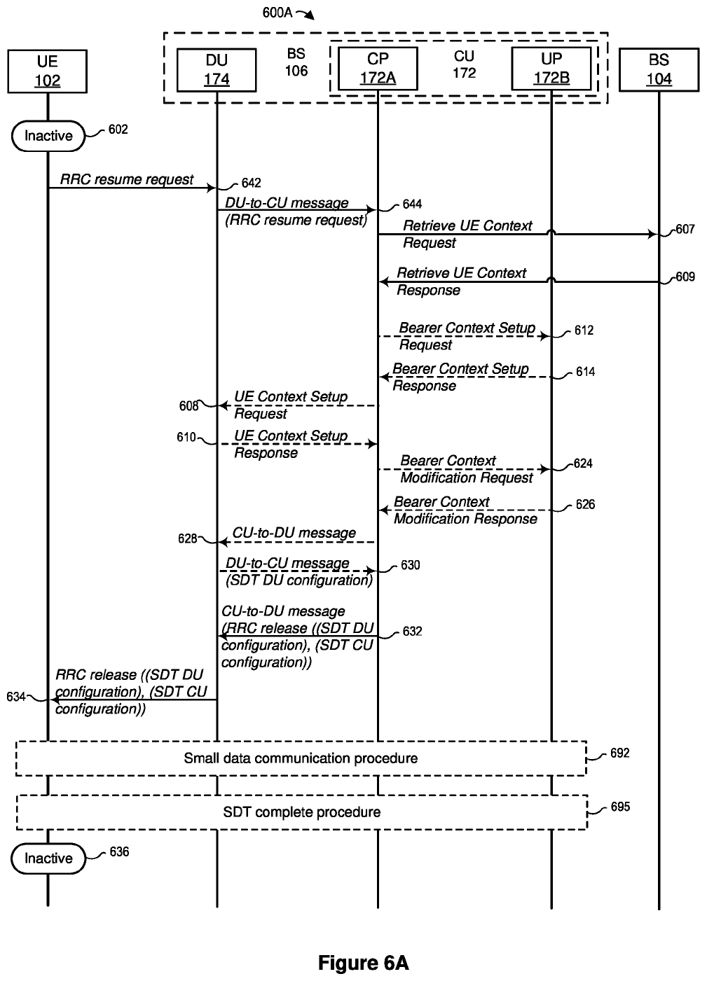

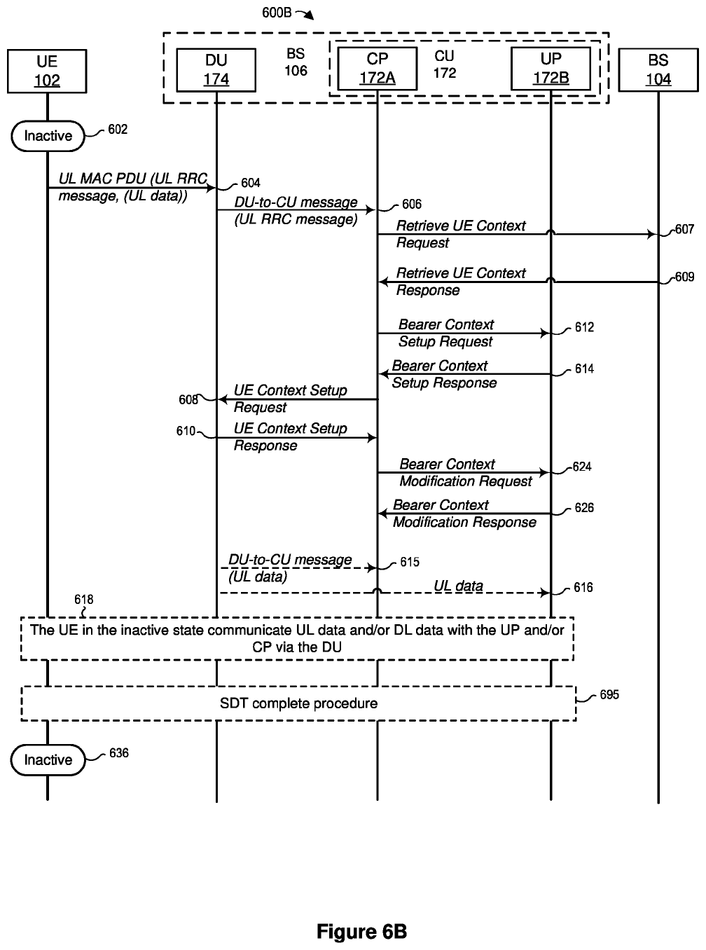

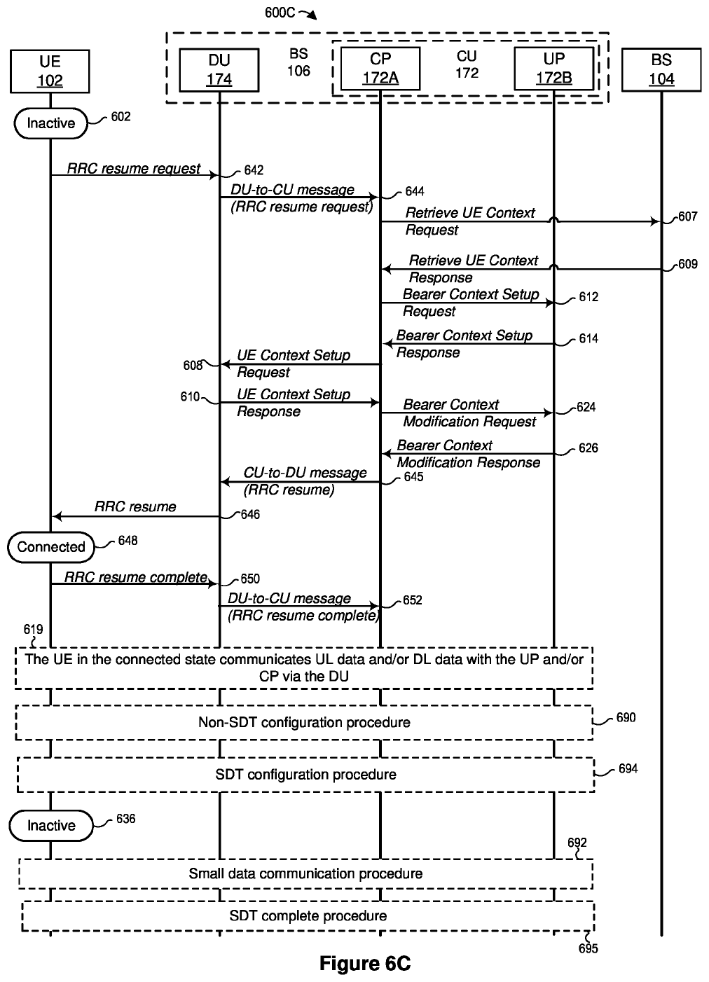

Referring next to FIG. 6A, a scenario 600A depicts an RRC resume request and a response with an RRC release message. In the example scenario 600A, the base station 106 includes a CU 172 and a DU 174. The CU 172 includes a CU-CP 172A and a CU-UP 172B. The UE 102 initially operates 602 in an inactive state. In some implementations, the UE 102 operates in the connected state with the base station 104 before operating 602 in the inactive state and, later in time, transitions to the inactive state 602, as described for FIG. 3. In other implementations, the UE 102 operates in the inactive state, performs small data transmission with the base station 104, stops the small data transmission with the base station 104, and stays in the inactive state 602, as described for FIG. 4. In some such implementations, the UE 102 is configured with SDT configuration parameters (e.g., SDT CU configuration and/or SDT DU configuration) by the base station 104, as described for FIG. 3 or FIG. 4. “SDT configuration” is used to represent the SDT configuration parameters to simplify the following description. In some implementations, the SDU configuration includes CG-SDT configuration(s). In some such cases, the UE 102 discards the CG-SDT configuration(s) because the base station 106 docs not configure the CG-SDT configuration(s) for the UE 102 (i.e., the CG-SDT configuration(s) is not valid).

Later in time, the UE 102 in the inactive state initiates an RRC resume procedure with the base station 106. In some implementations, the UE 102 initiates the RRC resume procedure for an RNA update because the base station 106 belongs to another RNA different from an RNA of a cell where the UE 102 receives an RRC release message configuring the UE 102 to transition to the inactive state 602. In other implementations, the UE 102 performs the RRC resume procedure for a periodic RNA update. In response to the initiation, the UE 102 in the inactive state transmits 642 an RRC resume request message to the DU 174, which in turn transmits 644 an Initial UL RRC Message Transfer message including the RRC resume request message (e.g., an RRCResumeRequest message or an RRCConnectionResumeRequest message) to the CU-CP 172A. In some implementations, the RRC resume request message includes a UE ID of the UE 102. For example, the UE ID can be an I-RNTI (e.g., a fullI-RNTI or shortI-RNTI value or field). In some implementations, the RRC resume request message includes an RRC MAC-I. In further implementations, the RRC MAC-I is a resumeMAC-I field and the UE 102 obtains the resumeMAC-I (e.g., as specified in 3GPP specification 38.331). In other implementations, the UE 102 obtains the RRC MAC-I (e.g., a resumeMAC-I field) from the RRC resume request with an integrity key (e.g., K_{RRCint} key), an integrity protection algorithm, and other parameters COUNT (e.g., 32-bit, 64-bit or 128-bit value), BEARER (e.g., 5-bit value), and DIRECTION (e.g., 1-bit value). In some implementations, the UE 102 sets bits for COUNT, BEARER, and DIRECTION set to binary ones to generate the RRC MAC-I.

After receiving the RRC resume request message, the CU-CP 172A transmits 607 a Retrieve UE Context Request message to a base station 104 to retrieve a UE context of the UE 102. In response, the base station 104 transmits 609 a Retrieve UE Context Response message including UE context information of the UE 102 to the CU-CP 172A. In some implementations, the CU-CP 172A includes the RRC MAC-I in the Retrieve UE Context Request message. In some implementations, the CU-CP 172A determines a first IP address of the base station 104, a CU-CP of the base station 104, or a CU of the base station 104 in accordance with the UE ID. The CU-CP 172A generates a first IP packet, including a source address (i.e., an IP address of the CU-CP 172A), a destination address (i.e., the first IP address), and the Retrieve UE Context Request message. The CU-CP 172A transmits the first IP packet to the base station 104. The base station 104 generates a second IP packet including a source address (i.e., the first IP address or another IP address of the base station 104), a destination address (i.e., the IP address of the CU-CP 172A), and the Retrieve UE Context Response message. The base station transmits the second IP packet to the CU-CP 172A.

In some implementations, the UE context information includes security capabilities, security information, a maximum bit rate, a PDU session resources to be setup list, an RRC context, a UE radio capability ID, and/or the SDT configuration. In some implementations, the RRC context includes configuration parameters that the base station 104 configures for the UE 102 operating in the connected state to communicate with the base station 104. For example, the configuration parameters include a cell group configuration (e.g., CellGroupConfig IE), a radio bearer configuration (e.g., RadioBearerConfig IE), and/or measurement configuration(s) (e.g., MeasConfig IE(s)). In some implementations, the base station 104 includes the SDT configuration in the RRC context. In other implementations, the base station 104 refrains from including the SDT configuration in the RRC context or in the Retrieve UE Context Response message.

In some cases where the SDT configuration includes CG-SDT configuration(s), the base station 104 excludes the CG-SDT configuration(s) from the SDT configuration. Alternatively, the base station 104 still includes the CG-SDT configuration(s) from the SDT configuration. In some implementations, when the CU-CP 172A receives the CG-SDT configuration(s), the CU-CP 172A discards the CG-SDT configuration(s). In some implementations, the CU-CP 172A discards the SDT configuration, (e.g., in cases where the CU-CP 172A does not support delta configuration). In other implementations, the base station 104 refrains from including the SDT configuration in the Retrieve UE Context Response message.

In some implementations, after receiving 609 the Retrieve UE Context Response message, the CU-CP 172A transmits 612 a Bearer Context Setup Request message to the CU-UP 172B to request the CU-UP 172B to establish bearer context(s) for SDT DRB(s) configured in the SDT configuration for the UE 102. In response, the CU-UP 172B establishes (i.e., sets up) bearer context(s) for the SDT DRB(s) and transmits 614 a Bearer Context Setup Response message to the CU-CP 172A to confirm that that bearer context(s) for the SDT DRB(s) are established. In some implementations, if non-SDT DRB(s) of the UE 102 exist, the CU-CP 172A requests the CU-UP 172B to establish bearer context(s) for the non-SDT DRB(s) in the Bearer Context Setup Request message. In such a case, the CU-UP 172B establishes bearer context(s) for the non-SDT DRB(s) in response to the Bearer Context Setup Request message 612. In some implementations, the CU-UP 172B includes transport layer information of the CU-UP 172B in the Bearer Context Setup Response message. The transport layer information of the CU-UP 172B configures and/or includes IP address(es) and/or uplink TEID(s) associated with the SDT DRB(s) and/or non-SDT DRB(s). In some implementations, each of the SDT DRB(s) and non-SDT DRB(s) is associated with a particular IP address and/or a particular uplink TEID, which can identify a GTP tunnel. The Bearer Context Setup Request message and Bearer Context Setup Response message can be grouped as a Bearer Context Setup procedure.

In further implementations, after receiving 609 the Retrieve UE Context Response message or receiving 614 the Bearer Context Setup Response message, the CU-CP 172A transmits 608 a UE Context Setup Request message to the DU 174 to request the DU 174 to establish a UE context for the UE 102. In response, the DU 174 establishes a UE context for the UE 102 and transmits 610 a UE Context Setup Response message to the CU-CP 172A. In some implementations, the CU-CP 172A includes the transport layer information of the CU-UP 172B in the UE Context Setup Request message. In some implementations, the DU 174 includes transport layer information of the DU 174 in the UE Context Setup Response message. The UE Context Setup Request message and UE Context Setup Response message can be grouped as a UE Context Setup procedure. The transport layer information of the DU 174 configures and/or includes IP address(es) and/or downlink TEID(s) associated with the SDT DRB(s) and/or non-SDT DRB(s). In some implementations, each of the SDT DRB(s) and non-SDT DRB(s) is associated with a particular IP address and/or a particular downlink TEID, which can identify a GTP tunnel.

After receiving 614 Bearer Context Setup Response message or receiving 610 the UE Context Setup Response message, the CU-CP 172A transmits 624 a Bearer Context Modification Request message to the CU-UP 172B. In response, the CU-UP 172B transmits 626 a Bearer Context Modification Response message to the CU-CP 172A. In some implementations, the CU-CP 172A includes the transport layer information of the DU 174 in the Bearer Context Modification Request message. The Bearer Context Modification Request message and Bearer Context Modification Response message can be grouped as a Bearer Context Modification procedure.

In some implementations, the CU-CP 172A includes a suspend indication (e.g., Bearer Context Status Change IE with a “Suspend” value) in the Bearer Context Setup Request message to indicate to suspend the one or more bearer contexts. Alternatively, the CU-CP 172A includes the suspend indication in the Bearer Context Modification Request message instead of including the suspend indication in the Bearer Context Setup Request message. In response to the suspend indication, the CU-UP 172B suspends all of the DRB(s) (i.e., the SDT DRB(s) and/or the non-SDT DRB(s)) of the UE 102. In some implementations, when the CU-UP 172B suspends the DRB(s), the CU-UP 172B suspends the bearer contexts of the DRB(s) and/or data communication for the DRB(s).

In some implementations, after receiving 609 the Retrieve UE Context Response message, 610 the UE Context Setup Response message, 614 the Bearer Context Setup Response message or 626 the Bearer Context Modification Response message, the CU-CP 172A determines to obtain an SDT DU configuration from the DU 174. In response to the determination, the CU-CP 172A transmits 628 a CU-to-DU message to the DU 174 to obtain an SDT DU configuration, similar to the events 328, 428. In response, the DU 174 transmits 630 a DU-to-CU message including an SDT DU configuration to the CU-CP 172A, similar to the events 330, 430. After receiving 609 the Retrieve UE Context Response message, 610 the UE Context Setup Response message, 614 the Bearer Context Setup Response message, 626 the Bearer Context Modification Response message, or 630 the DU-to-CU message, the CU-CP 172A transmits 632, 634 an RRC release message to the UE 102 via the DU 174, similar to the events 332, 334, 432, and 434. The UE 102 determines that the RRC resume procedure successfully completes upon receiving 634 the RRC release message and stays in the inactive state.

In some implementations, after receiving 634 the RRC release message, the UE 102 performs 692 a small data communication procedure and perform 695 an SDT complete procedure with the base station 106, similar to the events 492 and 494 respectively. In some implementations, the events 608, 610, 612, 614, 624 and/or 626 are omitted. In some such implementations, the events occur during the small data communication procedure 692.

In some scenarios or implementations, the CU-UP 172B receives a DL data packet for the UE 102 from a CN 110 (e.g., UPF 162) or an edge server, and the DL data packet is associated with one of the SDT DRB(s). Because the CU-UP 172B suspends the SDT DRB, the CU-UP 172B suspends transmitting the DL data packet to the DU 174 and transmits to the CU-CP 172A a UP-to-CP message (e.g., DL Data Notification message) to notify the CU-CP 172A that the SDT DRB has data arrival. In some implementations, the CU-UP 172B includes, in the UP-to-CP message, a PDU session ID and/or a QoS flow ID with which the SDT DRB is associated. In further implementations, in response to or after receiving the UP-to-CP message, the CU-CP 172A transmits a CU-to-DU message (e.g., a F1AP Paging message) to the DU 174 to cause or command the DU 174 to transmit to a paging message (e.g., an RRC Paging message) to the UE 102. In response to the CU-to-DU message, the DU 174 transmits a paging message to the UE 102.

In some scenarios or implementations, the CU-UP 172B receives a DL data packet for the UE 102 from a CN 110 (e.g., UPF 162) or an edge server, and the DL data packet is associated with one of the non-SDT DRB(s). Because the CU-UP 172B suspends the non-SDT DRB, the CU-UP 172B suspends transmitting the DL data packet to the DU 174 and transmits to the CU-CP 172A a UP-to-CP message (e.g., DL Data Notification message) to notify the CU-CP 172A that the non-SDT DRB has data arrival. In some implementations, the CU-UP 172B includes, in the UP-to-CP message, a PDU session ID and/or a QoS flow ID with which the non-SDT DRB is associated. In further implementations, in response to or after receiving the UP-to-CP message, the CU-CP 172A transmits a CU-to-DU message (e.g., a F1AP Paging message) to the DU 174 to cause or command the DU 174 to transmit to a paging message (e.g., an RRC Paging message) to the UE 102. In response to the CU-to-DU message, the DU 174 transmits a paging message to the UE 102.

Referring next to FIG. 6B, a scenario 600B depicts small data transmission, similar to the scenarios 400 and 600A. Except events 607 and 609, events 602, 604, 606, 608, 610, 612, 614, 615, 616, 618, 695, 636 are similar to events 402, 404, 406, 408, 410, 412, 414, 415, 416, 418, 494, 436, respectively. Examples and implementations for FIG. 4 and FIG. 6A can apply to FIG. 6B. The differences among FIGS. 4 and 6A and FIG. 6B are described below.

In the scenario 600B, the UE 102 initially operates 602 in an inactive state and is configured with an SDT configuration. In some implementations, the UE 102 receives the SDT configuration as described for FIGS. 3, 4, 5A, and/or 5B. The UE 102 operating 602 in the inactive state initiates SDT. In response to the initiation, the UE 102 transmits 604 a UL MAC PDU including a UL RRC message to the DU 174. In turn, the DU 174 transmits 606 a DU-to-CU message including the UL RRC message to the CU-CP 172A. In response to or after receiving 606 the UL RRC message, the CU-CP 172A transmits 607 the Retrieve UE Context Request message to the base station 104. In response, the base station 104 transmits 609 the Retrieve UE Context Response message to the CU-CP 172A.

In cases where the UE 102 includes UL data in the initial UL MAC PDU 604, the DU 174 can transmit 615 a DU-to-CU message including the UL data to the CU-CP 172A or 616 the UL data, similar to the events 415 or 416, respectively.

In some implementations, after transmitting 604 the initial UL MAC PDU, the UE 102 in the inactive state transmits 618 subsequent UL data to CU-CP 172A and/or CU-U 172B via the DU 174, similar to the event 418. In further implementations, after transmitting 604 the initial UL MAC PDU, the UE 102 in the inactive state receives 618 DL data from CU-CP 172A and/or CU-U 172B via the DU 174, similar to the event 418. In some implementations, after the events 604 and/or 618, the UE 102 and base station 106 perform 694 an SDT complete procedure, similar to the event 494. The UE 102 remains 636 in the inactive state in response to or after performing 694 the SDT complete procedure.

In some implementations, the CU-CP 172A refrains from including a suspend indication (e.g., Bearer Context Status Change IE with a “Suspend” value) in the Bearer Context Setup Request message 612. In some implementations, the CU-CP 172A includes, in the Bearer Context Setup Request message 612, a resume indication (e.g., Bearer Context Status Change IE with a “ResumeforSDT” value) indicating to the CU-UP 172B to suspend the non-SDT DRB(s). In response to the resume indication, the CU-UP 172B suspends the non-SDT DRB(s). In other implementations, the CU-CP 172A refrains from including the resume indication in the Bearer Context Setup Request message 612. In some such implementations, the CU-CP 172A includes a resume indication (e.g., Bearer Context Status Change IE with a “ResumeforSDT” value) in the Bearer Context Modification Request message 624 to indicate to the CU-UP 172B to suspend the non-SDT DRB(s). In response to the resume indication, the CU-UP 172B suspends the non-SDT DRB(s). In some implementations, if the UE 102 is not configured with a non-SDT DRB, the CU-CP 172A excludes the resume indication in the Bearer Context Setup Request message 612 and/or the Bearer Context Modification Request message 624.

In some implementations, when the CU-UP 172B suspends the non-SDT DRB(s), the CU-UP 172B suspends the bearer context(s) of the non-SDT DRB(s) and/or data communication for the non-SDT DRB(s).

In further implementations, after establishing the bearer context(s) for the SDT DRB(s), the CU-UP 172B receives 616, 618 the UL data from the DU 174 and processes the UL data, because the SDT DRB(s) where the UL data is associated is not suspended by the CU-UP 172B. In some scenarios or implementations, the CU-UP 172B receives a DL data packet for the UE 102 from a CN 110 (e.g., UPF 162) or an edge server. If the DL data packet is associated with one of the SDT DRB(s), the CU-UP 172B transmits 618 the DL data packet to the DU 174, which in turn transmits 618 the DL data packet(s) to the UE 102. If the DL data packet is associated with one of the non-SDT DRB(s), the CU-UP 172B suspends transmitting the DL data packet(s) to the DU 174. In response to receiving the DL data packet associated with the non-SDT DRB(s), the CU-UP 172B transmits, to the CU-CP 172A, a UP-to-CP message (e.g., DL Data Notification message) to notify the CU-CP 172A that a DL data packet for the non-SDT DRB arrives. In some implementations, the CU-UP 172B can include, in the UP-to-CP message, a PDU session ID and/or a QoS flow ID where the non-SDT DRB is associated.

Referring next to FIG. 6C, a scenario 600C depicts small data transmission, similar to the scenario 500A/500B and 600A. Except events 607 and 609, events 602, 604, 606, 608, 610, 645, 646, 648, 650, 652, 612, 614, 619, 690, 694, 636, 692, and 695 are similar to events 502, 542, 554, 506, 508, 510, 545, 546, 548, 550, 552, 512, 514, 518, 590, 594, 536, 592, and 595, respectively. Examples and implementations for FIGS. 5A, 5B and 6A can apply to FIG. 6C. The differences among FIGS. 5A, 5B, and 6A and FIG. 6C are described below.

In the scenario 600C, the CU-CP 172A refrains from including a suspend indication (e.g., Bearer Context Status Change IE with a “Suspend” value) in the Bearer Context Setup Request message 612 and the Bearer Context Modification Request message 624. Thus, the CU-UP 172B does not suspend a DRB of the UE 102 in response to or after receiving the Bearer Context Setup Request message 612 and the Bearer Context Modification Request message 624.

In some implementations, after establishing the bearer context(s) for the DRB(s) of the UE 102 (e.g., the SDT DRB(s) and/or the non-SDT DRB(s) of the UE 102), the CU-UP 172B receives 616, 619 the UL data packet(s) from the DU 174 and processes the UL data packet(s), because the DRB(s) with which the UL data is associated are not suspended by CU-UP 172B. The UL data packet(s) can be PDCP PDU(s), SDAP PDU(s), IP packet(s) or Ethernet packet(s). The UL data packet(s) are associated with DRB(s) (e.g., SDT DRB(s) and/or non-SDT DRB(s)). In some implementations, the UE 102 applies one or more security functions (e.g., encryption and/or integrity protection) to the UL data packet(s) as described above. The CU-UP 172B applies one or more security functions (e.g., decryption and/or integrity protection check) to the UL data packet(s) as described above. In some scenarios or implementations, the CU-UP 172B receives DL data packet(s) for the UE 102 from a CN (e.g., UPF 162) or an edge server. The DL data packet(s) can be IP packet(s) or Ethernet packet(s) and associated with the DRB(s). In some implementations, the CU-UP 172B applies one or more security functions (e.g., encryption and/or integrity protection) to the DL data packet(s) as described above. The UE 102 applies one or more security functions (e.g., decryption and/or integrity protection check) to the DL data packet(s) as described above.

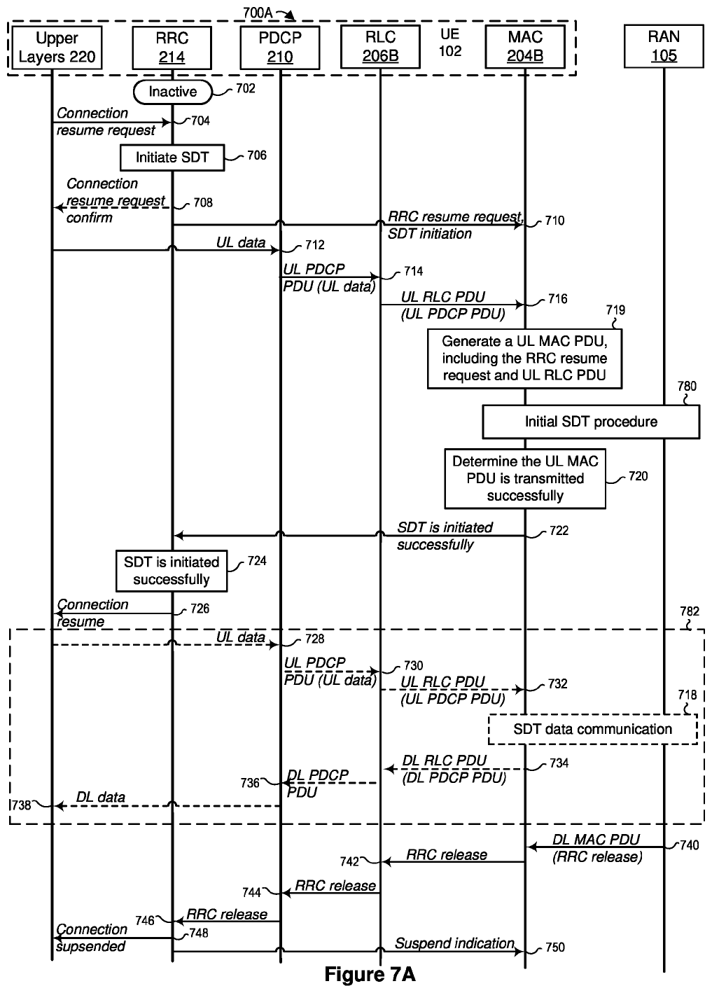

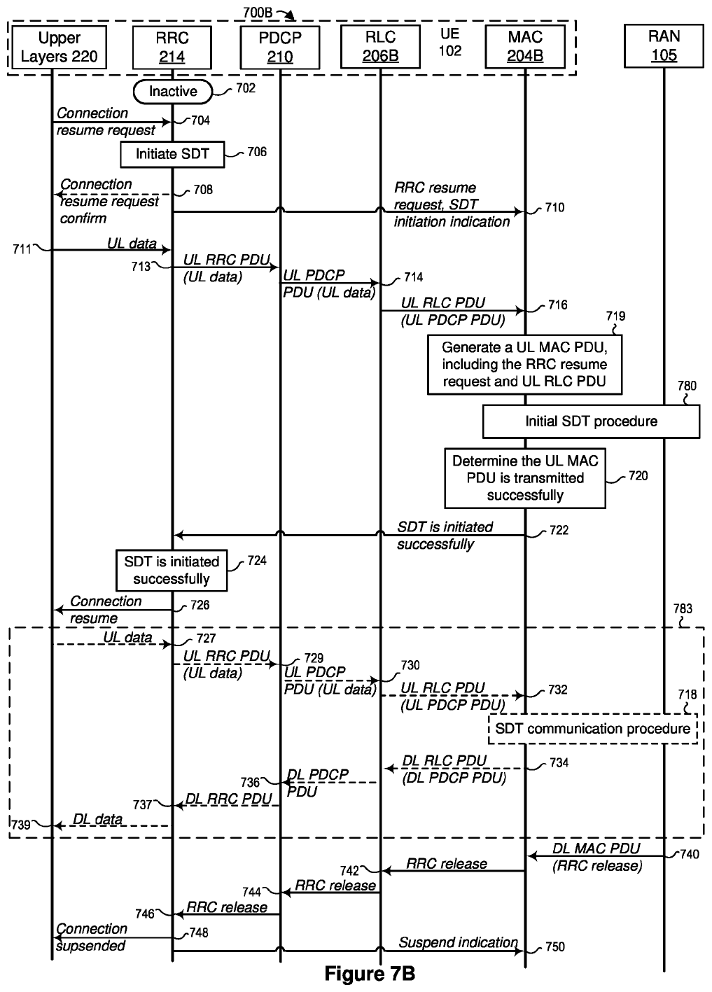

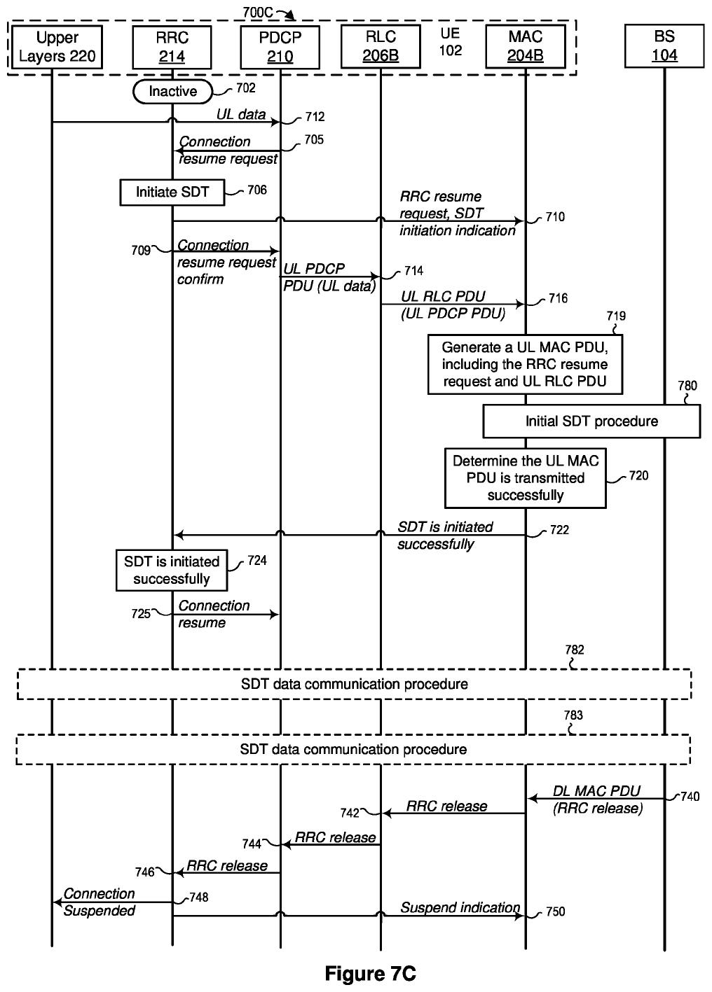

Referring first to FIG. 7A, a scenario 700A depicts data communication between the UE 102 and RAN 105 (e.g., base station 104 or 106) while the UE 102 operates in an inactive state (i.e., small data transmission). In the scenario 700A, the UE 102 includes the MAC sublayer 204B, the RLC sublayer 206B, the PDCP sublayer 210, the RRC sublayer 214, and upper layer(s) 220. Depending on the implementation, the upper layer(s) 220 include a mobility management (MM) sublayer, a session management (SM) sublayer, the SDAP sublayer 212, a data transport layer, a data connection manager, and/or a packet handler. For example, the MM sublayer and the SM sublayer can be a 5GMM sublayer and a 5GSM sublayer, respectively. In some implementations, the data transport sublayer is an IP layer or an Ethernet layer. In some implementations, the data connection manager manages to establish, release, suspend, or resume a data connection. The packet handler is a module to dispatch IP packets or Ethernet packets to a data connection. In some implementations, a data connection includes a packet data network (PDN) connection, a PDU session, an EPS bearer, a QoS flow, and/or a data path among the data transport layer, the packet handler, the SDAP sublayer 212, and/or the PDCP sublayer 210. In some implementations, the data connection manager is further divided into different modules (e.g., PDN (connection) management module, PDU (session) manage module, network service module, or data service module) each responsible for particular function(s).

To simplify the following description, “RRC 214, “PDCP 210”, “RLC 206B”, “MAC 204B”, and “PHY 202B” are used to represent “RRC sublayer 214”, “PDCP sublayer 210”, “RLC sublayer 206B”, “MAC sublayer 204B”, and “PHY sublayer 202B”, respectively.

Initially, the UE 102 operates 702 in the inactive state with SDT configured (e.g., as described for FIG. 3 or 4). Later in time, the upper layer(s) 220 determine to initiate data transmission or resume a (suspended) connection to transmit data. In response to the determination, the upper layer(s) 220 send 704 a connection resume request message to the RRC 214. In response to or after receiving the connection resume request message, the RRC 214 initiates 706 an SDT procedure (i.e., the UE 102 starts an SDT session). In some implementations, the RRC 214 can send 708 a connection resume request confirm message to the upper layer(s) 220, confirming that the RRC 214 receives or is processing the connection resume request message.

In some implementations, the upper layer(s) 220 include data volume information in the connection resume request message. The data volume information includes or indicates a data volume of data available for transmission. Based on the data volume information, the RRC 214 determines to initiate 706 the SDT procedure. For example, if the data volume in the data volume information is below a threshold, the RRC 214 determines to initiate 706 the SDT procedure. In some implementations, the UE 102 receives the threshold in a system information block (SIB) broadcast by the RAN 105. In other implementations, the RRC 214 receives the threshold in an RRC release message transmitted by the RAN 105 (e.g., similar to events 334 or 434). In cases where the RRC 214 receives a connection resume request message including data volume information and a data volume in the data volume information is above the threshold, the RRC 214 initiates an RRC connection resume procedure to transition to a connected state instead of the SDT procedure.

In other implementations, the upper layer(s) 220 includes an SDT indication in the connection resume request message, and the SDT indication indicates to the RRC 214 to initiate an SDT procedure. In response to the SDT indication, the RRC 214 initiates 706 SDT. In such implementations, the RRC 214 sends the threshold to the upper layer(s) 220. The upper layer(s) 220 determine to include the SDT indication if the data volume is below the threshold. If the data volume is above the threshold, the upper layer(s) 220 refrain from including the SDT indication in the connection resume request message.

In response to initiating 706 the SDT procedure, the RRC 214 generates an RRC resume request message and sends 710 the RRC resume request message to the MAC 204B. In some implementations, the RRC 214 sends 710 to the MAC 204B a UL SDT initiation indication indicating that the RRC resume request message is for UL SDT initiation. In some implementations, the RRC 214 sends an interface message including the RRC resume request message and the UL SDT initiation to the MAC 204B. In other implementations, the RRC 214 sends, to the MAC 204B, separate interface messages including the RRC resume request message and the SDT initiation indication, respectively. In some implementations, the MAC 204B sends a confirmation interface message to the RRC 214 to confirm that the MAC 204B receives the interface message(s) and will transmit the RRC resume request message. When the MAC 204B receives the SDT initiation indication and/or the RRC resume request message, the MAC 204B waits to receive UL data from the RLC 204B to generate an initial UL MAC PDU like event 719.

In some implementations, in response to determining to initiate 706 the SDT procedure, the RRC 214 sends, to the PDCP 210, a resume indication message. In further implementations, the PDCP 210 resumes SRB2 and/or DRB(s) configured for SDT in response to the resume indication message. In some implementations, the RRC 214 indicates that the SRB2 and/or DRB(s) are to be resumed in the resume indication message. For example, the RRC 214 can include an ID of the SRB2 and ID(s) of DRB(s) in the resume indication message. In other implementations, the RRC 214 indicates that the resume indication message is for SDT. For example, the RRC 214 can include an SDT indication in the resume indication message.

After determining to initiate data transmission or resume a connection, transmitting 704 the connection resume request message, or receiving 708 the connection resume request confirm message, the upper layer(s) 220 send 712 UL data to the PDCP 210. In some implementations, the UL data includes data packet(s) such as IP packet(s) or Ethernet packet(s) and are generated by an application or operating system (e.g., Android, Windows, iOS, Mac OS, and Chrome OS). In other implementations, the UL data includes SDAP PDU(s). The PDCP 210 generates UL PDCP PDU(s), including the UL data, and sends 714 the UL PDCP PDU(s) to the RLC 206B. In some implementations, the PDCP 210 sends 714 the UL PDCP PDU(s) to the RLC 206B in response to after receiving the resume indication. The RLC 206B generates UL RLC PDU(s), including the UL PDCP PDU(s), and sends 716 the UL RLC PDU(s) to the MAC 204B. In some implementations, each of the UL RLC PDU(s) includes a particular UL PDCP PDU of the UL PDCP PDU(s). The MAC 204B then generates 719 an initial UL MAC PDU, which includes the RRC resume request message and the UL RLC PDU(s). Alternatively, the RLC 206B generates a UL RLC PDU segment, including a first portion of the UL PDCP PDU, and sends 716 the UL RLC PDU segment to the MAC 204B. The MAC 204B then generates 719 an initial UL MAC PDU, which includes the RRC resume request message and the UL RLC PDU segment. In some implementations, the MAC 204B includes at least one MAC control element (e.g., a buffer status report (BSR)) in the initial UL MAC PDU. In some implementations, the MAC 204B includes a data volume in the BSR, and the data volume indicates data available for transmission.

The MAC 204B performs 780 an initial SDT procedure to transmit the initial UL MAC PDU to the RAN 105 via a cell, similar to the event 404, procedure 480, or event 604. In the initial SDT procedure, the MAC 204B transmits the initial UL MAC PDU to the RAN 105, similar to the event 404. In some implementations, after transmitting 780 the initial UL MAC PDU, the MAC 204B determines 720 that the initial UL MAC PDU is transmitted successfully (i.e., the UL MAC PDU is received by the RAN 105). In some implementations, the MAC 204B performs a random access procedure with the RAN 105 via the cell to transmit the initial UL MAC PDU to the RAN 105 (i.e., RA-SDT). In such implementations, the MAC 204B determines that the initial UL MAC PDU is transmitted successfully upon receiving a contention resolution MAC control element in the random access procedure. In cases where the random access procedure is a two-step random access procedure, the MAC 204B receives, from the RAN 105, the contention resolution MAC CE in a Message B (MsgB) of the random access procedure. In cases where the random access procedure is a four-step random access procedure, the MAC 204B receives, from the RAN 105, the contention resolution MAC control element in a Message 4 (Msg4) (i.e., a DL MAC PDU) of the random access procedure. In some implementations, the MAC 204B generates the initial UL MAC PDU before performing the random access procedure. For example, in some cases where the random access procedure is a two-step random access procedure, the MAC 204B generates 719 the initial UL MAC PDU in accordance with a UL grant configured in a system information block (SIB).

In other implementations, the MAC 204B generates the initial UL MAC PDU during the random access procedure. For example, in some cases where the random access procedure is a four-step random access procedure, the MAC 204B performs the four-step random access procedure upon receiving 710 the RRC resume request message or the SDT initiation indication from the RRC 214. In further such cases, the MAC 204B generates 719 the initial UL MAC PDU upon receiving a UL grant in a random access response in the random access procedure. Alternatively, the MAC 204B generates 719 the initial UL MAC PDU in accordance with a MAC PDU size before initiating the random acc. In some implementations, the MAC PDU size is a preconfigured size. In other implementations, the UE 102 determines the MAC PDU size based on a UL grant in a random access response in a random access procedure that the UE 102 previously performed.

In some cases where the MAC 204B transmits 780, to the RAN 105 via the cell, the UL MAC PDU on CG resources using a configured UL grant, the MAC 204B determines 720 that the initial UL MAC PDU is transmitted successfully upon receiving from PHY 202B (not shown in FIG. 7A) a successful delivery indication indicating that the initial UL MAC PDU is transmitted successfully. In some implementations, the PHY 202B receives, on a PDCCH, a DCI and a CRC (of the DCI) scrambled with an ID of the UE 102 after transmitting 780 the initial UL MAC PDU. In response to or after receiving the DCI and CRC, the PHY 202B sends the indication to the MAC 204B. In some implementations, the ID of the UE 102 is a C-RNTI. In other implementations, the ID of the UE 102 is a configured scheduling RNTI (CS-RNTI). In some implementations, the DCI includes a dynamic UL grant. In other implementations, the DCI includes a downlink assignment.

In some implementations, the MAC 204B indicates a maximum RLC data size to the RLC 206B. The RLC 206B ensures a total size of the UL RLC PDU(s) or UL RLC PDU segment of the event 716 not larger than the maximum size. In some implementations, the MAC 204B determines a MAC PDU size of the initial UL MAC PDU based on the UL grant in the SIB, the UL grant in the random access response, or the configured UL grant. The MAC 204B determines the maximum RLC data size as (the MAC PDU size-a size of the RRC resume request message-a size of a subheader for the RRC resume request message). In cases where the MAC 204B determines to transmit at least one MAC control element (e.g., a BSR), the MAC 204B determines the maximum RLC data size as (the MAC PDU size-a size of the RRC resume request message-a size of a subheader for the RRC resume request message-a size of the at least one MAC control element-a size of a subheader for each of the at least one MAC control element).

In some cases where the initial UL MAC PDU includes the first portion of the UL PDCP PDU, the MAC 204B transmits, to the RAN 105, other UL MAC PDU(s) including other UL RLC PDU segment(s). In further implementations, the segment(s) include the rest of the portion(s) of the UL PDCP PDU. Each of the RLC PDU segment(s) include a particular portion of the UL PDCP PDU. Depending on the implementation, each of the other UL MAC PDU(s) includes a particular RLC PDU segment of the other UL RLC PDU segment(s). In some implementations, the MAC 204B transmits the other UL MAC PDU(s) using dynamic UL grant(s). The UE 102 (e.g., PHY 202B) receives the dynamic UL grants on PDCCH(s) from the RAN 105. In other implementations, the MAC 204B transmits the other UL MAC PDU(s) using configured UL grant(s) configured in CG configuration(s) that the UE 102 receives in an RRC release message (e.g., events 334 or 434). The RAN 105 receives the other UL MAC PDU(s), retrieves the other UL RLC PDU segment(s) from the other UL MAC PDU(s), and assembles the other UL RLC PDU segment(s) to obtain the UL PDCP PDU.

In response to the determination 720, the MAC 204B sends 722 to the RRC 214 an indication indicating that the SDT procedure is initiated successfully (i.e., the initial UL MAC PDU, RRC resume request message, or UL data has been transmitted successfully). In response to receiving 722 the indication, the RRC 214 determines 724 that the SDT procedure is initiated successfully. In response to the determination 724 or the indication 722, the RRC 214 transmits 726 a connection resume message to the upper layer(s) 220 to indicate that the connection is resumed. In some implementations, after receiving 726 the connection resume message, the upper layer(s) 220 send 728 subsequent UL data packet(s) to the PDCP 210. For each of the subsequent UL data packet(s), the PDCP 210 generates a UL PDCP PDU, including the subsequent UL data packet, and sends 730 the UL PDCP PDU to the RLC 206B. In some implementations, the RLC 206B generates subsequent UL RLC PDU(s), including the UL PDCP PDU(s), and/or generates UL RLC PDU segments, including the UL PDCP PDU. The RLC 206 sends 732 the subsequent UL RLC PDU(s) and/or UL RLC PDU segments to the MAC 204B. The MAC 204B generates subsequent UL MAC PDU(s), including the subsequent UL RLC PDU(s) and/or UL RLC PDU segments. The MAC 204B performs 718 SDT data communication to transmit the subsequent UL MAC PDU(s) to the RAN 105, similar to the event 418. In some implementations, the MAC 204B transmits the subsequent UL MAC PDU(s) using dynamic UL grant(s). The UE 102 receives the dynamic UL grants on PDCCH(s) from the RAN 105. In other implementations, the MAC 204B transmits the other UL MAC PDU(s) using configured UL grant(s) configured in CG configuration(s) that the UE 102 receives in an RRC release message (e.g., events 334 or 434).

In some implementations, during the SDT session, the RAN 105 performs 718 SDT communication to transmit the DL MAC PDU(s) to the UE 102, similar to the event 418. The DL MAC PDU(s) include MAC SDU(s). Each of the DL MAC PDU(s) includes at least one MAC SDU. Depending on the implementation, the MAC SDU(s) are or include DL RLC PDU(s) and/or DL RLC PDU segments. Each of the MAC SDU(s) includes at least one DL RLC PDU and/or at least one DL RLC PDU segment. The MAC 204B retrieves the MAC SDU(s) from the DL MAC PDU(s). The MAC 204B sends 734 the MAC SDU(s) to the RLC 206B. The RLC 206B retrieves DL PDCP PDU(s) from the DL RLC PDU(s) and/or DL RLC PDU segments, and sends 736 the DL PDCP PDU(s) to the PDCP 210. The PDCP 210 retrieves DL data packet(s) from the DL PDCP PDU(s) and sends 738 the DL data packets to the upper layer(s) 220. In some implementations, the DL data packet(s) are IP packet(s), Ethernet packet(s), or SDAP PDU(s).

The events 728, 730, 732 and events 734, 736, 738 can overlapped or non-overlapped. The events 728, 730, 732, 718, 734, 736, and 738 are collectively referred to in FIG. 7A as SDT data communication 782.

In some implementations, during the SDT session, the upper layer(s) 220 (e.g., the MM sublayer) communicate the UL data and/or DL data with the RAN 105 via the RRC 214, PDCP 210, RLC 206B, and MAC 204B (see e.g., SDT data communication 783 in FIG. 7B).

In further implementations, later in time, the RAN 105 determines to stop the SDT session (e.g., as described for FIG. 4). In response to the determination, the RAN 105 generates an RRC release message to stop the SDT session and configure the UE 102 to remain in the inactive state, and transmits the RRC release message to the UE 102, similar to the events 332, 334, 432, 434. The RAN 105 transmits 740 DL MAC PDU(s) including the RRC release message to the UE 102. In some implementations, the RAN 105 generates an RRC PDU (e.g., DL-DCCH-Message), including the RRC release message, and generates a DL PDCP PDU including the RRC PDU message. In one implementation, the RAN 105 generates a DL RLC PDU including the DL PDCP PDU, generates a DL MAC PDU including the DL RLC PDU, and transmits 740 the DL MAC PDU to the UE 102. The MAC 204B retrieves the DL RLC PDU from the DL MAC PDU and sends 742 the DL RLC PDU to the RLC 206B. The RLC 206B retrieves the DL PDCP PDU from the DL RLC PDU and sends 744 the DL PDCP PDU to the PDCP 210. The RRC 214 retrieves the RRC release message from the RRC PDU. In other implementations, the RAN 105 generates DL RLC PDU segments including the DL PDCP PDU. Each of the DL RLC PDU segments includes a particular portion of the DL PDCP PDU. The RAN 105 generates DL MAC PDUs, each including a particular DL RLC PDU segment of the DL RLC PDU segments, and transmits 740 the DL MAC PDUs to the UE 102. The MAC 204B retrieves the DL RLC PDU segments from the DL MAC PDUs and sends 742 the DL RLC PDU segments to the RLC 206B. The RLC 206B retrieves the DL PDCP PDU from the DL RLC PDU segments and sends 744 the DL PDCP PDU to the PDCP 210.

After receiving the DL PDCP PDU, the PDCP 210 retrieves the RRC PDU from the DL PDCP PDU and sends 746 the RRC PDU message to the RRC 214. The RRC 214 retrieves the RRC release message from the RRC PDU. The RRC 214 stops the SDT session and remains in the inactive state in response to the RRC release message. In some implementations, after or in response to receiving the RRC release message, the RRC 214 sends 748, to the upper layer(s) 220, a connection suspended indication indicating the connection is suspended. Thus, the upper layer(s) 220 determine that the connection is suspended in accordance with the connection suspended indication.

In further implementations, after or in response to receiving the RRC release message, the RRC 214 sends 750, to the MAC 204B, an indication (e.g., a suspend indication, stop (SDT) indication, or release indication) indicating to stop communication with the RAN 105. In response to the indication 750, the MAC 204B stops communication with the RAN 105. Depending on the implementation, in response to receiving the indication 750, the MAC 204B commands the PHY 202B to stop communication with the RAN 105. Alternatively, the RRC 214 sends, to the PHY 202B, an indication indicating to the PHY 202B to stop communication with the RAN 105 (not shown in FIG. 7A). In response to the indication from the MAC 202B or RRC 214, the PHY 202B stops communication with the RAN 105. For example, stopping communication includes stopping monitoring a PDCCH with the ID(s) of the UE 102. The ID(s) includes a C-RNTI and/or a CS-RNTI. When stopping monitoring a PDCCH with the ID(s) of the UE 102, the UE 102 monitors a PDCCH with one or more common RNTIs for receiving paging or system information. For example, the common RNTIs include paging RNTI (P-RNTI) and/or system information RNTI (SI-RNTI).

Referring next to FIG. 7B, a scenario 700B depicts small data transmission, similar to the scenario 700A. The differences between FIGS. 7A and 7B are described below.

In the scenario 700B, the upper layer(s) 220 send 711 UL data to the RRC 214 instead of the PDCP 212. In some implementations, the UL data can include NAS PDU(s). The RRC 214 generates a UL RRC PDU, including the UL data, and sends 713 the UL RRC PDU to the PDCP 212. The PDCP 212 generates a UL PDCP PDU, including the UL RRC PDU, and sends 714 the UL PDCP PDU to the RLC 206B.

In some implementations, after receiving 726 the connection resume message, the upper layer(s) 220 send 727 subsequent UL data packet(s) (e.g., NAS PDU(s) or LPP PDU(s)) to the RRC 214. For each of the subsequent UL data packet(s), the RRC 214 generates a UL RRC PDU, including the subsequent UL data packet, and sends 729 the UL RRC PDU to the PDCP 210. When the PDCP 210 receives 736 DL PDCP PDU(s) from the RLC 206B, the PDCP 210 retrieves DL RRC PDU(s) from the DL PDCP PDU(s) and sends 737 the DL RRC PDU(s) to the RRC 214. The RRC 214 retrieves DL data packet(s) (e.g., NAS PDU(s) or LPP PDU(s)) from the DL RRC PDU(s) and sends 739 DL data packet(s) to the upper layer(s) 220.

The events 727, 729, 730, 732, 718, 734, 736, 737 and 739 are collectively referred to in FIG. 7B as SDT data communication 783.

In some implementations, during the SDT session, the upper layer(s) 220 (e.g., the data connection manager, packet handler, the SDAP sublayer 212, etc.) communicate UL data packet(s) and/or DL data packet(s) with the RAN 105 via the RRC 214, PDCP 210, RLC 206B and MAC 204B (see e.g., SDT data communication 782 in FIG. 7A). In some implementations, the communication of the UL data packet(s) and/or DL data packet(s) overlap with the SDT communication 783. In other implementations, the communication of the UL data packet(s) and/or DL data packet(s) occur before or after the SDT communication 783.

Referring next to FIG. 7C, a scenario 700C depicts small data transmission, similar to the scenarios 700A and 700B. The differences among FIGS. 7A, 7B, and 7C are described below.

In the scenario 700C, when the upper layer(s) 220 has UL data available for transmission, the upper layer(s) 220 send 712 UL data to the PDCP 210. Depending on the implementation, the UL data includes NAS PDU(s) or data packet(s) (e.g., IP packet(s), Ethernet packet(s), or SDAP PDU(s)), as described above. As the connection is suspended, the PDCP 210 buffers the UL data and sends 705 a connection resume request message to the RRC 214. In response to or after receiving the connection resume request message, the RRC 214 initiates 706 an SDT procedure (i.e., the UE 102 starts an SDT session). In some implementations, the RRC 214 sends 709 a connection resume request confirm message to the PDCP 210, confirming that the RRC 214 receives or is processing the connection resume request message. After receiving 709 the connection resume request confirm message, the PDCP 210 sends 714 the UL PDCP PDU(s) to the RLC 206B. In some implementations, the SDT data communication 782 and SDT data communication 783 overlap. In other implementations, the SDT data communication 782 occur before or after the SDT data communication 783.

Next, several example methods that can be implemented in a UE (e.g., the UE 102) to support small data transmissions in the inactive state with a base station, DU, CU, or otherwise in a RAN, are discussed with reference to FIGS. 3-7C.

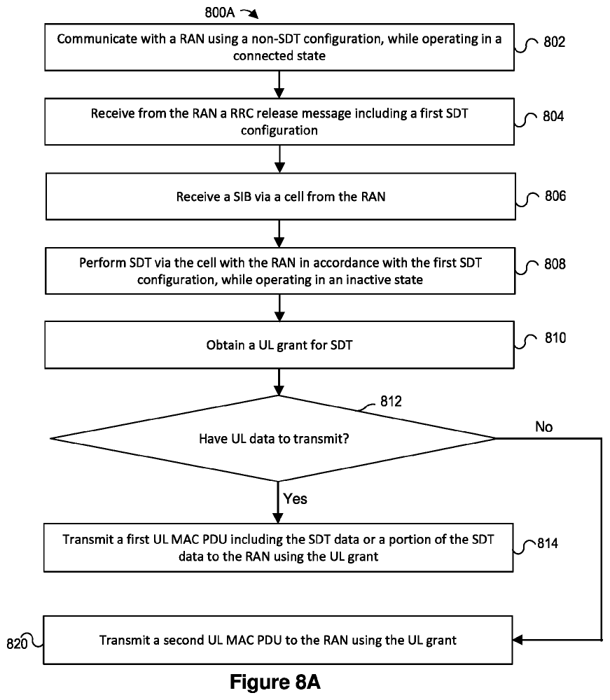

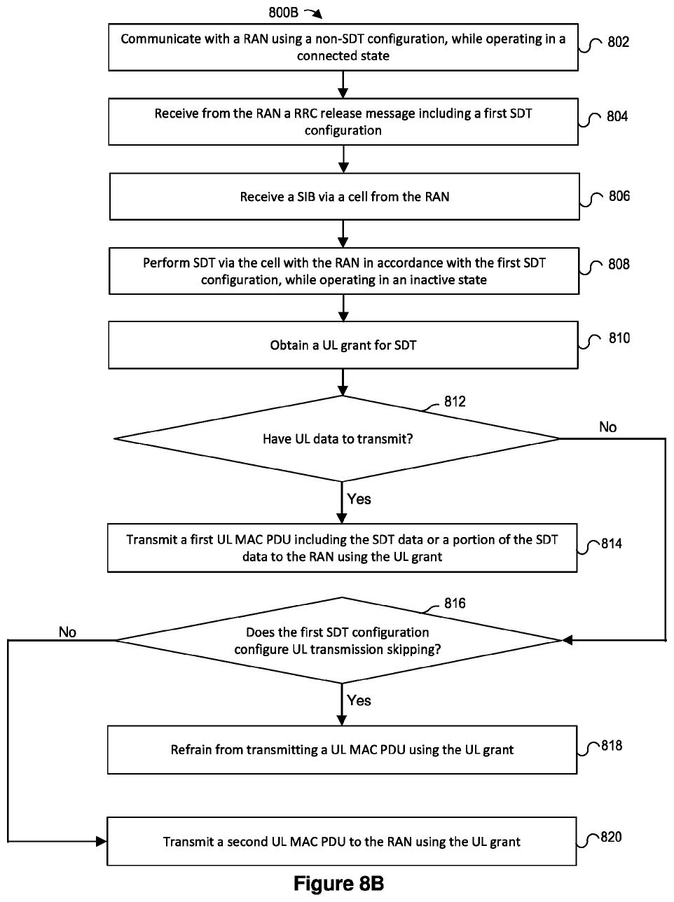

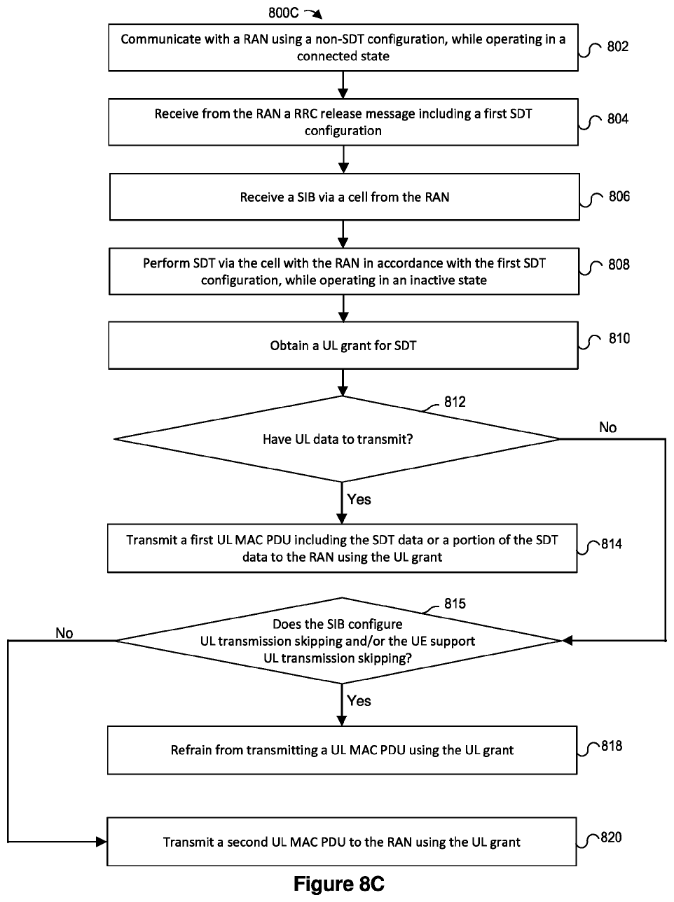

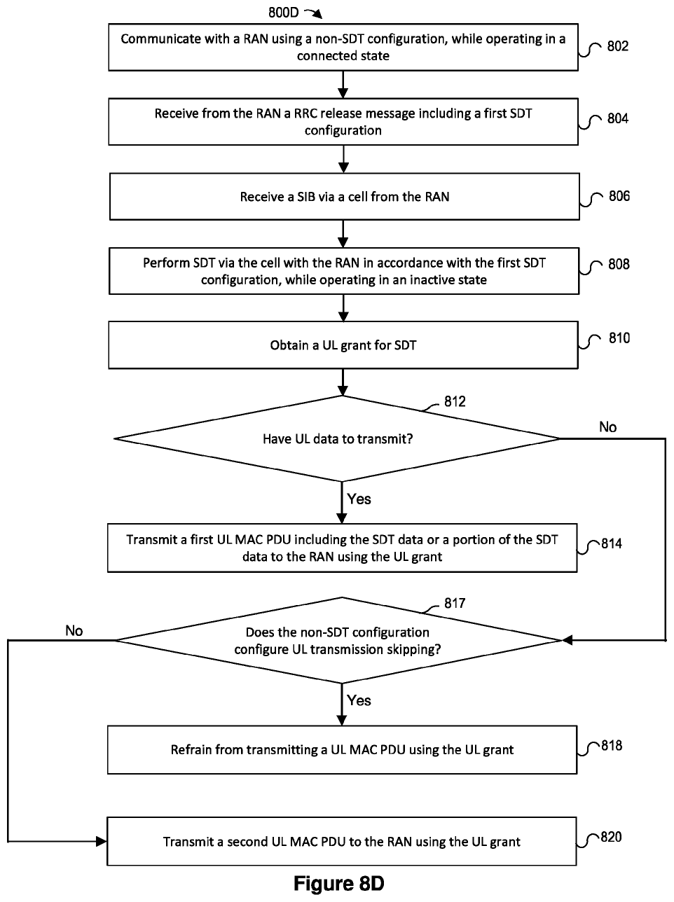

FIG. 8A illustrates a method 800A for handling small data communication, which can be implemented by a UE (e.g., UE 102). In particular, the method 800A is for determining whether to transmit SDT data to a RAN (e.g., RAN 105) using a UL grant based on whether the UE has UL data to transmit.

The method 800A begins at block 802, where the UE communicates with a RAN using a non-SDT configuration, while operating in a connected state (e.g., events 304, 312, 314, 320, 550, 552, 518, 588, 589, 619). At block 804, the UE receives, from the RAN, an RRC release message including a first SDT configuration (e.g., events 332, 334, 432, 434, 394, 494, 495, 594, 595, 694, 695). At block 806, the UE receives a SIB via a cell from the RAN. At block 808, the UE performs SDT (i.e., initiates an SDT session) via the cell with the RAN in accordance with the first SDT configuration, while operating in an inactive state (e.g., events 404, 418, 492, 493, 420, 494, 495, 592, 593, 594, 595, 692, 694, 695, 706, 710, 711, 712, 713, 714, 716, 719, 720, 722, 724, 780). At block 810, the UE obtains a UL grant for SDT during the SDT session. In some implementations, the UL grant is a dynamic grant (e.g., a DCI), and a DU (e.g., DU 174) of the RAN transmits the dynamic grant on a PDCCH to the UE. In other implementations, the UL grant is a configured grant and the first SDT configuration includes a configured grant configuration configuring the configured grant.

At block 812, the UE determines whether the UE has UL data to transmit during the SDT session. In some implementations, the UL data is data qualifying for SDT (i.e., SDT data). If the UE determines that the UE has UL data to transmit, the flow proceeds to block 814. At block 814, the UE transmits a first UL MAC PDU including the UL data or a portion of the UL data to the RAN, using the UL grant (e.g., events 418, 492, 493, 592, 692, 693, 727, 729, 730, 732, 718). Otherwise, if the UE determines that the UE has no data to transmit, the flow proceeds to block 820. At block 820, the UE transmits a second UL MAC PDU to the RAN, using the UL grant (e.g., events 418, 492, 493, 592, 692, 693, 718).

In some implementations, the SIB (e.g., SIB1) includes a second SDT configuration. For example, the second SDT configuration is SDT-ConfigCommonSIB IE (e.g., as defined in 3GPP specification v17.0.0). In some implementations, the second SDT configuration includes a logical channel timer value (e.g., sdt-LogicalChannelSR-DelayTimer-r17 as defined in 3GPP specification v17.0.0). In some implementations, the second SDT configuration includes a configuration parameter configuring UL transmission skipping for SDT (e.g., CG-SDT). In some implementations, the second SDT configuration includes an RSRP range for SDT (e.g., sdt-RSRP-Threshold-r17 or RSRP-Range). In some implementations, the second SDT configuration includes an SDT timer value (e.g., t319a-r17).

In some implementations, the UE at block 808 performs the SDT with the RAN via the cell in accordance with the first SDT configuration and the second SDT configuration. In other implementations, the UE at block 808 refrains from applying the second SDT configuration to perform the SDT. In some additional implementations, if the SDT is CG-SDT, the UE at block 808 refrains from applying the second SDT configuration to perform SDT via the cell. Otherwise, if the SDT is RA-SDT, the UE at block 808 applies the second SDT configuration to perform the SDT.

In some implementations, the first UL MAC PDU includes at least one MAC control element (CE) and at least one subheader for the at least one MAC CE. For example, the at least one MAC CE includes a BSR and the at least one subheader includes a subheader for the BSR. In another example, the at least one MAC CE includes a PHR and the at least one subheader includes a subheader for the PHR.

In some implementations, the second UL MAC PDU includes 1) at least one MAC CE and at least one subheader for the at least one MAC CE and/or 2) padding bits and a subheader for the padding bits. In other words, the second UL MAC PDU does not include SDT data. For example, the at least one MAC CE includes a BSR and the at least one subheader includes a subheader for the BSR. In another example, the at least one MAC CE includes a PHR and the at least one subheader includes a subheader for the PHR.

In some implementations, the non-SDT configuration includes configuration parameters in an RRC reconfiguration message (e.g., RRCReconfiguration message). In some implementations, the configuration parameters include measurement configuration(s), and SRB configuration(s) (e.g., SRB-ToAddMod IE(s)) and/or DRB configuration(s) (e.g., DRB-ToAddMod IE(s)) which are associated with SRB(s) and/or DRB(s) for the UE. In some implementations, the configuration parameters of the non-SDT configuration further include a cell group configuration (e.g., CellGroupConfig IE). The cell group configuration includes physical layer configuration parameters (e.g., PhysicalCellGroupConfig IE), MAC configuration parameter(s) (e.g., MAC-CellGroupConfig IE), and RLC configuration parameters(s) (e.g., one or more RLC bearer configurations (e.g., RLC-BearerConfig IEs)) associated with all SRB(s) and/or DRB(s) for the UE respectively. For example, the physical configuration parameters include beam related configuration parameters, MIMO configuration parameters, SRS configuration parameters, physical channel configuration parameters, and/or BWP configuration parameters.

FIG. 8B is a flow diagram of an example method 800B, similar to the method 800A, except that the method 800B additionally includes blocks 816 and 818. As such, the UE determines whether to transmit a data packet when the UE does not have UL data to transmit based on whether the first SDT configuration configures UL transmission skipping.

In particular, at block 816, the UE determines whether the first SDT configuration configures UL transmission skipping. If the first SDT configuration configures UL transmission skipping, the flow proceeds to block 818. At block 818, the UE refrains from transmitting a UL MAC PDU using the UL grant. Otherwise, if the first SDT configuration does not configure UL transmission skipping, the flow proceeds to block 820.

FIG. 8C is a flow diagram of an example method 800C, similar to the methods 800A and 800B, except that the method 800C includes block 815 instead of block 816. As such, the UE determines whether to transmit the data packet based on whether the SIB configures and/or the UE supports UL transmission skipping.

In particular, at block 815, the UE determines whether the SIB configures UL transmission skipping and/or the UE supports UL transmission skipping. If the SIB configures UL transmission skipping and/or the UE supports UL transmission skipping, the flow proceeds to block 818. Otherwise, if the SIB does not configure UL transmission skipping and/or the UE does not support UL transmission skipping, the flow proceeds to block 820.

FIG. 8D is a flow diagram of an example method 800D, similar to the methods 800A, 800B, and 800C, except that the method 800D includes block 817, instead of blocks 815 and 816. As such, the UE determines whether to transmit the data packet based on whether the non-SDT configuration configures UL transmission skipping.

In particular, at block 817, the UE determines whether the non-SDT configuration configures UL transmission skipping. If the non-SDT configuration configures UL transmission skipping, the flow proceeds to block 818. Otherwise, if the non-SDT configuration does not configure UL transmission skipping, the flow proceeds to block 820.

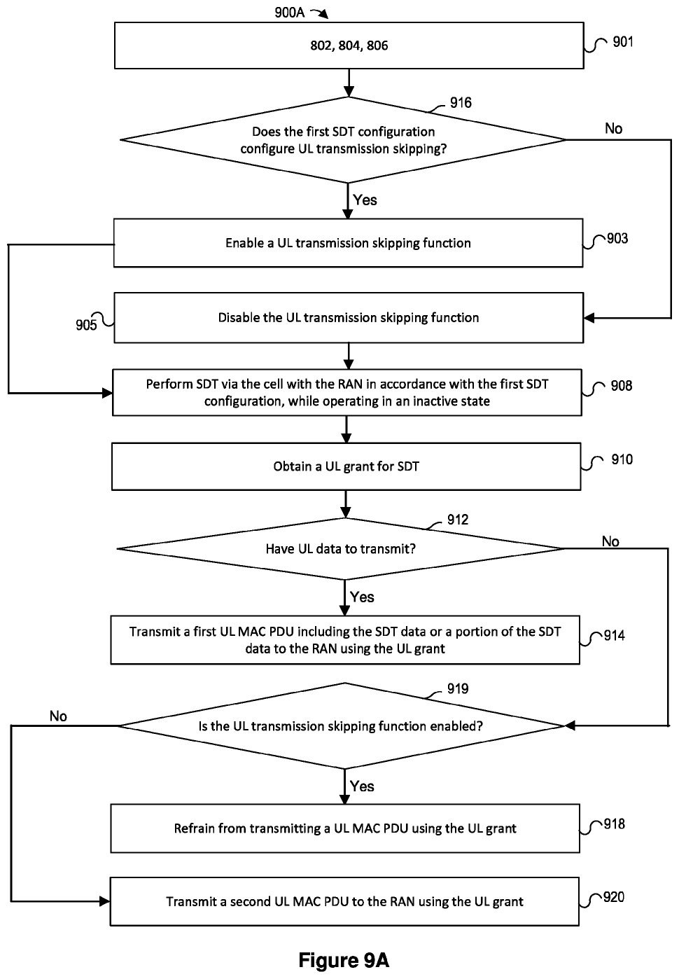

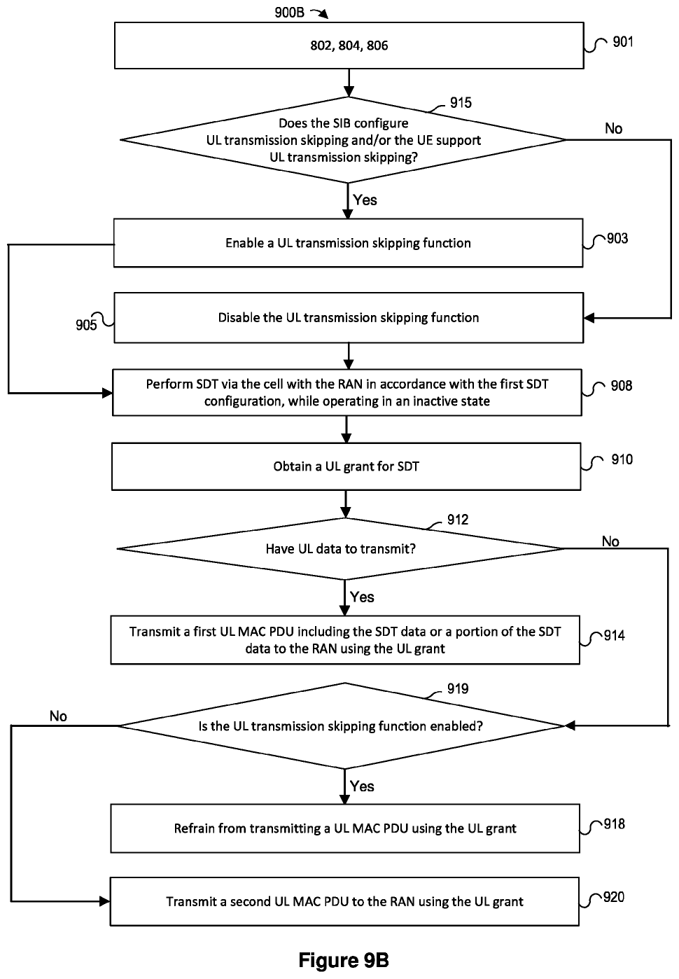

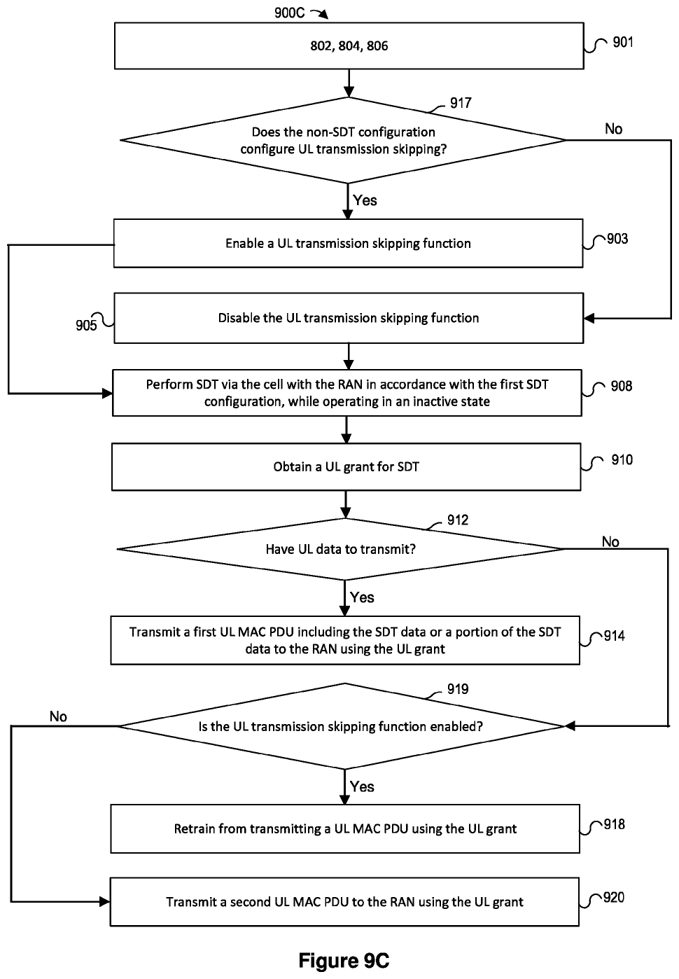

FIG. 9A illustrates an example method 900A for handling small data communication, which can be implemented by a UE (e.g., UE 102). In particular, the method 900A is a method for determining whether to enable UL transmission skipping based on whether an SDT configuration configures such before determining whether to transmit SDT data or a data packet.

The method 900A begins at block 901, where the flow proceeds to blocks 802, 804, and 806 described for FIG. 8. At block 916, the UE determines whether the first SDT configuration configures UL transmission skipping. If the first SDT configuration configures UL transmission skipping, the flow proceeds to block 903. At block 903, the UE enables a UL transmission skipping function. Otherwise, if the first SDT configuration does not configure UL transmission skipping, the flow proceeds to block 905. At block 905, the UE disables the UL transmission skipping function. The flow proceeds to block 908 from block 903 as well as from block 905.

At block 908, the UE performs SDT (i.e., initiates an SDT session) via the cell with a RAN (e.g., RAN 105) in accordance with the first SDT configuration, while operating in an inactive state (e.g., events 404, 418, 492, 493, 420, 494, 495, 592, 593, 594, 595, 692, 694, 695, 706, 710, 711, 712, 713, 714, 716, 719, 720, 722, 724, 780). At block 910, the UE obtains a UL grant for SDT during the SDT session. At block 912, the UE determines whether the UE has UL data to transmit during the SDT session. If the UE has UL data to transmit, the flow proceeds to block 914. At block 914, the UE transmits a first UL MAC PDU including the UL data or a portion of the UL data to the RAN, using the UL grant (e.g., events 418, 492, 493, 592, 692, 693, 727, 729, 730, 732, 718). Otherwise, if the UE has no data to transmit, the flow proceeds to block 919. At block 919, the UE determines whether the UL transmission skipping function is enabled. If the UL transmission skipping function is enabled, the flow proceeds to block 918. At block 918, the UE refrains from transmitting a UL MAC PDU using the UL grant. Otherwise, if the UL transmission skipping function is not enabled, the flow proceeds to block 920. At block 920, the UE transmits a second UL MAC PDU to the RAN, using the UL grant (e.g., events 418, 492, 493, 592, 692, 693, 718).

FIG. 9B is a flow diagram of an example method 900B, similar to the method 900A, except that the method 900B includes block 915, instead of blocks 916. As such, the UE determines whether to enable UL transmission skipping based on whether an SIB configures UL transmission skipping and/or the UE supports UL transmission skipping.

In particular, at block 915, the UE determines whether the SIB configures UL transmission skipping and/or the UE supports UL transmission skipping. If the SIB configures UL transmission skipping and/or the UE supports UL transmission skipping, the flow proceeds to block 903. Otherwise, if the SIB does not configure UL transmission skipping and/or the UE does not support UL transmission skipping, the flow proceeds to block 905.

FIG. 9C is a flow diagram of an example method 900C, similar to the methods 900A and 900B, except that the method 900C includes block 917, instead of blocks 916 and 915. As such, the UE determines whether to enable UL transmission skipping based on whether a non-SDT configuration configures UL transmission skipping.

In particular, at block 917, the UE determines whether the non-SDT configuration configures UL transmission skipping. If the non-SDT configuration configures UL transmission skipping, the flow proceeds to block 903. Otherwise, if the non-SDT configuration does not configure UL transmission skipping, the flow proceeds to block 905.

Examples and implementations described for FIG. 8A-8D can apply to FIGS. 9A-9B.

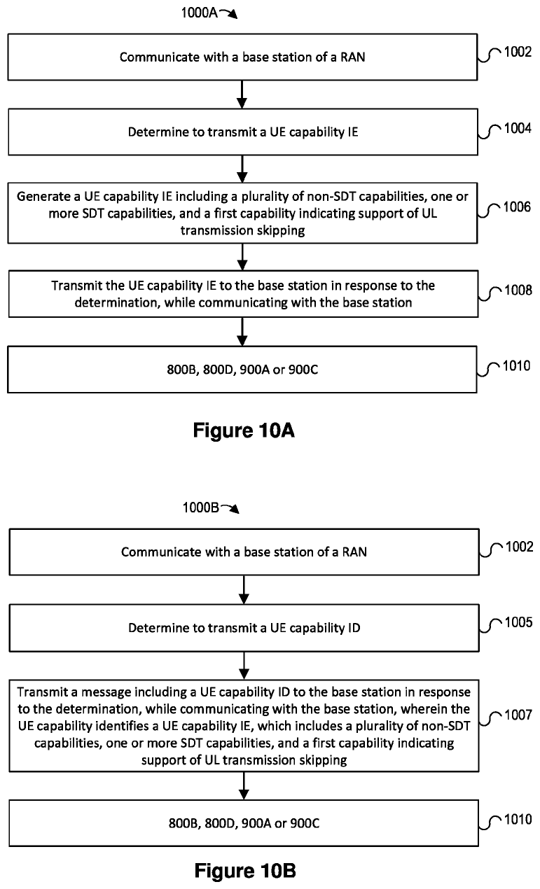

FIG. 10A is a flow diagram of an example method 1000A for managing small data communication, which can be implemented by a UE (e.g., UE 102). In particular, the method 1000A is a method for generating a UE capability IE including non-SDT, SDT, and UL transmission skipping capabilities.

The method 1000A begins at block 1002, where the UE communicates with a base station of a RAN (e.g., RAN 105). At block 1004, the UE determines to transmit a UE capability IE. At block 1006, the UE generates a UE capability IE including a plurality of non-SDT capabilities, one or more SDT capabilities, and a first capability indicating support of UL transmission skipping. At block 1008, the UE transmits the UE capability IE to the base station in response to the determination. At block 1010, the flow proceeds to one of the methods 800B, 800C, 900A, or 900C.

In some implementations, the UE determines to transmit the UE capability IE in response to receiving a UECapabilityEnquiry message from the base station. In some implementations, the UE capability IE is a UE-NR-Capability IE or a UE-6G-Capability IE. In some implementations, the UE at block 1008 transmits a message (e.g., an RRC message such as a UECapabilityInformation message) including the UE capability IE to the base station. Thus, the base station can determine that the UE supports UL transmission skipping in accordance with the first capability. In some implementations, the first capability is specific for UL transmission skipping for SDT (e.g., sdt-SkipUplinkTxDynamic-r17, sdt-SkipUplinkTxConfigured-r17, sdt-SkipUplinkTxDynamic-v17xy (x>1, y>1) and sdt-SkipUplinkTxConfigured-v17ab (a>1, b>1)).

In other implementations, the first capability is applied for SDT and non-SDT communications. In such implementations, the DU determines that the UE supports UL transmission skipping for SDT if the DU receives from the CU an SDT capability (e.g., CG-SDT capability such as cg-SDT or cg-SDT-r17) for the UE and the UL transmission skipping capability (e.g., skipUplinkTxDynamic, enhancedSkipUplinkTxConfigured-v1660, enhancedSkipUplinkTxDynamic-r16, enhancedSkipUplinkTxDynamic-r1660). The SDT capability indicates that the UE supports SDT (e.g., CG-SDT). If the DU receives the first capability and does not receive the SDT capability for the UE, the base station determines that the UE supports UL transmission skipping for non-SDT (i.e., data transmission while the UE operates in the connected state).

In other implementations, the first capability is a generic SDT capability. In such implementations, the DU determines that the UE supports UL transmission skipping for SDT if the base station receives the generic SDT capability (e.g., CG-SDT capability such as cg-SDT-r17) for the UE and the UL transmission skipping capability (e.g., skipUplinkTxDynamic, enhancedSkipUplinkTxConfigured-v1660, enhancedSkipUplinkTxDynamic-r16, enhancedSkipUplinkTxDynamic-r1660). The generic SDT capability indicates that the UE supports SDT (e.g., CG-SDT).

FIG. 10B is a flow diagram of an example method 1000B, similar to the methods 1000A and 900B, except that the method 1000B includes blocks 1005 and 1007, instead of blocks 1004, 1006 and 1008. As such, the UE transmits a UE capability identifier to a base station identifying a stored UE capability for non-SDT, SDT, and UL transmission skipping capabilities.

In particular, at block 1005, the UE determines to transmit a UE capability ID. At block 1007, the UE transmits a message including a UE capability ID to the base station in response to the determination, where the UE capability identifies a UE capability IE, which includes a plurality of non-SDT capabilities, one or more SDT capabilities, and a first capability indicating support of UL transmission skipping.

In some implementations, the message is a UL NAS message (e.g., a Registration Request message), and the base station forwards the UL NAS message to a CN (e.g., CN 110 including an AMF 164). The CN obtains the UE capability IE (e.g., from storage) in accordance with the UE capability ID and transmits the UE capability IE to the base station. Alternatively, the CN transmits the UE capability ID to the base station and the base station obtains the UE capability IE (e.g., from storage) in accordance with the UE capability ID. The UE receives a DL NAS message (e.g., a Registration Accept message) from the CN in response to the UL NAS message.

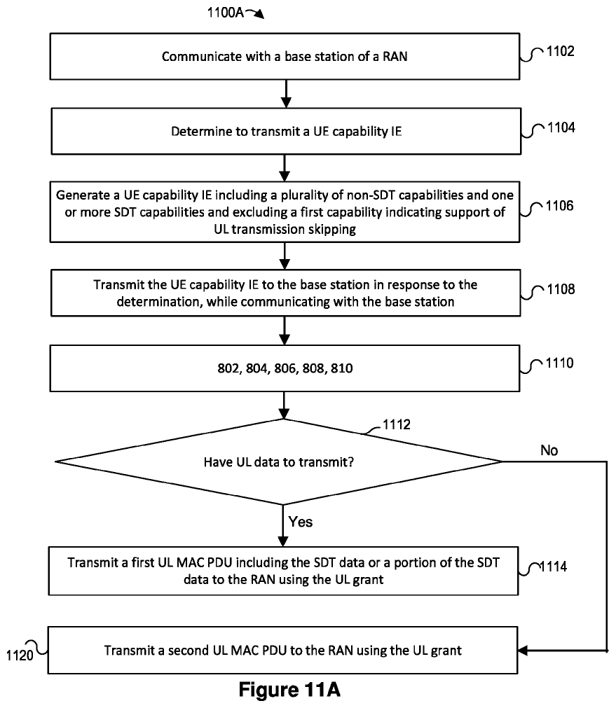

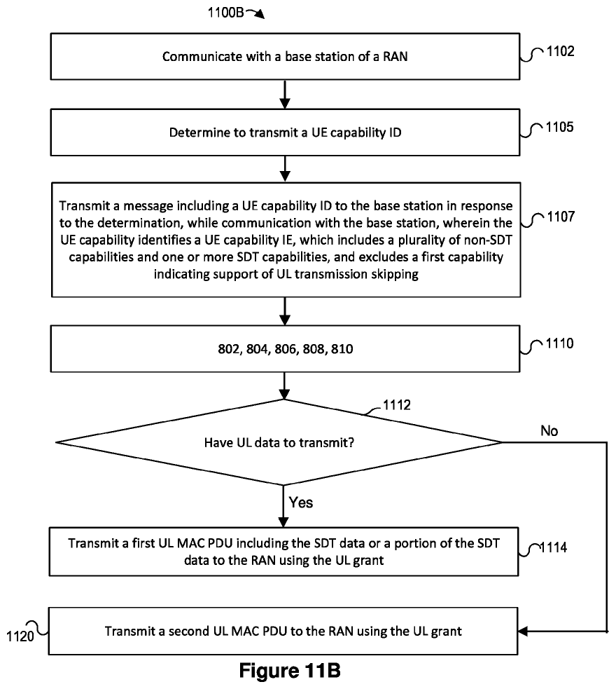

FIG. 11A is a flow diagram of an example method 1100A for managing small data communication, which can be implemented by a UE (e.g., UE 102). In particular, the method 1100A is a method for determining whether to transmit SDT data using a UL grant after generating and transmitting UE capability information to a RAN (e.g., RAN 105) node (e.g., base station 104).

The method 1100A begins at block 1102, where the UE communicates with a base station of a RAN (e.g., events 304, 312, 314, 320, 550, 552, 518, 588, 589, 619). At block 1104, the UE determines to transmit a UE capability IE. At block 1106, the UE generates a UE capability IE, including a plurality of non-SDT capabilities and one or more SDT capabilities and excluding a first capability indicating support of UL transmission skipping. At block 1108, the UE transmits the UE capability IE to the base station in response to the determination at block 1104 and while communicating with the base station. At block 1110, the flow proceeds to blocks 802, 804, 806, 808, and 810. At block 1112, the UE determines whether the UE has UL data to transmit. If the UE has UL data to transmit, the flow proceeds to block 1114. At block 1114, the UE transmits a first UL MAC PDU including the UL data or a portion of the UL data to the RAN, using the UL grant (e.g., events 418, 492, 493, 592, 692, 693, 727, 729, 730, 732, 718). Otherwise, if the UE has no data to transmit, the flow proceeds to block 1120. At block 1120, the UE transmits a second UL MAC PDU to the RAN, using the UL grant (e.g., events 418, 492, 493, 592, 692, 693, 718).

Examples and implementations described for FIGS. 8A-8D and 10A can apply to FIG. 11A.

FIG. 11B is a flow diagram of an example method 1100B, similar to the method 1100A, except that the method 1100B includes block 1105, and block 1107, instead of blocks 1104, 1106 and 1108. As such, the UE transmits a UE capability identifier to a base station identifying a stored UE capability.

In particular, at block 1105, the UE determines to transmit a UE capability ID. At block 1107, the UE transmits a message including a UE capability ID to the base station in response to the determination at block 1105 and while communicating with the base station, wherein the UE capability identifies a UE capability IE, which includes a plurality of non-SDT capabilities and one or more SDT capabilities and excludes a first capability indicating support of UL transmission skipping.

Examples and implementations described for FIGS. 8A-8D and 10B can apply to FIG. 11B.

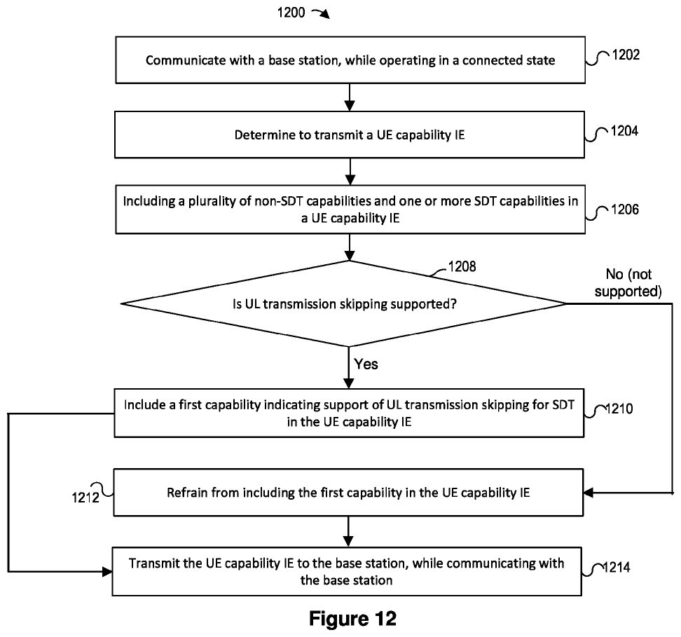

FIG. 12 is a flow diagram of an example method 1200 for managing small data communication, which can be implemented by a UE (e.g., UE 102). In particular, the method 1200 is a method for determining whether to indicate to a RAN (e.g., RAN 105) node (e.g., base station 104) that a UE supports transmission skipping.

The method 1200 begins at block 1202, where the UE communicates with a base station while operating in a connected state (e.g., events 304, 312, 314, 320, 550, 552, 518, 588, 589, 619). At block 1204, the UE determines to transmit a UE capability IE. At block 1206, the UE includes a plurality of non-SDT capabilities and one or more SDT capabilities in a UE capability IE. At block 1208, the UE determines whether the UL transmission skipping is supported. If the UL transmission skipping is supported, the flow proceeds to block 1210. At block 1210, the UE includes a first capability indicating support of UL transmission skipping for SDT in the UE capability IE. Otherwise, if the UL transmission skipping is not supported, the flow proceeds to block 1212. At block 1212, the UE refrains from including the first capability in the UE capability IE. At block 1214, the UE transmits the UE capability IE to the base station while communicating with the base station. The flow proceeds to block 1214 from block 1212 as well as from block 1210.

Examples and implementations described for FIG. 10A can apply to FIG. 12.

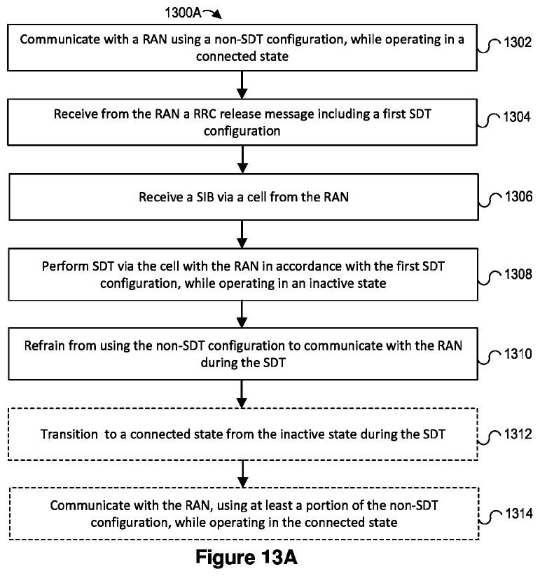

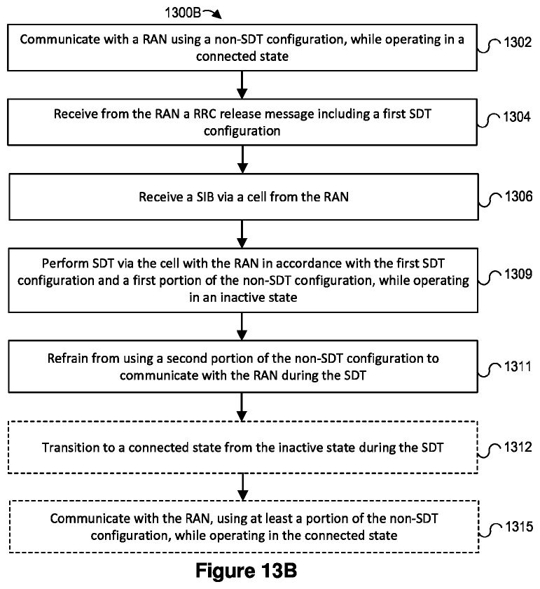

FIG. 13A is a flow diagram of an example method 1300A for managing small data communication, which can be implemented by a UE (e.g., UE 102). In particular, the method 1300A is a method for communicating with a RAN (e.g., RAN 105) node (e.g., base station 104) via SDT configurations and refrains from communicating via non-SDT configurations while in an inactive state.

The method 1300A begins at block 1302A, where the UE communicates with a RAN using a non-SDT configuration while operating in a connected state (e.g., events 304, 312, 314, 320, 550, 552, 518, 588, 589, 619). At block 1304, the UE receives, from the RAN, an RRC release message including a first SDT configuration (e.g., events 332, 334, 432, 434, 394, 494, 495, 594, 595, 694, 695). At block 1306, the UE receives an SIB via a cell from the RAN. At block 1308, the UE performs SDT via the cell with the RAN in accordance with the first SDT configuration while operating in an inactive state (e.g., events 404, 418, 492, 493, 420, 494, 495, 592, 593, 594, 595, 692, 694, 695, 706, 710, 711, 712, 713, 714, 716, 719, 720, 722, 724, 780). At block 1310, the UE refrains from using the non-SDT configuration to communicate with the RAN during the SDT. At block 1312, the UE transitions to a connected state from the inactive state during the SDT (e.g., events 545, 546, 645, 646). At block 1314, the UE communicates with the RAN, while operating in the connected state, using at least a portion of the non-SDT configuration (e.g., events 550, 552, 518, 590, 594).

In some implementations, the SIB includes a second SDT configuration and is an SIB1 or a new SIB. In some implementations, the second SDT configuration further includes a first RSRP threshold (e.g., sdt-RSRP-Threshold, sdt-RSRP-Threshold-r17 or RSRP-Range), a data volume threshold (e.g., sdt-DataVolumeThreshold or sdt-DataVolumeThreshold-r17), an SDT timer value (e.g., t319a-r17), and/or a logical channel delay timer value (e.g., sdt-LogicalChannelSR-DelayTimer or sdt-LogicalChannelSR-DelayTimer-r17). In some implementations, the second SDT configuration is an SDT-ConfigCommonSIB or SDT-ConfigCommonSIB-r17 IE. The UE performs measurements on DL signal(s) from the cell and obtains a first RSRP value from the measurements. In some implementations, if the first RSRP value is higher than the first RSRP threshold and UL data available for transmission is below the data volume threshold, the UE performs SDT (e.g., RA-SDT) with the RAN via the cell. Otherwise, the UE performs an RRC resume procedure with the RAN to transition to the connected state to transmit the UL data.

In some implementations, the first SDT configuration includes a second RSRP threshold (e.g., cg-SDT-RSRP-Threshold, cg-SDT-RSRP-ThresholdSSB, cg-SDT-RSRP-ThresholdSSB-r17 or RSRP-Range). The UE performs measurements on SSB(s) from the cell and obtains a second RSRP value from the measurements. In some implementations, if the first RSRP value is higher than the first RSRP threshold, the second RSRP value is higher than the second RSRP threshold, and UL data available for transmission is below the data volume threshold, the UE performs SDT (e.g., CG-SDT) with the RAN via the cell to transmit the UL data. Otherwise, if the first RSRP value is higher than the first RSRP threshold and the UL data available for transmission is below the data volume threshold, the UE performs SDT (e.g., RA-SDT) with the RAN via the cell to transmit the UL data. Otherwise, the UE performs an RRC resume procedure with the RAN to transition to the connected state to transmit the UL data.

In some implementations, the RAN node configures the DL signal(s) measured by the UE. For example, the RAN node configures the DL signal(s) as the SSB(s) so that the UE does not need to perform extra measurements to obtain the second RSRP value. In this example, the first RSRP value and the second RSRP value are the same value. In another example, the RAN node can configure the DL signal(s) partially the same as or different from the SSB(s) so that the UE does not need to perform separate measurements to obtain the first RSRP value and the second RSRP value respectively.

In some implementations, the non-SDT configuration include physical layer configuration parameters (e.g., PhysicalCellGroupConfig IE) and/or MAC configuration parameter(s) (e.g., MAC-CellGroupConfig IE). In some implementations, the UE refrains from using the first SDT configuration to communicate with the RAN while operating in the connected state.

FIG. 13B is a flow diagram of an example method 1300B, similar to the method 1300A, except that the method 1300B includes blocks 1309, 1311 and 1315 instead of blocks 1308, 1310 and 1314. As such, the UE communicates with the RAN node via the SDT configurations and a portion of the non-SDT configurations while in the inactive state.

In particular, at block 1309, the UE performs SDT via the cell with the RAN, in accordance with the first SDT configuration and a first portion of the non-SDT configuration, while operating in an inactive state (e.g., events 404, 418, 492, 493, 420, 494, 495, 592, 593, 594, 595, 692, 694, 695, 706, 710, 711, 712, 713, 714, 716, 719, 720, 722, 724, 780). At block 1311, the UE refrains from using a second portion of the non-SDT configuration to communicate with the RAN during the SDT. At block 1315, the UE communicates with the RAN, using at least a portion of the non-SDT configuration, while operating in the connected state (e.g., events 550, 552, 518, 590, 594).

In some implementations, the non-SDT configuration includes configuration parameters in an RRC reconfiguration message (e.g., RRCReconfiguration message). In some implementations, the configuration parameters include measurement configuration(s), and SRB configuration(s) (e.g., SRB-ToAddMod IE(s)) and/or DRB configuration(s) (e.g., DRB-ToAddMod IE(s)) which are associated with SRB(s) and/or DRB(s) for the UE. In such cases, the first portion of the non-SDT configuration includes some or all of the SRB configuration(s) (e.g., SRB-ToAddMod IE(s)) and/or some or all of the DRB configuration(s) (e.g., DRB-ToAddMod IE(s)), which are associated with DRB(s) or SRB(s) configured for SDT. The second portion of the non-SDT configuration includes the measurement configuration(s). Depending on the implementation, the second portion of the non-SDT configuration includes some of the SRB configuration(s) and/or some or all of the DRB configuration(s), which are associated with DRB(s) or SRB(s) configured for non-SDT, if existent.

In some implementations, the configuration parameters of the non-SDT configuration further include a cell group configuration (e.g., CellGroupConfig IE). The cell group configuration includes physical layer configuration parameters (e.g., PhysicalCellGroupConfig IE), MAC configuration parameter(s) (e.g., MAC-CellGroupConfig IE), and RLC configuration parameters(s) (e.g., one or more RLC bearer configurations (e.g., RLC-BearerConfig IEs)) associated with all SRB(s) and/or DRB(s) for the UE, respectively. For example, the physical configuration parameters include beam related configuration parameters, MIMO configuration parameters, SRS configuration parameters, physical channel configuration parameters, and BWP configuration parameters.

In some implementations, the first portion of the non-SDT configuration includes some or all of the one or more RLC bearer configurations associated with SRB(s) and/or DRB(s) for SDT. In some implementations, the second portion of the non-SDT configuration includes some of the one or more RLC bearer configurations associated with SRB(s) and/or DRB(s) for non-SDT, the MAC configuration parameter(s), and/or the physical layer configuration parameters. In other implementations, the first portion of the non-SDT configuration includes a first portion of the MAC configuration parameters, and the second portion of the non-SDT configuration includes a second portion of the MAC configuration parameters and/or the physical layer configuration parameters. For example, the first portion of the MAC configuration parameters include a UL transmission skipping configuration and/or data inactivity timer value, and the second portion of the MAC configuration parameters includes a DRX configuration, a BSR configuration, a PHR configuration, and/or a scheduling request configuration.

In some implementations, the portion of the non-SDT configuration includes the first portion of the non-SDT configuration. In some implementations, the portion of the non-SDT configuration includes the measurement configuration(s) and the SRB configuration(s) and/or DRB configuration(s), which are associated with SRB(s) and/or DRB(s) for the UE, respectively. In some implementations, the portion of the non-SDT configuration includes the one or more RLC bearer configurations associated with SRB(s) and/or DRB(s) for the UE. In some implementations, the portion of the non-SDT configuration includes a portion of the physical layer configuration parameters and a portion of MAC configuration parameters. In other implementations, the portion of the non-SDT configuration does not include the physical layer configuration parameters. In some implementations, the UE refrains from using the first SDT configuration to communicate with the RAN while operating in the connected state.

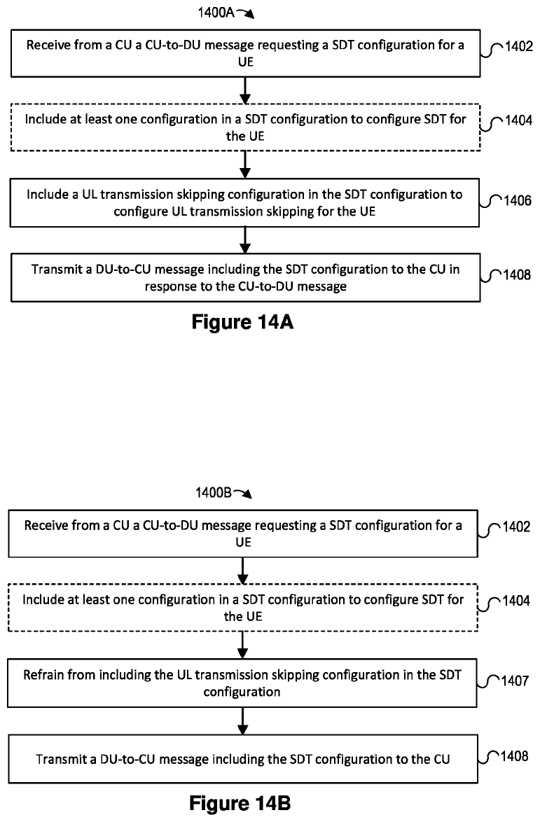

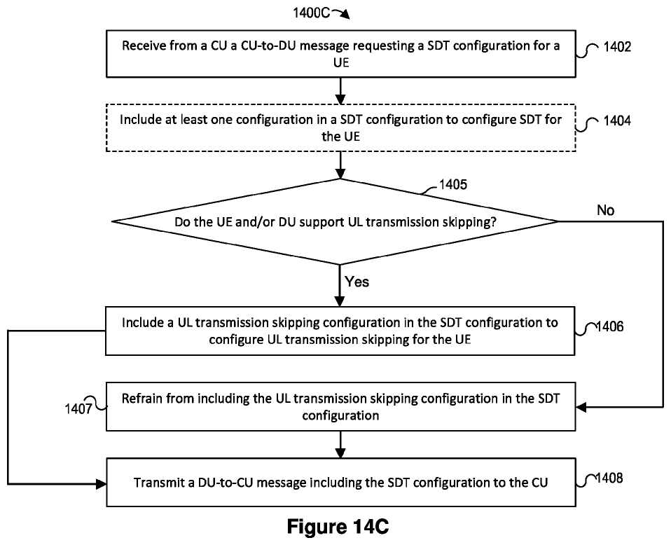

FIG. 14A is a flow diagram of an example method 1400A for managing uplink transmission skipping for a UE (e.g., the UE 102), which can be implemented by a DU (e.g., the DU 174). In particular, the method 1400A is a method for including a transmission skipping configuration in an SDT configuration to configure a UE.

The method 1400A begins at block 1402, where the DU receives, from a CU, a CU-to-DU message requesting an SDT configuration for a UE (e.g., events 328, 394, 428, 494, 495, 594, 595, 694, 695). At block 1404, the DU includes at least one configuration in an SDT configuration to configure SDT for the UE. At block 1406, the DU includes a UL transmission skipping configuration in the SDT configuration to configure UL transmission skipping for the UE. At block 1408, the DU transmits a DU-to-CU message, including the SDT configuration, to the CU in response to the CU-to-DU message (e.g., events 330, 394, 430, 494, 495, 594, 595, 694, 695).

In some implementations, the CU-to-DU message includes an SDT indication (e.g., CG-SDT query indication) indicating that the CU requests the DU to provide an SDT configuration. The DU includes the SDT configuration in the DU-to-CU message in response to the SDT indication.

In some implementations, the DU receives an RRC release message including the SDT configuration from the CU and transmits the RRC release message to the UE (e.g., events 332, 334, 432, 434, 394, 494, 495, 594, 595, 694, 695). The UE transitions to an inactive state or remains in the inactive state in response to the RRC release message (e.g., events 336, 436, 536, 636). After receiving the SDT configuration, the UE in the inactive state initiates or performs an SDT session with the DU and CU. In cases where the UE obtains a UL grant and does not have SDT data to transmit during the SDT session, the UE refrains from transmitting a UL MAC PDU to the DU as the UE is allowed by the UL transmission skipping configuration to do so.

In some implementations, the DU determines that the UE supports UL transmission skipping for SDT and includes the UL transmission skipping configuration in the SDT configuration in response to the determination. In some implementations, the DU makes the determination if the DU receives a UL transmission skipping capability for the UE from the CU and the UL transmission skipping capability indicates that the UE supports UL transmission skipping. For example, the DU receives a UE capability IE (e.g., UE-NR-Capability IE or UE-6G-Capability) of the UE from the CU and the UE capability IE includes the UL transmission skipping capability. In some implementations, the UL transmission skipping capability is specific for SDT (e.g., sdt-SkipUplinkTxDynamic-r17, sdt-SkipUplinkTxConfigured-r17, sdt-SkipUplinkTxDynamic-v17xy (x>1, y>1) and sdt-SkipUplinkTxConfigured-v114Ab (a>1, b>1)).

In other implementations, the UL transmission skipping capability is applied for SDT and non-SDT. In such implementations, the DU determines that the UE supports UL transmission skipping for SDT, if the DU receives from the CU an SDT capability (e.g., CG-SDT capability such as cg-SDT or cg-SDT-r17) for the UE and the UL transmission skipping capability (e.g., skipUplinkTxDynamic, enhancedSkipUplinkTxConfigured-v1660, enhancedSkipUplinkTxDynamic-r16, enhancedSkipUplinkTxDynamic-r1660). The SDT capability indicates that the UE supports SDT (e.g., CG-SDT). If the DU receives the UL transmission skipping capability and does not receive the SDT capability for the UE, the DU determines that the UE supports UL transmission skipping for non-SDT (i.e., data transmission while the UE operates in the connected state).

In other implementations, the UE automatically supports UL transmission skipping if the UE supports SDT (e.g., CG-SDT). In such cases, the DU determines that the UE supports UL transmission skipping for SDT if the DU determines that UE supports SDT (e.g., CG-SDT). For example, the DU determines that the UE supports UL transmission skipping for SDT if the DU receives, from the CU, a generic SDT capability (e.g., CG-SDT capability such as cg-SDT or cg-SDT-r17) indicating that the UE supports SDT.

In some implementations, the DU enables a UL transmission skipping detection function for the UE during an SDT session with the UE in response to configuring UL transmission skipping for the UE. In response to the enabling, the DU determines whether the UE skips a UL transmission scheduled by a UL grant. In some implementations, the UL grant is a dynamic grant (e.g., a DCI) and the DU transmits the dynamic grant on a PDCCH to the UE. In other implementations, the UL grant is a configured grant, and the SDT configuration includes a configured grant configuration to configure the configured grant. If the DU determines that the UE skips a UL transmission, the DU refrains from transmitting a DCI, including a dynamic grant, on a PDCCH to the UE. In some implementations, the DU detects an energy on a resource (e.g., time and frequency resource or physical resource blocks) configured in the UL grant. If the energy is below a predetermined threshold, the DU determines that the UE skips a UL transmission.

FIG. 14B is a flow diagram of an example method 1400B, similar to the method 1400A, except that the method 1400B includes blocks 1407, instead of blocks 1406. As such, the DU refrains from including the transmission skipping configuration in the SDT configuration.

In particular, at block 1407, the DU refrains from including a UL transmission skipping configuration in the SDT configuration. Thus, in cases where the UE does not have SDT data to transmit during the SDT session, the UE refrains from skipping a UL transmission because the SDT configuration does not include the UL transmission skipping configuration. In such cases, the UE transmits a UL MAC PDU not including any UL data to the DU, i.e., the UL MAC PDU includes empty UL data.

In some implementations, the DU determines that the UE does not support UL transmission skipping. In such cases, the DU refrains from including the UL transmission skipping configuration in the SDT configuration in response to the determination. In some implementations, the DU makes the determination when the DU does not receive the UL transmission skipping capability for the UE from the CU. For example, the DU receives a UE capability IE (e.g., UE-NR-Capability IE or UE-6G-Capability IE) of the UE from the CU and the UE capability IE does not include the UL transmission skipping capability of the UE.

In some implementations, the DU determines that the DU does not support UL transmission skipping for SDT. In such cases, the DU refrains from including the UL transmission skipping configuration in the SDT configuration in response to the determination. In other implementations, the DU is preconfigured to refrain from including the UL skipping configuration in the SDT configuration when the DU generates the SDT configuration.

In some implementations, the DU disables the UL transmission skipping detection function for the UE when the DU does not configure UL transmission skipping for the UE. During an SDT session with the UE, when the DU receives from the UE a UL MAC PDU, the DU processes the UL MAC PDU. If the UL MAC PDU only includes a subheader for padding, the DU ignores or discards the UL MAC PDU after processing the subheader. In some implementations, if the UL MAC PDU only includes MAC control element(s) (e.g., a BSR), subheader(s) for the MAC control element(s), and a subheader for padding, the DU retrieves the MAC control element(s) from the UL MAC PDU, processes the at least one MAC control element, and ignores or discards the remaining part of the UL MAC PDU after processing the subheader for padding.

FIG. 14C is a flow diagram of an example method 1400C, similar to the methods 1400A and 1400B, except that the method 1400C additionally includes block 1405. As such, the DU determines whether to include the transmission skipping configuration in the SDT configuration based on whether the UE and/or the DU supports UL transmission skipping.

In particular, at block 1405, the DU determines whether the UE and/or DU support UL transmission skipping. If the UE and/or DU support UL transmission skipping, the flow proceeds to block 1406. Otherwise, if the UE and/or DU do not support UL transmission skipping, the flow proceeds to block 1407. The flow proceeds to block 1408 from block 1406 as well as from block 1407.

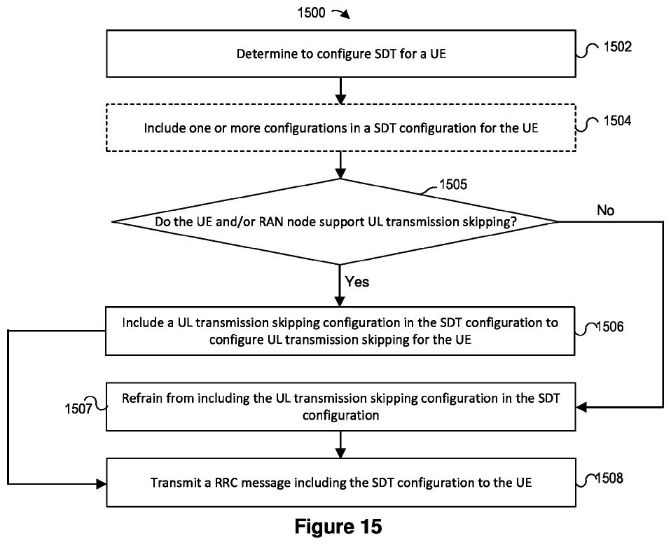

FIG. 15 is a flow diagram of an example method 1500 for managing uplink transmission skipping for a UE (e.g., the UE 102), which can be implemented by a RAN node (e.g., the base station 104/106 or DU 174). In particular, the example method 1500 is a method for determining whether to include a transmission skipping configuration based on whether the UE and/or RAN node supports UL transmission skipping.

The method 1500 begins at block 1502, where the RAN node determines to configure SDT for a UE. At block 1504, the RAN node includes one or more configurations in an SDT configuration for the UE. At block 1505, the RAN node determines whether the UE and/or RAN node support(s) UL transmission skipping. If the UE and/or RAN node support(s) UL transmission skipping, the flow proceeds to block 1506. At block 1506, the RAN node includes a UL transmission skipping configuration in the SDT configuration to configure UL transmission skipping for the UE. Otherwise, if the UE and/or RAN node do not support UL transmission skipping, the flow proceeds to block 1507. At block 1507, the RAN node refrains from including the UL transmission skipping configuration in the SDT configuration. The flow proceeds to block 1508 from block 1506 as well as from block 1507. At block 1508, the RAN node transmits an RRC message including the SDT configuration to the UE (e.g., events 332, 334, 432, 434, 394, 494, 495, 594, 595, 694, 695).

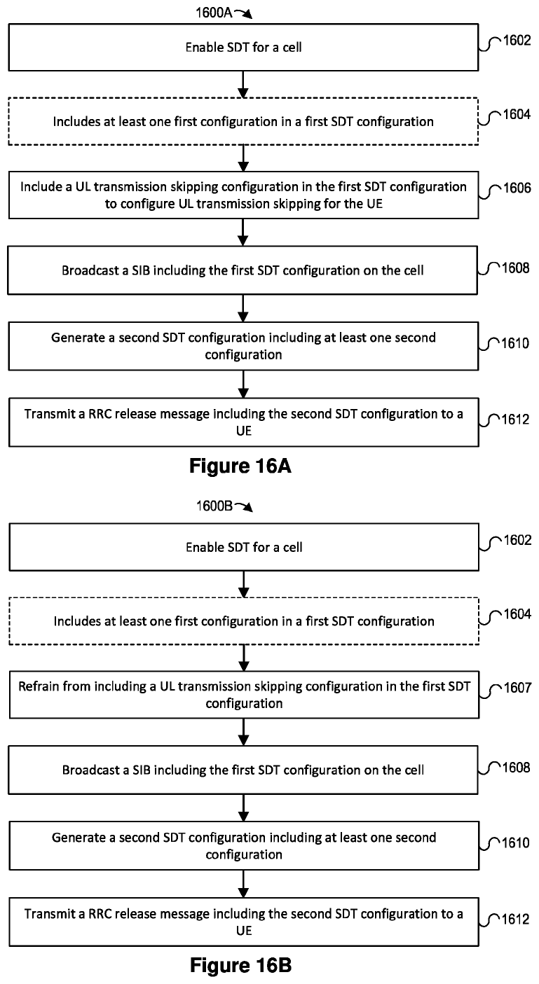

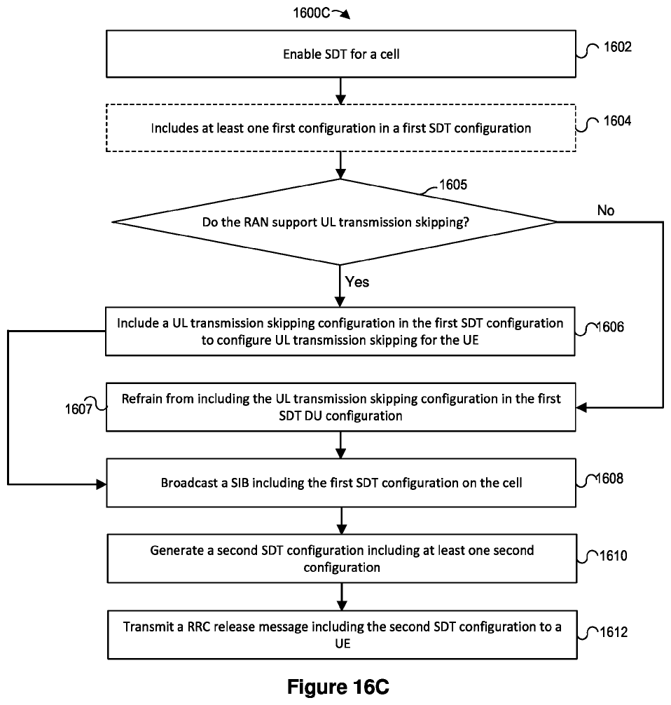

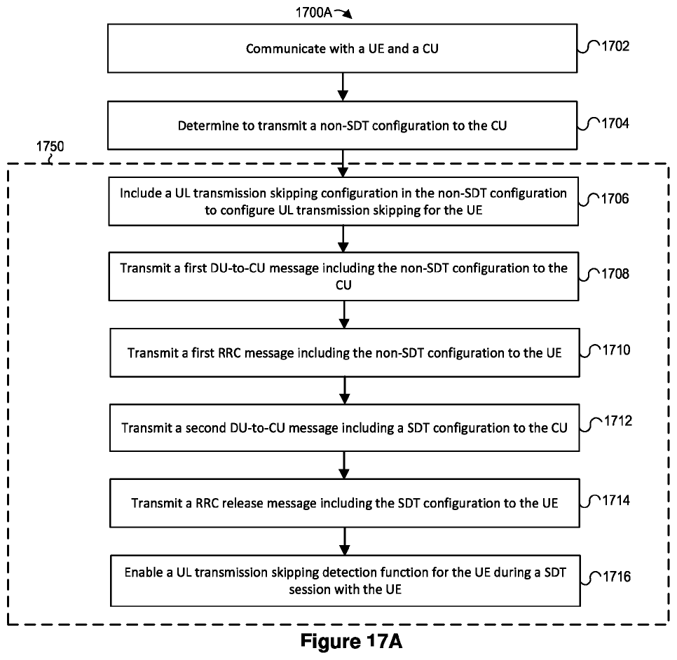

FIG. 16A is a flow diagram of an example method 1600A for managing uplink transmission skipping for a UE (e.g., the UE 102), which can be implemented by a RAN node (e.g., the base station 104/106 or DU 174). In particular, the method 1600A is a method for including a transmission skipping configuration in an SDT configuration and broadcasting the SDT configuration on a cell.

The method 1600A begins at block 1602, where the RAN node enables SDT for a cell. At block 1604, the RAN node includes at least one first configuration in a first SDT configuration. At block 1606, the RAN node includes a UL transmission skipping configuration in the first SDT configuration to configure UL transmission skipping for the UE. At block 1608, the RAN node broadcasts a SIB, including the first SDT configuration on the cell. At block 1610, the RAN node generates a second SDT configuration, including at least one second configuration. At block 1612, the RAN node transmits an RRC release message including the second SDT configuration to a UE (e.g., events 332, 334, 432, 434, 394, 494, 495, 594, 595, 694, 695).

In some implementations, the SIB is an SIB1 or a new SIB. In some implementations, the first SDT configuration further includes an RSRP threshold (e.g., sdt-RSRP-Threshold-r17 or RSRP-Range IE), a data volume threshold (e.g., sdt-DataVolumeThreshold-r17), an SDT timer value (e.g., t319a-r17), and/or a logical channel delay timer value (e.g., sdt-LogicalChannelSR-DelayTimer-r17). In some implementations, the first SDT configuration is an SDT-ConfigCommonSIB-r17 IE. In further implementations, the second SDT configuration is an SDT CU configuration and/or an SDT DU configuration described above.

FIG. 16B is a flow diagram of an example method 1600B, similar to the method 1600A, except that method 1600B includes block 1607, instead of block 1606. As such, the RAN node refrains from including the transmission skipping configuration in the SDT configuration. In particular, at block 1607, the RAN node refrains from including a UL transmission skipping configuration in the first SDT configuration.

FIG. 16C is a flow diagram of an example method 1600C, similar to the methods 1600A and 1600B, except that the method 1600C additionally includes block 1605. As such, the RAN node determines whether to include the transmission skipping configuration based on whether the RAN node supports UL transmission skipping.

In particular, at block 1605, the RAN node determines whether the RAN supports UL transmission skipping. If the RAN supports UL transmission skipping, the flow proceeds to block 1606. Otherwise, if the RAN does not support UL transmission skipping, the flow proceeds to block 1607. The flow proceeds to block 1608 from block 1606 as well as from block 1607.

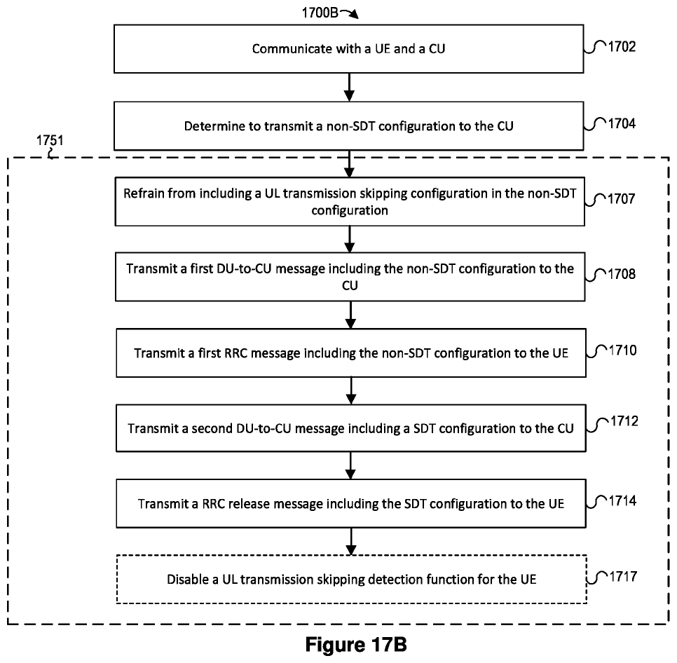

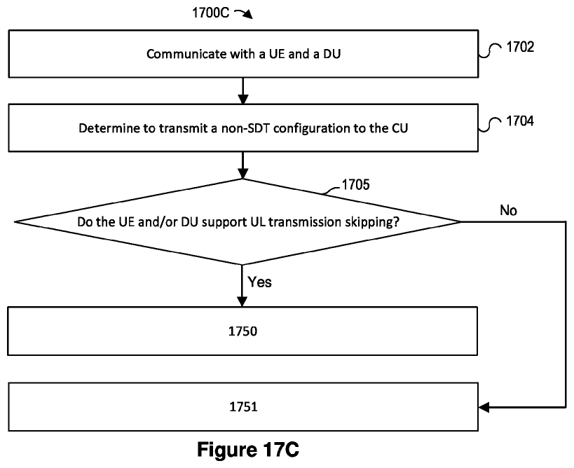

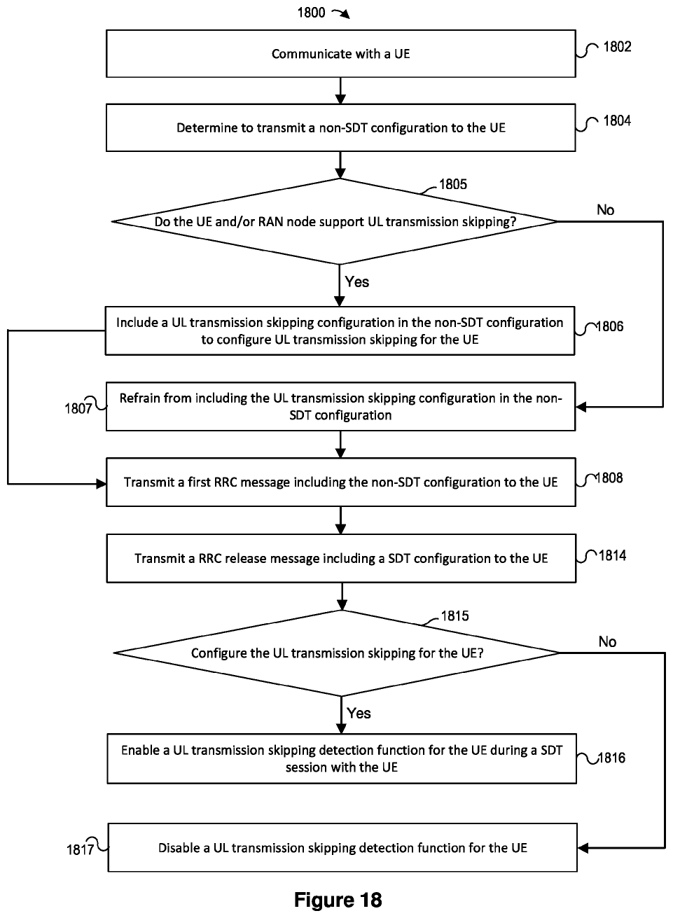

FIG. 17A is a flow diagram of an example method 1700A for managing uplink transmission skipping for a UE (e.g., the UE 102), which can be implemented by a DU (e.g., the DU 174). In particular, the method 1700A is a method for including a transmission skipping configuration in a non-SDT configuration, transmitting the non-SDT configuration to the UE, and enabling a transmission skipping detection function for the UE.

The method 1700A begins at block 1702, where the DU communicates with a UE and a CU (e.g., events 304, 492, 518, 588, 589, 592, 542, 544, 642, 644, 619). At block 1704, the DU determines to transmit a non-SDT configuration to the CU. At block 1706, the DU includes a UL transmission skipping configuration in the non-SDT configuration to configure UL transmission skipping for the UE. At block 1708, the DU transmits a first DU-to-CU message, including the non-SDT configuration, to the CU (e.g., events 308, 390, 510, 588, 589, 590, 610, 690). At block 1710, the DU transmits a first RRC message including the non-SDT configuration to the UE (e.g., events 312, 390, 546, 588, 589, 590, 646, 690). At block 1712, the DU transmits a second DU-to-CU message, including an SDT configuration, to the CU (e.g., events 330, 394, 430, 494, 495, 594, 595, 694, 695). At block 1714, the DU transmits an RRC release message including the SDT configuration to the UE (e.g., events 334, 434, 394, 494, 495, 594, 595, 694, 695). At block 1716, the DU enables a UL transmission skipping detection function for the UE during an SDT session with the UE (e.g., events 492, 494, 493, 495, 592, 692). Blocks 1706, 1708, 1710, 1712, 1714 and 1716 are grouped as block 1050.

FIG. 17B is a flow diagram of an example method 1700B, similar to the method 1700A, except that method 1700B includes blocks 1707 and 1717, instead of blocks 1706 and 1716. As such, the DU refrains from including the transmission skipping configuration in the non-SDT configuration.

In particular, at block 1707, the DU refrains from including a UL transmission skipping configuration in the non-SDT configuration. At block 1717, the DU disables a UL transmission skipping detection function for the UE. Blocks 1707, 1708, 1710, 1712, 1714 and 1717 are grouped as block 1051.

FIG. 17C is a flow diagram of an example method 1700C, similar to the methods 1700A and 1700B, except that the method 1700C additionally includes block 1705. As such, the DU determines whether to include the transmission skipping configuration in the non-SDT configuration based on whether the UE and/or DU supports UL transmission skipping.

In particular, the method 1700C begins at block 1702, where the DU communicates with a UE and a DU. At block 1704, the DU determines to transmit a non-SDT configuration to the CU. At block 1705, the DU determines whether the UE and/or DU supports UL transmission skipping. If the UE and/or DU supports UL transmission skipping, the flow proceeds to block 1050. Otherwise, if the UE and/or DU does/do not support UL transmission skipping, the flow proceeds to block 1051.

Examples and implementations described for FIGS. 14A-14C can apply to FIGS. 17A-17C.

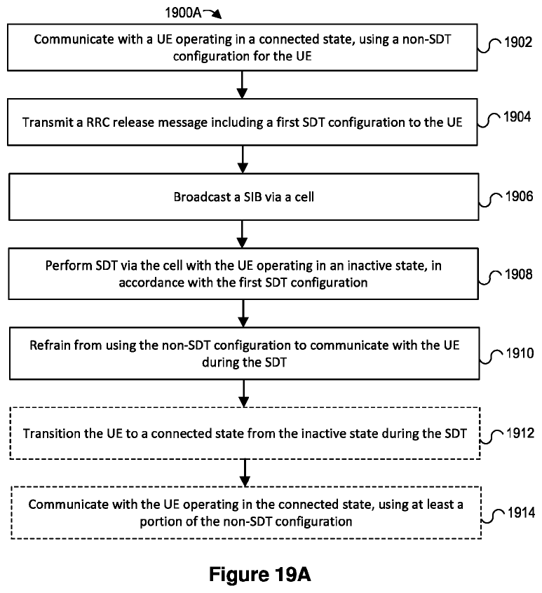

FIG. 18 is a flow diagram of an example method 1800 for managing uplink transmission skipping for a UE (e.g., the UE 102), which can be implemented by a RAN node (e.g., the base station 104/106 or DU 174). In particular, the method 1800 is a method for determining whether to include a transmission skipping configuration in a non-SDT configuration based on whether the UE and/or RAN node supports UL transmission skipping.

The method 1800 begins at block 1802, where the RAN node communicates with a UE (e.g., events 304, 492, 542, 544, 518, 550, 552, 588, 589, 592, 642, 644, 650, 652, 619). At block 1804, the RAN node determines to transmit a non-SDT configuration to the UE. At block 1805, the RAN node determines whether the UE and/or RAN node supports UL transmission skipping. If the UE and/or RAN node supports UL transmission skipping, the flow proceeds to block 1806. At block 1806, the RAN node includes a UL transmission skipping configuration in the non-SDT configuration to configure UL transmission skipping for the UE. Otherwise, if the UE and/or RAN node do not support UL transmission skipping, the flow proceeds to block 1807. At block 1807, the RAN node refrains from including the UL transmission skipping configuration in the non-SDT configuration. The flow proceeds to block 1808 from block 1806 as well as from block 1807.

At block 1808, the RAN node transmits a first RRC message including the non-SDT configuration to the UE (e.g., events 310, 312, 390, 545, 546, 588, 589, 590, 645, 646, 690). At block 1814, the RAN node transmits an RRC release message including an SDT configuration to the UE (e.g., events 332, 334, 432, 434, 394, 494, 495, 594, 595, 694, 695). At block 1815, the RAN node determines whether to configure the UL transmission skipping for the UE. If the RAN node determines to configure the UL transmission skipping for the UE, the flow proceeds to block 1816. At block 1816, the RAN node enables a UL transmission skipping detection function for the UE during an SDT session with the UE. Otherwise, if the RAN node determines not to configure the UL transmission skipping for the UE, the flow proceeds to block 1817. At block 1817, the RAN node disables a UL transmission skipping detection function for the UE.

Examples and implementations described for FIGS. 14A-14C can apply to FIG. 18.

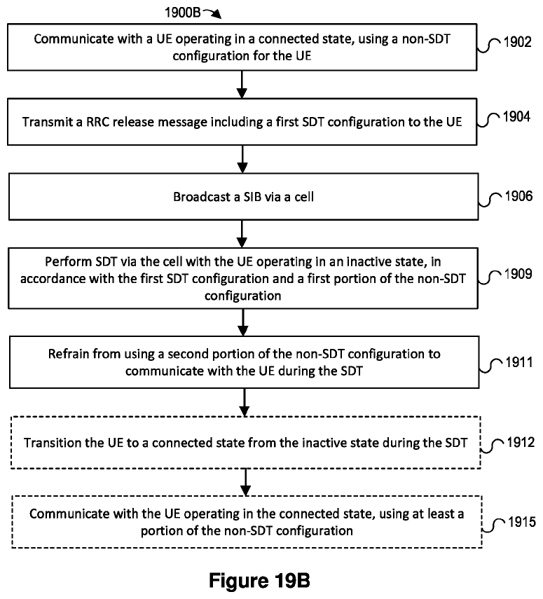

FIG. 19A is a flow diagram of an example method 1900A for managing uplink transmission skipping for a UE (e.g., the UE 102), which can be implemented by a RAN node (e.g., the base station 104/106 or DU 174). In particular, method 1900A is a method for communicating with a UE in an inactive state by using an SDT configuration and refraining from using a non-SDT configuration.

The method 1900A begins at block 1902, where the RAN node communicates with a UE operating in a connected state using a non-SDT configuration for the UE (e.g., events 304, 312, 314, 320, 550, 552, 518, 588, 589, 619). At block 1904, the RAN node transmits an RRC release message, including a first SDT configuration, to the UE (e.g., events 332, 334, 432, 434, 394, 494, 495, 594, 595, 694, 695). At block 1906, the RAN node broadcasts an SIB via a cell. At block 1908, the RAN node performs SDT via the cell with the UE operating in an inactive state, in accordance with the first SDT configuration and a portion of the non-SDT configuration (e.g., events 404, 418, 492, 493, 420, 494, 495, 592, 593, 594, 595, 692, 694, 695). At block 1910, the RAN node refrains from using the non-SDT configuration to communicate with the UE during the SDT. At block 1912, the RAN node transitions the UE to a connected state from the inactive state during the SDT (e.g., events 545, 546, 645, 646). At block 1914, the RAN node communicates with the UE operating in the connected state, using at least a portion of the non-SDT configuration (e.g., events 550, 552, 518, 590, 594).

In some implementations, the SIB includes a second SDT configuration and is an SIB1 or a new SIB. In some implementations, the second SDT configuration further includes a first RSRP threshold (e.g., sdt-RSRP-Threshold, sdt-RSRP-Threshold-r17 or RSRP-Range), a data volume threshold (e.g., sdt-DataVolumeThreshold or sdt-DataVolumeThreshold-r17), an SDT timer value (e.g., t319a-r17), and/or a logical channel delay timer value (e.g., sdt-LogicalChannelSR-DelayTimer or sdt-LogicalChannelSR-DelayTimer-r17). In some implementations, the second SDT configuration is an SDT-ConfigCommonSIB or SDT-ConfigCommonSIB-r17 IE. The UE performs measurements on DL signal(s) from the cell and obtains a first RSRP value from the measurements. In some implementations, if the first RSRP value is higher than the first RSRP threshold and UL data available for transmission is below the data volume threshold, the UE performs SDT (e.g., RA-SDT) with the RAN node via the cell. Otherwise, the UE performs an RRC resume procedure with the RAN node to transition to the connected state to transmit the UL data. In further implementations, the first SDT configuration includes a second RSRP threshold (e.g., cg-SDT-RSRP-Threshold, cg-SDT-RSRP-ThresholdSSB, cg-SDT-RSRP-ThresholdSSB-r17 or RSRP-Range). The UE performs measurements on SSB(s) from the cell and obtains a second RSRP value from the measurements. In some implementations, if the first RSRP value is higher than the first RSRP threshold, the second RSRP value is higher than the second RSRP threshold, and UL data available for transmission is below the data volume threshold, the UE performs SDT (e.g., CG-SDT) with the RAN node via the cell to transmit the UL data. Otherwise, if the first RSRP value is higher than the first RSRP threshold and the UL data available for transmission is below the data volume threshold, the UE performs SDT (e.g., RA-SDT) with the RAN node via the cell to transmit the UL data. Otherwise, the UE performs an RRC resume procedure with the RAN node to transition to the connected state to transmit the UL data. In some implementations, the RAN node configures the DL signal(s) measured by the UE. For example, the RAN node can configure the DL signal(s) as the SSB(s) so that the UE does not need to perform extra measurements to obtain the second RSRP value. In some such examples, the first RSRP value and the second RSRP value are the same value. In another example, the RAN node can configure the DL signal(s) partially the same as or different from the SSB(s) so that the UE does not need to perform separate measurements to obtain the first RSRP value and the second RSRP value, respectively.

In some implementations, the non-SDT configuration includes physical layer configuration parameters (e.g., PhysicalCellGroupConfig IE) and/or MAC configuration parameter(s) (e.g., MAC-CellGroupConfig IE). In some implementations, the RAN node refrains from using the first SDT configuration to communicate with the UE operating in the connected state.

FIG. 19B is a flow diagram of an example method 1900B, similar to the method 1900A, except that the method 1900B includes blocks 1909, 1911, and 1915 instead of blocks 1908, 1910, and 1914. As such, the RAN node communicates with the UE in the inactive state by using the SDT configuration and a portion of the non-SDT configuration.

In particular, at block 1909, the RAN node performs SDT via the cell with the UE operating in an inactive state, in accordance with the first SDT configuration and a first portion of the non-SDT configuration (e.g., events 404, 418, 492, 493, 420, 494, 495, 592, 593, 594, 595, 692, 694, 695). At block 1911, the RAN node refrains from using a second portion of the non-SDT configuration to communicate with the UE during the SDT. At block 1915, the RAN node communicates with the UE operating in the connected state, using at least a portion of the non-SDT configuration (e.g., events 550, 552, 518, 590, 594).

In some implementations, the non-SDT configuration includes configuration parameters in an RRC reconfiguration message (e.g., RRCReconfiguration message). In some implementations, the configuration parameters include measurement configuration(s) and SRB configuration(s) (e.g., SRB-ToAddMod IE(s)) and/or DRB configuration(s) (e.g., DRB-ToAddMod IE(s) which are associated with SRB(s) and/or DRB(s) for the UE. In such cases, the first portion of the non-SDT configuration includes some or all of the SRB configuration(s) (e.g., SRB-ToAddMod IE(s)) and/or some or all of the DRB configuration(s) (e.g., DRB-ToAddMod IE(s)), which are associated with DRB(s) or SRB(s) configured for SDT. The second portion of the non-SDT configuration includes the measurement configuration(s). In some implementations, the second portion of the non-SDT configuration includes some of the SRB configuration(s) and/or some or all of the DRB configuration(s), which are associated with DRB(s) or SRB(s) configured for non-SDT, if existent.

In some implementations, the configuration parameters of the non-SDT configuration further include a cell group configuration (e.g., CellGroupConfig IE). The cell group configuration includes physical layer configuration parameters (e.g., PhysicalCellGroupConfig IE), MAC configuration parameter(s) (e.g., MAC-CellGroupConfig IE), and RLC configuration parameters(s) (e.g., one or more RLC bearer configurations (e.g., RLC-BearerConfig IEs)) associated with all SRB(s) and/or DRB(s) for the UE, respectively. For example, the physical configuration parameters include beam related configuration parameters, MIMO configuration parameters, SRS configuration parameters, physical channel configuration parameters, and BWP configuration parameters. In some implementations, the first portion of the non-SDT configuration includes some or all of the RLC bearer configurations associated with SRB(s) and/or DRB(s) for SDT. In some implementations, the second portion of the non-SDT configuration includes some of the RLC bearer configurations associated with SRB(s) and/or DRB(s) for non-SDT, the MAC configuration parameter(s), and/or the physical layer configuration parameters. In other implementations, the first portion of the non-SDT configuration includes a first portion of the MAC configuration parameters, and the second portion of the non-SDT configuration includes a second portion of the MAC configuration parameters and/or the physical layer configuration parameters. For example, the first portion of the MAC configuration parameters include a UL transmission skipping configuration and/or data inactivity timer value, and the second portion of the MAC configuration parameters includes a DRX configuration, a BSR configuration, a PHR configuration, and/or a scheduling request configuration.

In some implementations, the portion of the non-SDT configuration includes the first portion of the non-SDT configuration. In some implementations, the portion of the non-SDT configuration includes the measurement configuration(s), and the SRB configuration(s) and/or DRB configuration(s) which are associated with SRB(s) and/or DRB(s) for the UE respectively. In some implementations, the at least a portion of the non-SDT configuration includes the RLC bearer configurations associated with SRB(s) and/or DRB(s) for the UE. In some implementations, the portion of the non-SDT configuration includes a portion of the physical layer configuration parameters and a portion of MAC configuration parameters. In other implementations, the portion of the non-SDT configuration does not include the physical layer configuration parameters. In some implementations, the RAN node refrains from using the first SDT configuration to communicate with the UE operating in the connected state.

The following description may apply to the description above.

Generally speaking, description for one of the above figures can apply to another of the above figures. An event or block described above can be optional or omitted. For example, an event or block with dashed lines in the figures can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, “small data transmission” can be replaced by “early data transmission (EDT)” and “SDT” can be replaced by “EDT”, and vice versa. In some implementations, “small data transmission” can be replaced by “small data communication”, and vice versa. In some implementations, “SDT”, “SDT procedure”, “SDT session” are interchangeable. In some implementations, “stop” can be replaced by “suspend” and vice versa. In some implementations, “configured grant” and “configured uplink grant” are interchangeable.

In some implementations, the “second UE CG-SDT timer” can be replaced by “CG-SDT retransmission timer (cg-SDT-RetransmissionTimer)”. In some implementations, “CG-SDT”, “CG”, “SDT-CG” can be interchanged. In some implementations, “sublayer” can be replaced by the “entity”. In some implementations, “sublayer” can be replaced by the “entity”. In some implementations, the “SDT configuration”, “SDT DU configuration” and “SDT CU configuration” are interchangeable.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1-17. (canceled)

18. A method for wireless communication, the method implemented in a user equipment (UE) and comprising:
receiving, from a radio access network (RAN), a small data transmission (SDT) configuration;
obtaining an uplink (UL) grant during an SDT session;
when the UE has UL data for transmission during the SDT session, transmitting, to the RAN and using the UL grant, a first UL packet including at least a portion of the UL data; and
when the UE does not have UL data for transmission during the SDT session, transmitting, to the RAN and using the UL grant, a second UL packet including non-SDT data.

19. The method of claim 18, wherein transmitting the second UL packet occurs further when the UE does not have UL data for transmission during the SDT session and the SDT configuration does not configure UL transmission skipping.

20. The method of claim 19, further comprising:
when the UE does not have UL data for transmission during the SDT session and the SDT configuration configures UL transmission skipping, refraining from transmitting, using the UL grant, the first UL packet and the second UL packet.

21. The method of claim 18, further comprising:
receiving, from the RAN, a system information block (SIB).

22. The method of claim 21, wherein transmitting the second UL packet occurs further when the UE does not have UL data for transmission during the SDT session and the SIB does not configure UL transmission skipping.

23. The method of claim 22, further comprising:
when the UE does not have UL data for transmission during the SDT session and the SIB configures UL transmission skipping, refraining from transmitting, using the UL grant, the first UL packet and the second UL packet.

24. The method of claim 18, wherein transmitting the second UL packet occurs further when the UE does not have UL data for transmission during the SDT session and the UE does not support UL transmission skipping.

25. The method of claim 24, further comprising:
when the UE does not have UL data for transmission during the SDT session and the UE supports UL transmission skipping, refraining from transmitting, using the UL grant, the first UL packet and the second UL packet.

26. The method of claim 18, further comprising:
communicating, prior to receiving the SDT configuration, with the RAN using a non-SDT configuration.

27. The method of claim 26, wherein transmitting the second UL packet occurs further when the UE does not have UL data for transmission during the SDT session and the non-SDT configuration does not configure UL transmission skipping.

28. The method of claim 27, further comprising:
when the UE does not have UL data for transmission during the SDT session and the non-SDT configuration configures UL transmission skipping, refraining from transmitting, using the UL grant, the first UL packet and the second UL packet.

29. The method of claim 18, wherein the UL grant includes a configured UL grant.

30. The method of claim 18, wherein the UL grant includes a dynamic UL grant.

31. An apparatus, functioning as a user equipment and configured for wireless communication, the apparatus comprising:
a transceiver; and
a processing hardware configured to:
receive, from a radio access network (RAN), a small data transmission (SDT) configuration;
obtain an uplink (UL) grant during an SDT session;
when the UE has UL data for transmission during the SDT session, transmit, to the RAN and using the UL grant, a first UL packet including at least a portion of the UL data; and
when the UE does not have UL data for transmission during the SDT session, transmit, to the RAN and using the UL grant, a second UL packet including non-SDT data.

32. The apparatus of claim 31, wherein the processing hardware configured to transmit the second UL packet is further configured to:
transmit the second UL packet when the UE does not have UL data for transmission during the SDT session and the SDT configuration does not configure UL transmission skipping.

33. The apparatus of claim 32, wherein the processing hardware is further configured to:
when the UE does not have UL data for transmission during the SDT session and the SDT configuration configures UL transmission skipping, refrain from transmitting, using the UL grant, the first UL packet and the second UL packet.

34. The apparatus of claim 31, wherein the processing hardware is further configured to:
receive, from the RAN, a system information block (SIB).

35. The apparatus of claim 34, wherein the processing hardware configured to transmit the second UL packet is further configured to:
transmit the second UL packet when the UE does not have UL data for transmission during the SDT session and the SIB does not configure UL transmission skipping.

36. The apparatus of claim 35, wherein the processing hardware is further configured to:
when the UE does not have UL data for transmission during the SDT session and the SIB configures UL transmission skipping, refrain from transmitting, using the UL grant, the first UL packet and the second UL packet.

37. The apparatus of claim 31, wherein the processing hardware configured to transmit the second UL packet is further configured to:
transmit the second UL packet when the UE does not have UL data for transmission during the SDT session and the UE does not support UL transmission skipping.
